(19) United States
(12) Patent Application Publication
(10) Pub. No.: US 2026/0050374 A1
(43) Pub. Date: Feb. 19, 2026

(54) GESTURE-BASED VIRTUAL INTERFACES

(71) Applicant: Hewlett-Packard Development Company, L.P., Spring, TX (US)

(72) Inventors: Pierluigi Dalla Rosa, Oakland, CA (US); Imran A. Chaudhri, San Francisco, CA (US); Daniel Gobera Rubalcava, San Jose, CA (US); Kenneth Luke Kocienda, Mill Valley, CA (US); Kevin Alderfer, Hayward, CA (US); Edward Jiao, San Francisco, CA (US); Joshua Dickens, Oakland, CA (US)

(21) Appl. No.: 19/370,692

(22) Filed: Oct. 27, 2025

Related U.S. Application Data
(62) Division of application No. 18/638,623, filed on Apr. 17, 2024.
(60) Provisional application No. 63/459,989, filed on Apr. 17, 2023.
(60) Provisional application No. 63/459,993, filed on Apr. 17, 2023.
(60) Provisional application No. 63/459,994, filed on Apr. 17, 2023.
(60) Provisional application No. 63/459,991, filed on Apr. 17, 2023.

(51) Int. Cl. G06F 3/04883; G06F 3/042; G06F 3/0484

(52) U.S. Cl. CPC G06F 3/04883; G06F 3/0425; G06F 3/0426; G06F 3/0484

(57) ABSTRACT

Systems, methods, devices and non-transitory, computer-readable storage mediums are disclosed for a wearable multimedia device and cloud computing platform with an application ecosystem for processing multimedia data captured by the wearable multimedia device. In an embodiment, a wearable multimedia device projects a virtual interface (VI) on a surface using a laser projector. Further, the device determines, based on sensor data from at least one of a camera or a depth sensor, a position of a first finger of the user relative to the surface. Further, the device, presents, using the VI, a first graphical element representing the position of the first finger of the user relative to the surface.

### CROSS-REFERENCE TO RELATED APPLICATIONS

This application is a division of, and claims priority to, U.S. patent application Ser. No. 18/638,623, filed Apr. 17, 2024, which claims priority to U.S. Provisional Patent Application No. 63/459,989, entitled “Laser Projected Virtual Interface With Finger Position Indicators,” filed Apr. 17, 2023, and U.S. Provisional Patent Application No. 63/459,993, entitled “Dynamic Laser Projected Virtual Interface,” filed Apr. 17, 2023, and U.S. Provisional Patent Application No. 63/459,994, entitled “Scrollable Laser Projected Virtual Interface,” filed Apr. 17, 2023, and U.S. Provisional Patent Application No. 63/459,991, entitled “Detecting Finger Positions and Hand Gestures Using a Wearable Multimedia Device,” filed Apr. 17, 2023. The disclosures of each of the aforementioned applications are incorporated herein by reference in their entireties.

### TECHNICAL FIELD

This disclosure relates generally to gesture-based virtual interfaces, such as those generated by wearable multimedia devices.

### BACKGROUND

High-precision laser scanners (e.g., MEMS scanners) have been developed that can turn any surface into a virtual interface. For example, a laser projected virtual interface (VI) can be projected onto the palm of a user's hand or other surface. Three-dimensional (3D) depth sensors (e.g., a time of flight (TOF) camera) can be used to detect user gestures that are interacting with one or more VI elements projected on the surface. In the case of the user's palm, there is very little surface area in which to project a detailed VI. This limited space can limit the number and types of user interactions with the VI, and thus potentially limit the number and types of applications that rely on the VI for input and output.

### SUMMARY

Systems, methods, devices and non-transitory, computer-readable storage mediums are disclosed for a laser projected VI.

In general, a wearable multimedia device can include a projector subsystem configured to present information visually to a user in the form of projected light. For example, the projector subsystem can project light onto a surface (e.g., a surface of a user's hand, such the user's palm) according to a particular spatial and/or temporal pattern, such that the user perceives a virtual interface with one or more user interface elements. Further, the user can perform gestures to interact with the virtual interface.

In some implementations, there may be little surface area on which to project a detailed virtual interface. For example, a user's palm may be relatively small (e.g., compared to the display screen of a smartphone or tablet). Thus, there may be constraints regarding the size, number, and/or density of user interface elements that are presented on the virtual interface, such that they can be readily discerned by the user while also not overwhelming the user with minute detail. Further, there may be constraints regarding the types of physical interactions that the user can perform with respect to the virtual interface.

In some implementations, a wearable multimedia device can present a virtual interface that includes one or more graphical elements (which may also be referred to as “finger position indicators” or “shadow indicators”), where each graphical element visually represents one of the user's fingers that are in proximity to the virtual interface. As an example, a graphical element can mimic a shadow that a user's finger would cast on the virtual interface (e.g., if a light source were to be located at a particular position relative to the user's finger and the virtual interface), and can represent or approximate the position and/or orientation of the user's finger relative to the virtual interface. As the user moves her finger relative to the virtual interface, the wearable multimedia device can continuously modify the position and/or other visual characteristics of the graphical element (e.g., in real time or substantially real time) to provide visual cues to the user regarding the position and orientation of her finger relative to the virtual interface.

This can be beneficial, for example, in allowing allow a user to intuitively ascertain the position and/or orientation of her finger relative to the virtual interface, such that she can interact with the virtual interface more precisely and/or more quickly. For instance, based on the visual characteristics of a graphical element representing her finger, the user can ascertain that her finger is positioned in a particular position and/or orientation relative to the virtual interface. Further, based on the visual characteristics of the graphical element, she can adjust the position and/or orientation of her finger until her finger is positioned and/or oriented in a desired manner (e.g., such that the finger is aligned with a particular interactive user interface element with which the user wishes to interact). This can be particularly beneficial, for example, if the virtual interface includes relatively small interactive user interface elements (e.g., buttons, switches, scrollable text boxes, selectable dials, etc.) and/or interactive user elements at are positioned in close proximity to one another.

In some implementations, the wearable multimedia device can detect a user positioning her hand (or a portion thereof) in proximity with a particular user interface element, and in response, selectively modify the virtual interface to accentuate that user interface element. As an example, the wearable multimedia device can present a virtual interface on the palm of one hand of user, and detect the user moving a finger from her other hand such that the finger is hovering over a particular user interface element. In response, the wearable multimedia device 101 can modify the virtual interface to increase the visibility of that user interface element to the user. As examples, the wearable multimedia device 101 can increase the size of that user interface element, zoom into that virtual interface element, and/or move that virtual interface element towards the user's finger. As other examples, the wearable multimedia device 101 can decrease the size of the other user interface elements and/or move the other virtual interface element away the user's finger.

This can be beneficial, for example, in allowing a user to interpret the virtual interface and interact with the virtual interface in a more intuitive manner. For instance, as discussed above, there may be little surface area on which to project a detailed virtual interface. Therefore, a user might otherwise have difficulty discerning user interface elements from one another, particularly if the user interface elements are small and/or presented in a dense manner. However, by selectively accentuating certain user interface elements over another, the wearable multimedia device can allow the user to browse through the user interface elements and interact with the user interface elements more easily. For instance, a user can move her finger across several user interface elements in sequence (e.g., to view each of those user interface elements more clearly), and select one or more of the user interface elements after reviewing her options.

In some implementations, a wearable multimedia device can present information to a user using a scrollable virtual interface. For instance, the wearable multimedia device can present a portion of a virtual interface to a user, and allow the user to scroll or pan the virtual interface to view other portions of the virtual interface. This can be beneficial, for example, in allowing the user to see a particular portion of the virtual interface in greater detail, while also allowing the user to see other portions of the virtual interface if desired.

As an example, the wearable multimedia device can present text, images, videos, and/or other content to the user according to a particular layout, whereby at least some of the content is beyond a field of view of the virtual interface. Further, the wearable multimedia device can allow a user to selectively scroll or pan to different portions of the virtual interface, such that the user can view different portions of the content.

In some implementations, the wearable multimedia device can be configured to scroll a virtual interface in response to one or more gestured performed by the user. As an example, a user can perform one or more first gestures to instruct the wearable multimedia device to scroll a virtual interface in a first direction (e.g., upward), one or more second gestures to instruct the wearable multimedia device to scroll a virtual interface in a second direction (e.g., downward), one or more third gestures to instruct the wearable multimedia device to scroll a virtual interface in a third direction (e.g., rightward), and so forth. The wearable multimedia device can detect the user performing these gestures using one or more sensors (e.g., one or more cameras, depth sensors, etc.), and scroll the virtual interface in accordance with the user's instructions.

This can be beneficial, for example, in allowing a user to interpret a virtual interface and interact with the virtual interface in a more intuitive manner. For instance, as discussed above, there may be little surface area on which to project a detailed virtual interface. Therefore, a user might otherwise have difficulty discerning the contents of the virtual interface, particularly if the user interface elements in the virtual interface are small and/or presented in a dense manner. However, by allowing a user to scroll through the virtual content through the performance of gestures, the wearable multimedia device can present content to the user according to a larger size and/or in a less dense manner. Accordingly, the user can browse through the contents of the virtual interface and interact with the virtual interface more easily and accurately. In some implementations, a user can interact with the virtual interface, at least in part, by performing hand gestures. For example, the user can position her hand in view of one or more sensors of the wearable multimedia device (e.g., one or more cameras, depth sensors, etc.), such that her hand has a particular pose. Further, the user can move her hand according to a particular pattern. Using the one or more sensors, the wearable multimedia device can detect the position of one or more portions of the user's hand (e.g., finger tips, fingers, palm, etc.), and movements by those portions of the user's hand over time. The wearable multimedia device can determine a hand gesture corresponding to the positions and/or movements, identify one or more commands associated with that hand gesture, and execute the one or more identified commands.

In some implementations, a user can perform hand gestures in which one hand does not physically contact the other hand. For example, the virtual interface can be configured to project the virtual interface on a first hand of the user (e.g., the left hand). Further, the user can position her second hand (e.g., the right hand) such that it is hovering over the first hand or positioned alongside the first hand, and perform one more gestures using the second hand (e.g., by posing and/or moving her second hand in a particular manner). This can be beneficial, for example, as it allows the user to perform hand gestures in the air, without being confined to the physical surface upon which the virtual interface is projected.

This can be beneficial, for example, in allowing a user to interact with a virtual interface in a more intuitive manner. For instance, as discussed above, there may be little surface area on which to project a detailed virtual interface. Further, there may be little surface area with which a user can physically interact. Therefore, a user might otherwise have difficulty interacting with the contents of the virtual interface solely through touch-based inputs. However, according to the implementations described herein, a user can interact with the virtual interface by performing hand gestures in the air (e.g., in which the hands are not necessarily in contact with one another). Accordingly, the user can interact with the virtual interface without being constrained to the surface area of her palm.

Further, one or more of the techniques described herein can reduce the occurrence of erroneous and/or unintended selections by the user, which can reduce the resources expended by the wearable multimedia device during operation. For instance, if a user selects a particular interactive user interface element in error, the wearable multimedia device may perform certain operations unnecessarily (e.g., contrary to the user's intentions). Further, the user may spend more time interacting with the wearable multimedia device to correct or reverse her erroneous selection. Accordingly, the wearable multimedia device may expend resources—such as computational resources (e.g., CPU cycles), memory resources, storage resources, network resources, and/or battery resources—that might otherwise not need to be expended. By reducing the likelihood of user error in interaction with the virtual interface, the wearable multimedia device can reduce the expenditure of resources in correcting or reversing those errors. Thus, the wearable multimedia device can operate in a more efficient manner.

In at least some embodiments, a method includes: projecting, using a laser projector of a wearable multimedia device, a virtual interface (VI) on a surface; determining, based on sensor data from at least one of a camera or a depth sensor of the wearable multimedia device, a position of a first finger of the user relative to the surface; and presenting, using the VI, a first graphical element representing the position of the first finger of the user relative to the surface.

Embodiments can include one or more of the following features.

In some embodiments, the first graphical element can further represent a shape of at least a portion of the first finger.

In some embodiments, the first graphical element can further represent a size of at least a portion of the first finger.

In some embodiments, the first graphical element can further represent an orientation of the first finger.

In some embodiments, determining the position of the first finger of the user relative to the surface can include determining a distance between the first finger and the surface. One or more characteristics the first graphical element can be selected based on the distance between the first finger and the surface.

In some embodiments, an opacity of the first graphical element can be selected based on the distance between the first finger and the surface.

In some embodiments, the opacity of the first graphical element can increase with a decrease in the distance between the first finger and the surface.

In some embodiments, the surface can be a surface of a palm of the user.

In at least some embodiments, a method includes: projecting, using a laser projector of a wearable multimedia device, a virtual interface (VI) on a surface, the VI including a first user interface element and a second user interface element; obtaining sensor data from at least one of a camera or a depth sensor of the wearable multimedia device; determining, based on the sensor data, that the user has positioned a finger (i) within a first distance range from the surface and (ii) in proximity with the first user interface element; responsive to determining that the user has positioned the finger (i) within the first distance range from the surface and (ii) in proximity with the first user interface element, modifying a visual characteristic of at least one of the first user interface element or the second user interface element.

Embodiments can include one or more of the allowing features.

In some embodiments, modifying a visual characteristic of at least one of the first user interface element or the second user interface element can include changing a size of the first user interface element.

In some embodiments, modifying a visual characteristic of at least one of the first user interface element or the second user interface element can include changing a size of the second user interface element.

In some embodiments, modifying a visual characteristic of at least one of the first user interface element or the second user interface element can include moving the first user interface element relative to the second user interface element.

In some embodiments, modifying a visual characteristic of at least one of the first user interface element or the second user interface element can include moving the second user interface element relative to the first user interface element.

In some embodiments, the method can also include: determining, based on the sensor data, that the user has touched the finger on a portion of the surface coinciding with the first user interface element; and responsive to determining that the user has touched the finger on the portion of the surface coinciding with the first user interface element, performing one or more first operations associated with the first user interface element.

In some embodiments, the method can also include: subsequent to determining that the user has positioned a finger (i) within the first distance range from the surface and (ii) in proximity with the first user interface element, determining that the user has repositioned the finger within a second distance range from the surface, where the second distance range less than the first distance range; and responsive to determining that the user has repositioned the finger within the second distance range from the surface, refraining from modifying the visual characteristic of the first user interface element and the second user interface element based on the repositioning of the finger.

In some embodiments, the second distance range can be greater than zero and less than or equal to a first threshold distance.

In some embodiments, the first distance range can be greater than the first threshold distance and less than or equal to a second threshold distance.

In some embodiments, the method can also include: subsequent to determining that the user has repositioned the finger within the second distance range from the surface, determining that the user has touched the finger on the surface; and responsive to determining that the user has touched the finger on the surface, performing one or more first operations associated with the first user interface element.

In some embodiments, determining that the user has touched the finger on the surface can include determining that the user has touched the finger on a portion of the surface coinciding with the first user interface element.

In some embodiments, determining that the user has touched the finger on the surface can include determining that the user has touched the finger on a portion of the surface that does not coincide with the first user interface element.

In some embodiments, the method can also include: determining that the user is moving the finger within a second distance range from the surface according to a first velocity, where the second distance range less than the first distance range; determining that the first velocity is less than a threshold velocity; and responsive to determining that the first velocity is less than the threshold velocity, modifying the visual characteristic of at least one of the first user interface element or the second user interface element based on the movement of the finger.

In some embodiments, the first velocity can be measured with respect to a plane parallel of the surface.

In some embodiments, the method can also include: determining that the user is moving the finger within the second distance range from the surface according to a second velocity; determining that the second velocity is greater than the threshold velocity; and responsive to determining that the second velocity is greater than the threshold velocity, refraining from modifying the visual characteristic of the first user interface element and the second user interface element based on the movement of the finger.

In some embodiments, the second velocity can be measured with respect to a plane parallel of the surface.

In some embodiments, the method can also include: subsequent to determining that the user has positioned a finger (i) within the first distance range from the surface and (ii) in proximity with the first user interface element, determining that the user has moved the finger in a first direction; and responsive to determining that the user has moved the finger in the first direction, moving the first user interface element in the first direction.

In some embodiments, the VI can include a plurality of user interface elements including the first user interface element and the second user interface element. The plurality of user interface elements can be arranged in a grid.

In some embodiments, the method can also include: determining, based on the sensor data, that the user has moved the finger towards the surface; and responsive to determining that the user has moved the finger towards the surface, performing a zoom in operation with respect to the VI.

In some embodiments, the method can also include: determining, based on the sensor data, that the user has moved the finger in a first direction along the VI; and responsive to determining that the user has moved the finger in the first direction along the VI, performing a scroll operation on the VI in the first direction.

In some embodiments, the method can also include: determining, based on the sensor data, that the user has moved the finger away from the surface; and responsive to determining that the user has moved the finger away from the surface, performing a zoom out operation with respect to the VI.

In some embodiments, the method can also include: determining, based on the sensor data, that the user is moving the finger; determining a first velocity of the finger along a plane parallel to the surface; applying a weight to the first velocity; and determining an input of the user based on the weighted first velocity.

In some embodiments, the weight can be determined based on a second velocity of the finger along a direction orthogonal to the plane.

In some embodiments, the weight can be inversely related to the second velocity.

In some embodiments, modifying the visual characteristic of at least one of the first user interface element or the second user interface element can include visually indicating that the finger is in proximity with the first user interface element.

In some embodiments, the method can also include: subsequent to determining that the user has positioned a finger (i) within the first distance range from the surface and (ii) in proximity with the first user interface element, determining that the user has moved the finger to a first position; determining that the first position is within a boundary region enclosing the first user interface element; and responsive to determining that the first position is within the boundary region, continuing to indicate that the finger is in proximity with the first user interface element.

In some embodiments, the method can also include: determining that the user has moved the finger to a second position; determining that the first position is beyond the boundary region and is in proximity with the second user interface element; and responsive to determining that the first position is beyond the boundary region and in proximity with the second user interface element, indicating that the finger is in proximity with the second user interface element.

In some embodiments, the boundary region can be larger than the first user interface element.

In some embodiments, a size of the boundary region can vary depending on a distance between the finger and the surface.

In some embodiments, the size of the boundary region can be inversely proportional to the distance between the finger and the surface.

In some embodiments, the method can also include refraining from visually presenting the boundary region to the user in the VI.

In at least some embodiments, a method includes: presenting, by a wearable multimedia device, a user interface on a surface of a first hand of a user; capturing, by the wearable multimedia device, sensor data from at least one of a camera or a depth sensor of the wearable multimedia device; determining, by the wearable multimedia device, based on the sensor data, a gesture performed by a second hand of the user, where there is an absence of physical contact between the first hand and the second hand; determining, by the wearable multimedia device, that the gesture corresponds to a scrolling operation with respect to the user interface; and performing, by the wearable multimedia device, the scrolling operation with respect to the user interface.

Embodiments can include one or more of the following features.

In some embodiments, presenting the user interface can include projecting, using a laser projector of the wearable multimedia device, the user interface onto the surface of the first hand of the user.

In some embodiments, the gesture can be performed by the second hand beyond a periphery of the user interface.

In some embodiments, the gesture can include positioning one or more fingers of the second hand a first direction from the first hand. The scrolling operation ca include scrolling the user interface in the first direction.

In some embodiments, a speed of the scrolling operation can depend on a distance between the one or more fingers from a reference line.

In some embodiments, the gesture can include positioning one or more fingers of the second hand an upward direction from the first hand. The scrolling operation can include scrolling the user interface upward.

In some embodiments, the gesture can include positioning one or more fingers of the second hand a downward direction from the first hand. The scrolling operation can include scrolling the user interface downward.

In some embodiments, the gesture can include positioning one or more fingers of the second hand a leftward direction from the first hand. The scrolling operation can include scrolling the user interface leftward.

In some embodiments, the gesture can include positioning one or more fingers of the second hand a rightward direction from the first hand. The scrolling operation can include scrolling the user interface rightward.

In some embodiments, the gesture can include moving the second hand in a first direction. The scrolling operation can include scrolling the user interface in the first direction.

In some embodiments, the gesture can include moving the second hand in an upward direction. The scrolling operation can include scrolling the user interface upward.

In some embodiments, the gesture can include moving the second hand in a downward direction. The scrolling operation can include scrolling the user interface downward.

In some embodiments, the gesture can include moving the second hand in a leftward direction. The scrolling operation can include scrolling the user interface leftward.

In some embodiments, the gesture can include moving the second hand in a rightward direction. The scrolling operation can include scrolling the user interface rightward.

In some embodiments, the gesture can include, concurrently: (i) pointing a particular number of fingers outward from the second hand, and (ii) moving the second hand in a first direction. The scrolling operation can include scrolling the user interface in the first direction.

In some embodiments, the number of fingers can be five.

In some embodiments, the number of fingers can be less than five.

In some embodiments, the gesture can include, concurrently: (i) performing a pinching gesture using the second hand, and (ii) moving the second hand in a first direction. The scrolling operation can include scrolling the user interface in the first direction.

In some embodiments, the method can also include: determining, based on the sensor data, a second gesture performed by the second hand of the user, where the second gesture includes, concurrently: (i) performing the pinching gesture using the second hand, and (ii) moving the second hand away from the surface; determining that the second gesture corresponds to a zoom out operation with respect to the user interface; and performing the zoom out operation with respect to the user interface.

In some embodiments, the method can further include: subsequent to performing the zoom out operation, determining, based on the sensor data, a third gesture performed by the second hand of the user, where the second gesture comprises stopping the performance of the pinching gesture; determining that the third gesture corresponds to a zoom in operation with respect to the user interface; and performing the zoom in operation with respect to the user interface.

In some embodiments, the user interface can include a scroll control element having a plurality of portions, where each of the portions corresponds to respective scrolling direction and a respective scrolling speed. The method can further include: determining, based on the sensor data, a second gesture performed by the second hand of the user, where the gesture comprises touching one of the portions of the scroll control element, and scrolling the user interface according to the corresponding scrolling direction and scrolling speed.

In some embodiments, the first hand can be a right hand of the user, and the second hand can be a left hand of the user.

In some embodiments, the first hand can be a left hand of the user, and the second hand can be a right hand of the user.

In at least some embodiments, a method includes: projecting, using a laser projector of a wearable multimedia device, a virtual interface (VI) on a surface; obtaining, by the wearable multimedia device, sensor data from at least one of a camera or a depth sensor of the wearable multimedia device; determining, by the wearable multimedia device based on the sensor data, a presence of one or more fingers of a user; generating finger data regarding the one or more fingers, where the finger data includes, for each of the one or more fingers: a first coordinate representing a location of a tip of that finger relative to the surface with respect to a first dimension, a second coordinate representing the location of the tip of that finger relative to the surface with respect to a second dimension, and a third coordinate representing the location of the tip of that finger relative to the surface with respect to a third dimension; and outputting, by the wearable multimedia device, the finger data to one or more applications.

Embodiments can include one or more of the following features.

In some embodiments, the method can also include: determining gesture data based on the finger data, where the gesture data indicates one or more gestures performed by the user, and outputting the gesture data to the one or more applications.

In some embodiments, determining the gesture data can include: determining a movement of each of the one or more fingers, and determining the one or more gestures based on the finger data and the movement of each of the one or more fingers.

In some embodiments, the one or more gestures can include at least one of: a pinching gesture, a swiping gesture, a waving gesture, a pointing gesture, a rotating gesture, a hand raising gesture, or a hand lowering gesture.

In some embodiments, the one or more gestures can include a movement of a first finger of the one or more fingers along a second finger of the one or more fingers.

In some embodiments, the one or more gestures can include a handwriting gesture.

In some embodiments, the handwriting gesture can include a movement a first finger of the one or more fingers along a path, where the path represents a portion of text.

In some embodiments, the handwriting gesture can include concurrently: positioning the tip of a first finger of the one or more fingers in contact with the tip of a second finger of the one or more fingers, and moving the first finger and the second finger along a path, wherein the path represents a portion of text.

In some implementations, the one or more gesture can include maintaining a pose of a hand for a period of time.

In some embodiments, a first application of the one or more applications can be configured to: receive the gesture data; determine that the one or more gestures corresponds to one or more operations; and perform the one or more operations.

In some embodiments, at least one of the finger data or the gesture data can be outputted to the one or more applications using an application programming interface (API).

In some embodiments, the method can also include determining whether each of the one or more fingers is pointed outward from a palm of the user. The finger data can also include an indication of each of the one or more fingers that are pointed outward from the palm of the user.

In some embodiments, the method can also include determining whether each of the one or more fingers is curled towards a palm of the user. The finger data can also include an indication of each of the one or more fingers that are curled towards the palm of the user.

In some embodiments, the first dimension can extend in a first direction along the surface.

In some embodiments, the second dimension can extend in a second direction along the surface. The first direction can be orthogonal to the second direction.

In some embodiments, the third dimension can extend in a third direction from the surface. The third direction can be orthogonal to the first direction and to the second direction.

In some embodiments, at least some of the one or more fingers may not be in contact with the surface.

In some embodiments, each of the one or more fingers may not be in contact with the surface.

In some embodiments, a first application of the one or more applications can be configured to: receive the finger data; and perform one or more operations based on at least one of the finger data.

In some embodiments, the one or more operations can include, for each of the one or more fingers: determining the location of the tip of that finger based on the finger data; and causing the VI to visually indicate the location of the tip of that finger based on the finger data.

In some embodiments, the one or more operations can include, for each of the one or more fingers: determining the location of the tip of that finger based on the finger data; determining that the tip of that finger is proximal to one or more user interface elements of the VI; and responsive to determining that the tip of that finger is proximal to one or more user interface elements of the VI, causing the VI to modify a visual characteristics of the one or more user interface elements.

In some embodiments, the one or more operations can include: determining, for one of the one or more fingers, a distance between the tip of that finger and the surface based on the finger data; and performing the one or more operations based on the distance.

In some embodiments, performing the one or more operations based on the distance can include: performing a first operation response to determining that the distance is within a first distance range, and performing a second operation response to determining that the distance is within a second distance range.

In some embodiments, the one or more applications can include a graphics editor. Performing the first operation can include generating a first image element having a first thickness. Further performing the second operation can include generating a second image element having a second thickness.

In some embodiments, the surface can be a surface of a hand of the user.

In some embodiments, the surface can be a surface of a palm of the user.

In at least some embodiments, a method includes: obtaining, by a wearable multimedia device, first touch input data via a touch surface of the wearable multimedia device, where the first touch input data represents a user's first physical interaction with the touch surface; determining, by the wearable multimedia device based on the first touch input data, whether the user performed a first gesture and a second gesture subsequent to the first gesture; and responsive to determining that user performed the first gesture and the second gesture subsequent to the first gesture, transitioning, by the wearable multimedia device, from a locked state to an unlocked state.

Embodiments can include one or more of the following features.

In some embodiments, the first gesture can include one or more fingers of the user moving along at least one of a circular path or a ring path on the touch surface.

In some embodiments, the second gesture can include at least one of: one or more fingers of the user moving along a pre-determined path on the touch surface, or the one or more fingers of the user touching the touch surface according to a pre-determined pattern.

In some embodiments, the method can further include: subsequent to transitioning from the locked state to the unlocked state, obtaining second touch input data via the touch surface of the wearable multimedia device, where the second touch input data represents a user's second physical interaction with the touch surface; determining, based on the second touch input data, that the user performed the first gesture; and responsive to determining that user performed the first gesture, transitioning from the unlocked state to the unlocked state.

In some embodiments, in the unlocked state, the wearable multimedia device can provide the user with access to a set of functionality of the wearable multimedia device, and in the locked state, the wearable multimedia device can restrict the user from accessing the set of functionality of the wearable multimedia device.

In some embodiments, the set of functionality can include at least one of: accessing content stored on the wearable multimedia device, creating content using the wearable multimedia device, transmitting data to a network using the wearable multimedia device receiving data from the network using the wearable multimedia device, or running an application on the wearable multimedia device.

In some embodiments, the second gesture can be specified by the user.

In some embodiments, determining whether the user performed the first gesture and the second gesture subsequent to the first gesture can include determining whether the user performed the second gesture within a pre-determined time of time after the first gesture.

In some implementations, the second gesture can corresponds to a numerical passcode associated with the user.

In at least some embodiments, a wearable multimedia device includes: a laser projector; at least one of a camera or a depth sensor; at least one processor; and memory storing instructions that, when executed by the at least one processor, cause the at least one processor to perform various operations, including one or more of the methods described herein.

In at least some embodiments, one or more non-transitory computer-readable media store instructions that, when executed by at least one processor, cause the at least one processor to perform operations, including one or more of the methods described herein.

The details of the disclosed embodiments are set forth in the accompanying drawings and the description below. Other features, objects and advantages are apparent from the description, drawings and claims.

### DESCRIPTION OF DRAWINGS

FIG. 1 is a block diagram of an operating environment for a wearable multimedia device and cloud computing platform with an application ecosystem for processing multimedia data captured by the wearable multimedia device, according to an embodiment

FIG. 2 is a block diagram of a data processing system implemented by the cloud computing platform of FIG. 1, according to an embodiment.

FIG. 3 is a block diagram of a data processing pipeline for processing a context data stream, according to an embodiment.

FIG. 4 is a block diagram of another data processing for processing a context data stream for a transportation application, according to an embodiment.

FIG. 5 illustrates data objects used by the data processing system of FIG. 2, according to an embodiment.

FIG. 6 is a flow diagram of a data pipeline process, according to an embodiment.

FIG. 7 is an architecture for the cloud computing platform, according to an embodiment.

FIG. 8 is an architecture for the wearable multimedia device, according to an embodiment.

FIG. 9 is a system block diagram of a projector architecture, according to an embodiment.

FIG. 10 is a diagram of an example virtual interface, according to an embodiment.

FIGS. 11A-11C are diagrams of an example virtual interface having a graphical element representing a finger of a user.

FIGS. 12A-12D are diagrams of another example virtual interface having a graphical element representing a finger of a user.

FIGS. 13A-13D are diagrams of another example virtual interface having a graphical element representing a finger of a user.

FIGS. 14A-14D are diagrams of another example virtual interface having a graphical element representing a finger of a user.

FIG. 15 is a diagram of another example virtual interface having multiple graphical elements representing multiple fingers of a user.

FIGS. 16A and 16B are diagrams of another example virtual interface having a graphical element representing a finger of a user.

FIGS. 17A and 17B are diagrams of another example virtual interface having a graphical element representing a finger of a user and additional information regarding the virtual interface.

FIG. 18 is a diagram of an example virtual interface, according to an embodiment.

FIGS. 19A-19C are diagrams of example modifications to a virtual interface that can be performed in response to a user positioning a finger in proximity to a user interface element.

FIGS. 20A-20C are diagrams of further example modifications to a virtual interface that can be performed in response to a user positioning a finger in proximity to a user interface element.

FIGS. 21A-21J are diagrams of further example modifications to a virtual interface that can be performed in response to a user positioning a finger in proximity to a user interface element.

FIGS. 22A-22E are diagrams of further example modifications to a virtual interface that can be performed in response to a user positioning a finger in proximity to a user interface element.

FIGS. 23A-23C are diagrams of further example modifications to a virtual interface that can be performed in response to a user positioning a finger in proximity to a user interface element.

FIGS. 24A and 24B are diagrams of further example modifications to a virtual interface that can be performed in response to a user positioning a finger in proximity to a user interface element.

FIGS. 25A-25C are diagrams of further example modifications to a virtual interface that can be performed in response to a user positioning a finger in proximity to a user interface element.

FIGS. 26A-26C are diagrams of further example modifications to a virtual interface that can be performed in response to a user positioning a finger in proximity to a user interface element.

FIGS. 27A-27C are diagrams of example operations for weighting the movement of a user's finger in a planar direction based on the movement of the user's finger in a vertical direction.

FIG. 28 is a diagram of an example virtual interface, according to an embodiment.

FIG. 29A is a diagram of example content for display in a virtual interface.

FIGS. 29B and 29C are diagrams of an example scrolling operation of a virtual interface.

FIGS. 30A and 30B are diagrams of example gestures for instructing a wearable multimedia device to perform a scrolling operation.

FIGS. 31A and 31B are diagrams of additional example gestures for instructing a wearable multimedia device to perform a scrolling operation.

FIG. 32 is a diagram of additional example gestures for instructing a wearable multimedia device to perform a scrolling operation.

FIGS. 33A and 33B are diagrams of example gestures for instructing a wearable multimedia device to perform a scrolling operation.

FIG. 34 is a diagram of additional example gestures for instructing a wearable multimedia device to perform a scrolling operation.

FIG. 35 is a diagram of additional example gestures for instructing a wearable multimedia device to perform a scrolling operation.

FIG. 36 is a diagram of additional example gestures for instructing a wearable multimedia device to perform a scrolling operation.

FIG. 37A is a diagram of additional example gestures for instructing a wearable multimedia device to perform a scrolling operation.

FIG. 37B is a diagram of an example user interface element for performing scrolling operations.

FIGS. 38A and 38B are diagrams of additional example gestures for instructing a wearable multimedia device to perform a scrolling operation.

FIGS. 39A and 39B are diagrams of additional example gestures for instructing a wearable multimedia device to perform a scrolling operation.

FIGS. 40A-40F are diagrams of additional example gestures for instructing a wearable multimedia device to perform a scrolling operation.

FIGS. 41A and 41B are diagrams of additional example gestures for instructing a wearable multimedia device to perform a scrolling operation.

FIG. 42 is a diagram of an example virtual interface, according to an embodiment.

FIG. 43 is a diagram of an example system for detecting the positions of a user's fingers and/or hand gestures.

FIG. 44 is a diagram of example finger location data indicating the positions of each of a user's fingertips.

FIG. 45 is a diagram of example finger location data indicating the positions of several points of interest on a user's hands and line segment interconnecting the points of interest.

FIG. 46 is a diagram of an example neural network.

FIG. 47 is a diagram of an example process for training a neural network.

FIGS. 48A-48C are diagrams of example hand gestures.

FIGS. 49A and 49B are diagrams of additional example hand gestures.

FIGS. 50A and 50B are diagrams of additional example hand gestures.

FIGS. 51A and 51B are diagrams of additional example hand gestures.

FIGS. 52A and 52B are diagrams of additional example hand gestures.

FIGS. 53A-53C are diagrams of additional example hand gestures.

FIG. 54 is a diagram of an additional example hand gesture.

FIG. 55 is a flow diagram of a process for presenting a virtual interface, according to an embodiment.

FIG. 56 is a flow diagram of a process for presenting a virtual interface, according to an embodiment.

FIG. 57 is a flow diagram of a process for presenting a virtual interface, according to an embodiment.

FIG. 58 is a flow diagram of a process for detecting a user's interactions with a virtual interface, according to an embodiment.

FIG. 59 is a flow diagram of a process for unlocking and locking a wearable multimedia device using touch-based gestures.

The same reference symbol used in various drawings indicates like elements.

### DETAILED DESCRIPTION

### Example Wearable Multimedia Device

The features and processes described herein can be implemented on a wearable multimedia device. In an embodiment, the wearable multimedia device is a lightweight, small form factor, battery-powered device that can be attached to a user's clothing or an object using a tension clasp, interlocking pin back, magnet, or any other attachment mechanism. The wearable multimedia device includes a digital image capture device (e.g., a camera with 180° FOV with optical image stabilizer (OIS)) that allows a user to spontaneously and/or continuously capture multimedia data (e.g., video, audio, depth data, biometric data) of life events (“moments”) and document transactions (e.g., financial transactions) with minimal user interaction or device set-up. The multimedia data (“context data”) captured by the wireless multimedia device is uploaded to a cloud computing platform with an application ecosystem that allows the context data to be processed, edited and formatted by one or more applications (e.g., Artificial Intelligence (AI) applications) into any desired presentation format (e.g., single image, image stream, video clip, audio clip, multimedia presentation, image gallery) that can be downloaded and replayed on the wearable multimedia device and/or any other playback device. For example, the cloud computing platform can transform video data and audio data into any desired filmmaking style (e.g., documentary, lifestyle, candid, photojournalism, sport, street) specified by the user.

In an embodiment, the context data is processed by server computer(s) of the cloud computing platform based on user preferences. For example, images can be color graded, stabilized and cropped perfectly to the moment the user wants to relive based on the user preferences. The user preferences can be stored in a user profile created by the user through an online account accessible through a website or portal, or the user preferences can be learned by the platform over time (e.g., using machine learning). In an embodiment, the cloud computing platform is a scalable distributed computing environment. For example, the cloud computing platform can be a distributed streaming platform (e.g., Apache Kafka™) with real-time streaming data pipelines and streaming applications that transform or react to streams of data.

In an embodiment, the user can start and stop a context data capture session on the wearable multimedia device with a simple touch gesture (e.g., a tap or swipe), by speaking a command or any other input mechanism. All or portions of the wearable multimedia device can automatically power down when it detects that it is not being worn by the user using one or more sensors (e.g., proximity sensor, optical sensor, accelerometers, gyroscopes).

The context data can be encrypted and compressed and stored in an online database associated with a user account using any desired encryption or compression technology. The context data can be stored for a specified period of time that can be set by the user. The user can be provided through a website, portal or mobile application with opt-in mechanisms and other tools for managing their data and data privacy.

In an embodiment, the context data includes point cloud data to provide three-dimensional (3D) surface mapped objects that can be processed using, for example, augmented reality (AR) and virtual reality (VR) applications in the application ecosystem. The point cloud data can be generated by a depth sensor (e.g., LiDAR or Time of Flight (TOF)) embedded on the wearable multimedia device.

In an embodiment, the wearable multimedia device includes a Global Navigation Satellite System (GNSS) receiver (e.g., Global Positioning System (GPS)) and one or more inertial sensors (e.g., accelerometers, gyroscopes) for determining the location and orientation of the user wearing the device when the context data was captured. In an embodiment, one or more images in the context data can be used by a localization application, such as a visual odometry application, in the application ecosystem to determine the position and orientation of the user.

In an embodiment, the wearable multimedia device can also include one or more environmental sensors, including but not limited to: an ambient light sensor, magnetometer, pressure sensor, voice activity detector, etc. This sensor data can be included in the context data to enrich a content presentation with additional information that can be used to capture the moment.

In an embodiment, the wearable multimedia device can include one or more biometric sensors, such as a heart rate sensor, fingerprint scanner, etc. This sensor data can be included in the context data to document a transaction or to indicate the emotional state of the user during the moment (e.g., elevated heart rate could indicate excitement or fear).

In an embodiment, the wearable multimedia device includes a headphone jack connecting a headset or earbuds, and one or more microphones for receiving voice command and capturing ambient audio. In an alternative embodiment, the wearable multimedia device includes short range communication technology, including but not limited to Bluetooth, IEEE 802.15.4 (ZigBee™) and near field communications (NFC). The short range communication technology can be used to wirelessly connect to a wireless headset or earbuds in addition to, or in place of the headphone jack, and/or can wirelessly connect to any other external device (e.g., a computer, printer, projector, television and other wearable devices).

In an embodiment, the wearable multimedia device includes a wireless transceiver and communication protocol stacks for a variety of communication technologies, including WiFi, 3G, 4G and 5G communication technologies. In an embodiment, the headset or earbuds also include sensors (e.g., biometric sensors, inertial sensors) that provide information about the direction the user is facing, to provide commands with head gestures or playback of spatial audio, etc. In an embodiment, the camera direction can be controlled by the head gestures, such that the camera view follows the user's view direction. In an embodiment, the wearable multimedia device can be embedded in or attached to the user's glasses.

In an embodiment, the wearable multimedia device includes a projector (e.g., a laser projector, LCOS, DLP, LCD), or can be wired or wirelessly coupled to an external projector, that allows the user to replay a moment on a surface such as a wall or table top or on a surface of the user's band (e.g., the user's palm). In another embodiment, the wearable multimedia device includes an output port that can connect to a projector or other output device.

In an embodiment, the wearable multimedia capture device includes a touch surface responsive to touch gestures (e.g., a tap, multi-tap or swipe gesture). The wearable multimedia device may include a small display for presenting information and one or more light indicators to indicate on/off status, power conditions or any other desired status.

In an embodiment, the cloud computing platform can be driven by context-based gestures (e.g., air gesture) in combination with speech queries, such as the user pointing to an object in their environment and saying: “What is that building?” The cloud computing platform uses the air gesture to narrow the scope of the viewport of the camera and isolate the building. One or more images of the building are captured, optionally cropped (e.g., to protect privacy), and sent to the cloud computing platform where an image recognition application can run an image query and store or return the results to the user. Air and touch gestures can also be performed on a projected ephemeral display, for example, responding to user interface elements projected on a surface.

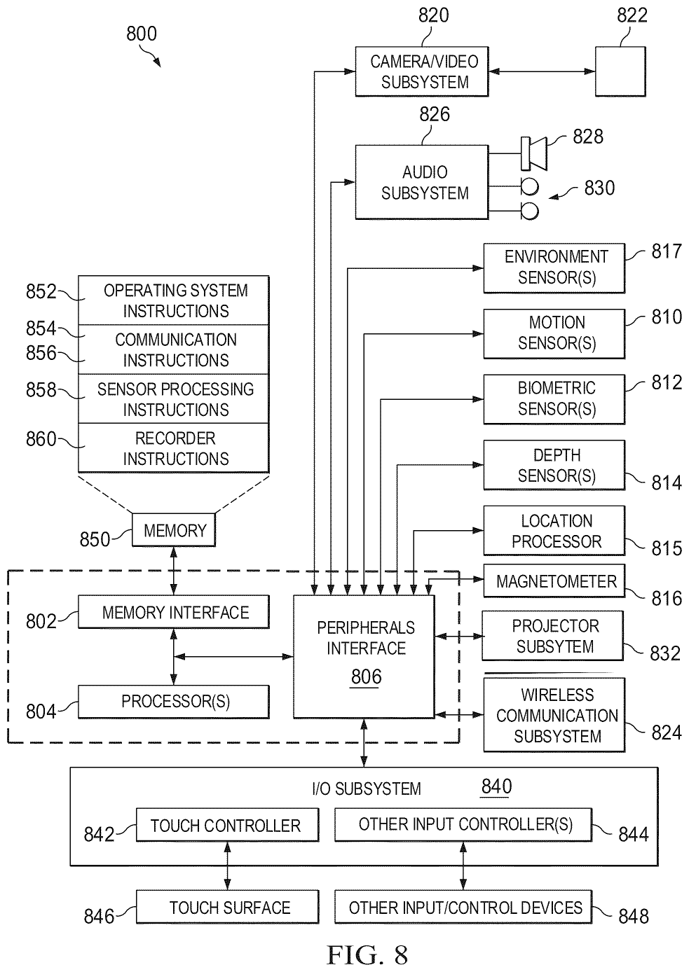

In an embodiment, the context data can be encrypted on the device and on the cloud computing platform so that only the user or any authorized viewer can relive the moment on a connected screen (e.g., smartphone, computer, television, etc.) or as a projection on a surface. An example architecture for the wearable multimedia device is described in reference to FIG. 8.

In addition to personal life events, the wearable multimedia device simplifies the capture of financial transactions that are currently handled by smartphones. The capture of every day transactions (e.g., business transactions, micro transactions) is made simpler, faster and more fluid by using sight assisted contextual awareness provided by the wearable multimedia device. For example, when the user engages in a financial transaction (e.g., making a purchase), the wearable multimedia device will generate data memorializing the financial transaction, including a date, time, amount, digital images or video of the parties, audio (e.g., user commentary describing the transaction) and environment data (e.g., location data). The data can be included in a multimedia data stream sent to the cloud computing platform, where it can be stored online and/or processed by one or more financial applications (e.g., financial management, accounting, budget, tax preparation, inventory, etc.).

In an embodiment, the cloud computing platform provides graphical user interfaces on a website or portal that allows various third party application developers to upload, update and manage their applications in an application ecosystem. Some example applications can include but are not limited to: personal live broadcasting (e.g., Instagram™ Life, Snapchat™), senior monitoring (e.g., to ensure that a loved one has taken their medicine), memory recall (e.g., showing a child's soccer game from last week) and personal guide (e.g., AI enabled personal guide that knows the location of the user and guides the user to perform an action).

In an embodiment, the wearable multimedia device includes one or more microphones and a headset. In some embodiments, the headset wire includes the microphone. In an embodiment, a digital assistant is implemented on the wearable multimedia device that responds to user queries, requests and commands. For example, the wearable multimedia device worn by a parent captures moment context data for a child's soccer game, and in particular a “moment” where the child scores a goal. The user can request (e.g., using a speech command) that the platform create a video clip of the goal and store it in their user account. Without any further actions by the user, the cloud computing platform identifies the correct portion of the moment context data (e.g., using face recognition, visual or audio cues) when the goal is scored, edits the moment context data into a video clip, and stores the video clip in a database associated with the user account.

In an embodiment, the device can include photovoltaic surface technology to sustain battery life and inductive charging circuitry (e.g., Qi) to allow for inductive charging on charge mats and wireless over-the-air (OTA) charging.

In an embodiment, the wearable multimedia device is configured to magnetically couple or mate with a rechargeable portable battery pack. The portable battery pack includes a mating surface that has permanent magnet (e.g., N pole) disposed thereon, and the wearable multimedia device has a corresponding mating surface that has permanent magnet (e.g., S pole) disposed thereon. Any number of permanent magnets having any desired shape or size can be arranged in any desired pattern on the mating surfaces.

The permanent magnets hold portable battery pack and wearable multimedia device together in a mated configuration with clothing (e.g., a user's shirt) therebetween. In an embodiment, the portable battery pack and wearable multimedia device have the same mating surface dimensions, such that there is no overhanging portions when in a mated configuration. A user magnetically fastens the wearable multimedia device to their clothing by placing the portable battery pack underneath their clothing and placing the wearable multimedia device on top of portable battery pack outside their clothing, such that permanent magnets attract each other through the clothing.

In an embodiment, the portable battery pack has a built-in wireless power transmitter which is used to wirelessly power the wearable multimedia device while in the mated configuration using the principle of resonant inductive coupling. In an embodiment, the wearable multimedia device includes a built-in wireless power receiver which is used to receive power from the portable battery pack while in the mated configuration.

### System Overview

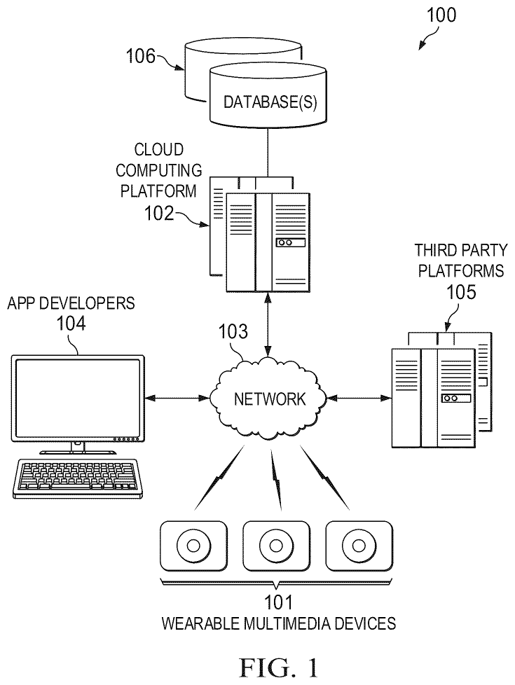

FIG. 1 is a block diagram of an operating environment for a wearable multimedia device and cloud computing platform with an application ecosystem for processing multimedia data captured by the wearable multimedia device, according to an embodiment. Operating environment 100 includes wearable multimedia devices 101, cloud computing platform 102, network 103, application (“app”) developers 104 and third party platforms 105. Cloud computing platform 102 is coupled to one or more databases 106 for storing context data uploaded by wearable multimedia devices 101.

As previously described, wearable multimedia devices 101 are lightweight, small form factor, battery-powered devices that can be attached to a user's clothing or an object using a tension clasp, interlocking pin back, magnet or any other attachment mechanism. Wearable multimedia devices 101 include a digital image capture device (e.g., a camera with a 180° FOV and OIS) that allows a user to spontaneously capture multimedia data (e.g., video, audio, depth data) of “moments” and document every day transactions (e.g., financial transactions) with minimal user interaction or device set-up. The context data captured by wireless multimedia devices 101 are uploaded to cloud computing platform 102. Cloud computing platform 101 includes an application ecosystem that allows the context data to be processed, edited and formatted by one or more server side applications into any desired presentation format (e.g., single image, image stream, video clip, audio clip, multimedia presentation, images gallery) that can be downloaded and replayed on the wearable multimedia device and/or other playback device.

By way of example, at a child's birthday party a parent can clip the wearable multimedia device on their clothing (or attached the device to a necklace or chain and wear around their neck) so that the camera lens is facing in their view direction. The camera includes a 180° FOV that allows the camera to capture almost everything that the user is currently seeing. The user can start recording by simply tapping the surface of the device or pressing a button or speaking a command. No additional set-up is required. A multimedia data stream (e.g., video with audio) is recorded that captures the special moments of the birthday (e.g., blowing out the candles). This “context data” is sent to cloud computing platform 102 in real-time through a wireless network (e.g., WiFi, cellular). In an embodiment, the context data is stored on the wearable multimedia device so that it can be uploaded at a later time. In another embodiment, the user can transfer the context data to another device (e.g., personal computer hard drive, smartphone, tablet computer, thumb drive) and upload the context data to cloud computing platform 102 at a later time using an application.

In an embodiment, the context data is processed by one or more applications of an application ecosystem hosted and managed by cloud computing platform 102. Applications can be accessed through their individual application programming interfaces (APIs). A custom distributed streaming pipeline is created by cloud computing platform 102 to process the context data based on one or more of the data type, data quantity, data quality, user preferences, templates and/or any other information to generate a desired presentation based on user preferences. In an embodiment, machine learning technology can be used to automatically select suitable applications to include in the data processing pipeline with or without user preferences. For example, historical user context data stored in a database (e.g., NoSQL database) can be used to determine user preferences for data processing using any suitable machine learning technology (e.g., deep learning or convolutional neural networks).

In an embodiment, the application ecosystem can include third party platforms 105 that process context data. Secure sessions are set-up between cloud computing platform 102 and third party platforms 105 to send/receive context data. This design allows third party app providers to control access to their application and to provide updates. In other embodiments, the applications are run on servers of cloud computing platform 102 and updates are sent to cloud computing platform 102. In the latter embodiment, app developers 104 can use an API provided by cloud computing platform 102 to upload and update applications to be included in the application ecosystem.

### Example Data Processing System

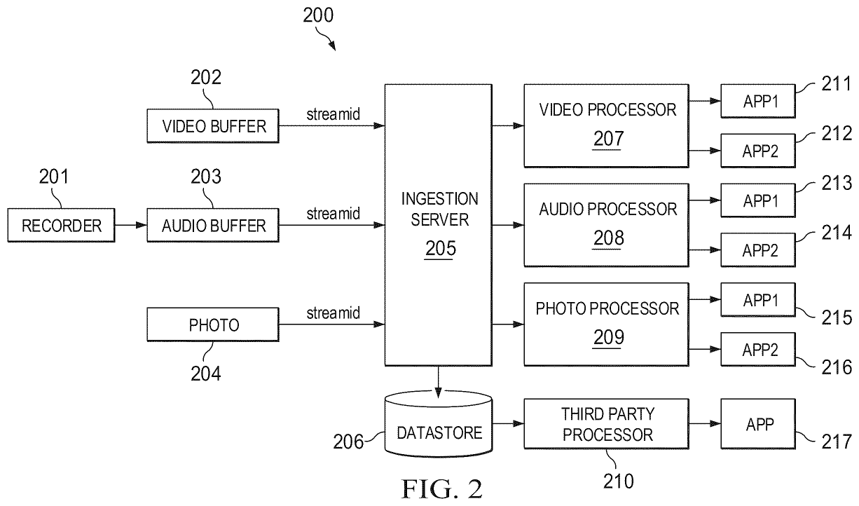

FIG. 2 is a block diagram of a data processing system implemented by the cloud computing platform of FIG. 1, according to an embodiment. Data processing system 200 includes recorder 201, video buffer 202, audio buffer 203, photo buffer 204, ingestion server 205, data store 206, video processor 207, audio processor 208, photo processor 209 and third party processor 210.

A recorder 201 (e.g., a software application) running on a wearable multimedia device records video, audio and photo data (“context data”) captured by a camera and audio subsystem, and stores the data in buffers 202, 203, 204, respectively. This context data is then sent (e.g., using wireless OTA technology) to ingestion server 205 of cloud computing platform 102. In an embodiment, the data can be sent in separate data streams each with a unique stream identifier (streamid). The streams are discrete pieces of data that may contain the following example attributes: location (e.g., latitude, longitude), user, audio data, video stream of varying duration and N number of photos. A stream can have a duration of 1 to MAXSTREAM_LEN seconds, where in this example MAXSTREAM_LEN=20 seconds.

Ingestion server 205 ingests the streams and creates a stream record in data store 206 to store the results of processors 207-209. In an embodiment, the audio stream is processed first and is used to determine the other streams that are needed. Ingestion server 205 sends the streams to the appropriate processor 207-209 based on streamid. For example, the video stream is sent to video processor 207, the audio stream is sent to audio processor 208 and the photo stream is sent to photo processor 209. In an embodiment, at least a portion of data collected from the wearable multimedia device (e.g., image data) is processed into metadata and encrypted so that it can be further processed by a given application and sent back to the wearable multimedia device or other device.

Processors 207-209 can run proprietary or third party applications as previously described. For example, video processor 207 can be a video processing server that sends raw video data stored in video buffer 202 to a set of one or more image processing/editing applications 211, 212 based on user preferences or other information. Processor 207 sends requests to applications 211, 212, and returns the results to ingestion server 205. In an embodiment, third party processor 210 can process one or more of the streams using its own processor and application. In another example, audio processor 208 can be an audio processing server that sends speech data stored in audio buffer 203 to a speech-to-text converter application 213.

### Example Scene Identification Application

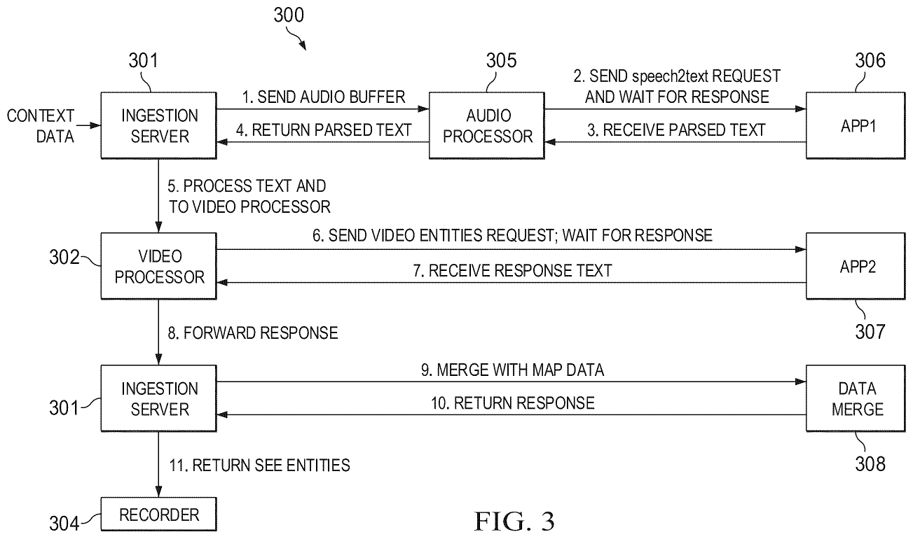

FIG. 3 is a block diagram of a data processing pipeline for processing a context data stream, according to an embodiment. In this embodiment, data processing pipeline 300 is created and configured to determine what the user is seeing based on the context data captured by a wearable multimedia device worn by the user. Ingestion server 301 receives an audio stream (e.g., including user commentary) from audio buffer 203 of wearable multimedia device and sends the audio stream to audio processor 305. Audio processor 305 sends the audio stream to app 306 which performs speech-to-text conversion and returns parsed text to audio processor 305. Audio processor 305 returns the parsed text to ingestion server 301.

Video processor 302 receives the parsed text from ingestion server 301 and sends a request to video processing app 307. Video processing app 307 identifies objects in the video scene and uses the parsed text to label the objects. Video processing app 307 sends a response describing the scene (e.g., labeled objects) to video processor 302. Video processor then forwards the response to ingestion server 301. Ingestion server 301 sends the response to data merge process 308, which merges the response with the user's location, orientation and map data. Data merge process 308 returns a response with a scene description to recorder 304 on the wearable multimedia device. For example, the response can include text describing the scene as the child's birthday party, including a map location and a description of objects in the scene (e.g., identify people in the scene). Recorder 304 associates the scene description with the multimedia data (e.g., using a streamid) stored on the wearable multimedia device. When the user recalls the data, the data is enriched with the scene description.

In an embodiment, data merge process 308 may use more than just location and map data. There can also be a notion of ontology. For example, the facial features of the user's Dad captured in an image can be recognized by the cloud computing platform, and be returned as “Dad” rather than the user's name, and an address such as “555 Main Street, San Francisco, CA” can be returned as “Home.” The ontology can be specific to the user and can grow and learn from the user's input.

### Example Transportation Application

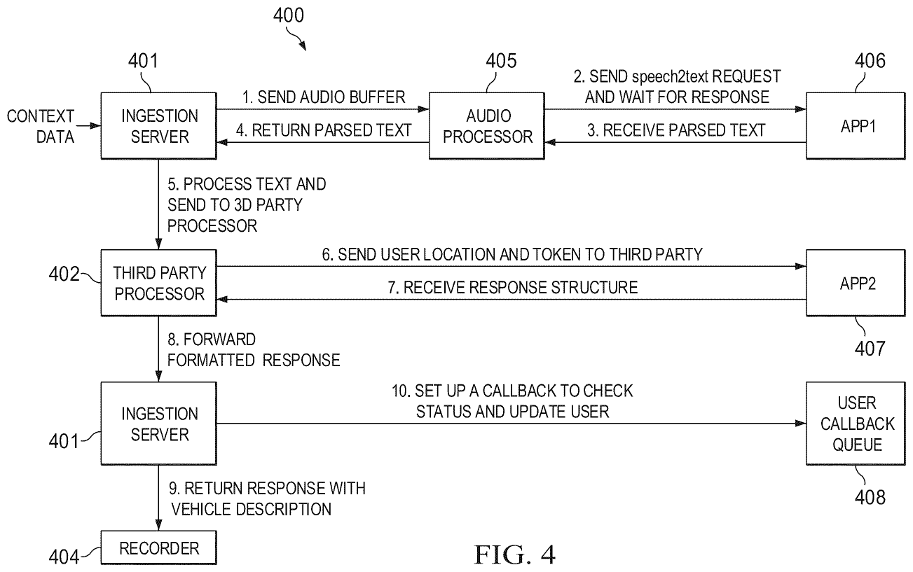

FIG. 4 is a block diagram of another data processing for processing a context data stream for a transportation application, according to an embodiment. In this embodiment, data processing pipeline 400 is created to call a transportation company (e.g., Uber®, Lyft®) to get a ride home. Context data from a wearable multimedia device is received by ingestion server 401 and an audio stream from an audio buffer 203 is sent to audio processor 405. Audio processor 405 sends the audio stream to app 406, which converts the speech to text. The parsed text is returned to audio processor 405, which returns the parsed text to ingestion server 401 (e.g., a user speech request for transportation). The processed text is sent to third party processor 402. Third party processor 402 sends the user location and a token to a third party application 407 (e.g., Uber® or Lyft™ ® application). In an embodiment, the token is an API and authorization token used to broker a request on behalf of the user. Application 407 returns a response data structure to third party processor 402, which is forwarded to ingestion server 401. Ingestion server 401 checks the ride arrival status (e.g., ETA) in the response data structure and sets up a callback to the user in user callback queue 408. Ingestion server 401 returns a response with a vehicle description to recorder 404, which can be spoken to the user by a digital assistant through a loudspeaker on the wearable multimedia device, or through the user's headphones or earbuds via a wired or wireless connection.

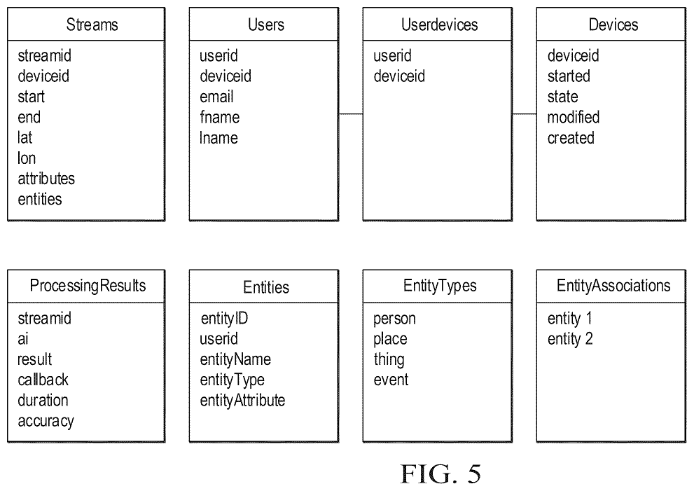

FIG. 5 illustrates data objects used by the data processing system of FIG. 2, according to an embodiment. The data objects are part of software component infrastructure instantiated on the cloud computing platform. A “streams” object includes the data streamid, deviceid, start, end, lat, lon, attributes and entities. “Streamid” identifies the stream (e.g., video, audio, photo), “deviceid” identifies the wearable multimedia device (e.g., a mobile device ID), “start” is the start time of the context data stream, “end” is the end time of the context data stream, “lat” is the latitude of the wearable multimedia device, “lon” is the longitude of the wearable multimedia device, “attributes” include, for example, birthday, facial points, skin tone, audio characteristics, address, phone number, etc., and “entities” make up an ontology. For example, the name “John Do” would be mapped to “Dad” or “Brother” depending on the user.

A “Users” object includes the data userid, deviceid, email, fname and lname. Userid identifies the user with a unique identifier, deviceid identifies the wearable device with a unique identifier, email is the user's registered email address, fname is the user's first name and lname is the user's last name. A “Userdevices” object includes the data userid and deviceid. A “devices” object includes the data deviceid, started, state, modified and created. In an embodiment, deviceid is a unique identifier for the device (e.g., distinct from a MAC address). Started is when the device was first started. State is on/off/sleep. Modified is the last modified date, which reflects the last state change or operating system (OS) change. Created is the first time the device was turned on.

A “ProcessingResults” object includes the data streamid, ai, result, callback, duration an accuracy. In an embodiment, streamid is each user stream as a Universally Unique Identifier (UUID). For example, a stream that was started from 8:00 AM to 10:00 AM will have id: 15h158dhb4 and a stream that starts from 10:15 AM to 10:18 AM will have a UUID that was contacted for this stream. AI is the identifier for the platform application that was contacted for this stream. Result is the data sent from the platform application. Callback is the callback that was used (versions can change hence the callback is tracked in case the platform needs to replay the request). Accuracy is the score for how accurate the result set is. In an embodiment, processing results can be used for multiple tasks, such as 1) to inform the merge server of the full set of results, 2) determine the fastest AI so that user experience can be enhanced, and 3) determine the most accurate ai. Depending on the use case, one may favor speed over accuracy or vice versa.

An “Entities” object includes the data entityID, userID, entityName, entityType and entity Attribute. EntityID is a UUID for the entity and an entity having multiple entries where the entityID references the one entity. For example, “Barack Obama” would have an entityID of 144, which could be linked in an associations table to POTUS44 or “Barack Hussein Obama” or “President Obama.” UserID identifies the user that the entity record was made for. EntityName is the name that the userID would call the entity. For example, Malia Obama's entityName for entityID 144 could be “Dad” or “Daddy.” EntityType is a person, place or thing. EntityAttribute is an array of attributes about the entity that are specific to the userID's understanding of that entity. This maps entities together so that when, for example, Malia makes the speech query: “Can you see Dad?”, the cloud computing platform can translate the query to Barack Hussein Obama and use that in brokering requests to third parties or looking up information in the system.

### Example Processes

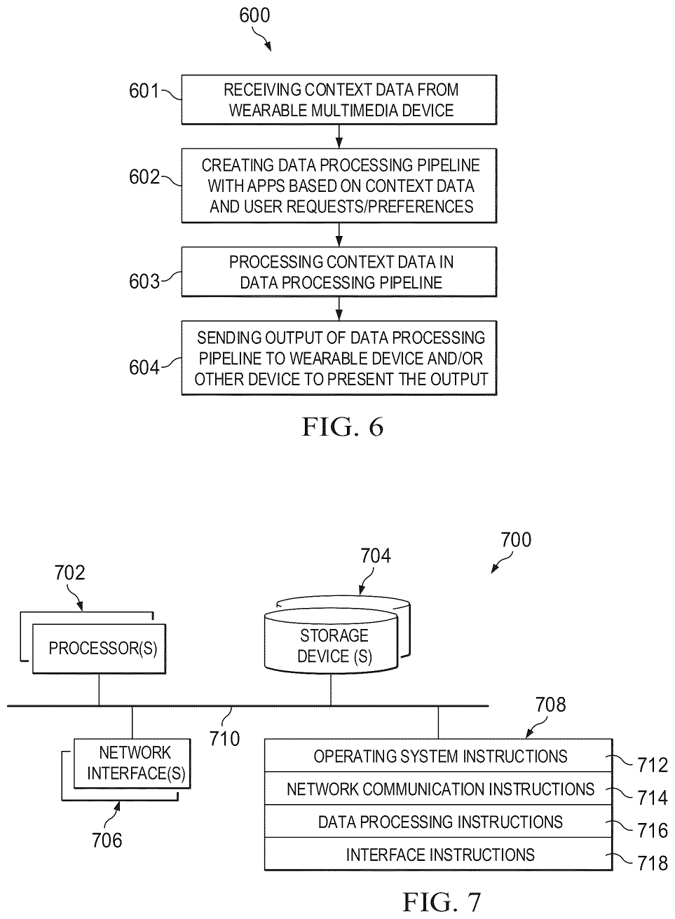

FIG. 6 is flow diagram of a data pipeline process, according to an embodiment. Process 600 can be implemented using wearable multimedia devices 101 and cloud computing platform 102 described in reference to FIGS. 1-5.

Process 600 can begin by receiving context data from a wearable multimedia device (601). For example, the context data can include video, audio and still images captured by a camera and audio subsystem of the wearable multimedia device.

Process 600 can continue by creating (e.g., instantiating) a data processing pipeline with applications based on the context data and user requests/preferences (602). For example, based on user requests or preferences, and also based on the data type (e.g., audio, video, photo), one or more applications can be logically connected to form a data processing pipeline to process the context data into a presentation to be playback on the wearable multimedia device or another device.

Process 600 can continue by processing the context data in the data processing pipeline (603). For example, speech from user commentary during a moment or transaction can be converted into text, which is then used to label objects in a video clip.

Process 600 can continue by sending the output of the data processing pipeline to the wearable multimedia device and/or other playback device (604).

### Example Cloud Computing Platform Architecture

FIG. 7 is an example architecture 700 for cloud computing platform 102 described in reference to FIGS. 1-6, according to an embodiment. Other architectures are possible, including architectures with more or fewer components. In some implementations, architecture 700 includes one or more processor(s) 702 (e.g., dual-core Intel® Xeon® Processors), one or more network interface(s) 706, one or more storage device(s) 704 (e.g., hard disk, optical disk, flash memory) and one or more computer-readable medium(s) 708 (e.g., hard disk, optical disk, flash memory, etc.). These components can exchange communications and data over one or more communication channel(s) 710 (e.g., buses), which can utilize various hardware and software for facilitating the transfer of data and control signals between components.

The term “computer-readable medium” refers to any medium that participates in providing instructions to processor(s) 702 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium(s) 708 can further include operating system 712 (e.g., Mac OS® server, Windows® NT server, Linux Server), network communication module 714, interface instructions 716 and data processing instructions 718.

Operating system 712 can be multi-user, multiprocessing, multitasking, multithreading, real time, etc. Operating system 712 performs basic tasks, including but not limited to: recognizing input from and providing output to devices 702, 704, 706 and 708; keeping track and managing files and directories on computer-readable medium(s) 708 (e.g., memory or a storage device); controlling peripheral devices; and managing traffic on the one or more communication channel(s) 710. Network communications module 714 includes various components for establishing and maintaining network connections (e.g., software for implementing communication protocols, such as TCP/IP, HTTP, etc.) and for creating a distributed streaming platform using, for example, Apache Kafka™. Data processing instructions 716 include server-side or backend software for implementing the server-side operations, as described in reference to FIGS. 1-6. Interface instructions 718 includes software for implementing a web server and/or portal for sending and receiving data to and from wearable multimedia devices 101, third party application developers 104 and third party platforms 105, as described in reference to FIG. 1.

Architecture 700 can be included in any computer device, including one or more server computers in a local or distributed network each having one or more processing cores. Architecture 700 can be implemented in a parallel processing or peer-to-peer infrastructure or on a single device with one or more processors. Software can include multiple software components or can be a single body of code.

### Example Wearable Multimedia Device Architecture

FIG. 8 is a block diagram of example architecture 800 for a wearable multimedia device implementing the features and processes described in reference to FIGS. 1-6. Architecture 800 may include memory interface 802, data processor(s), image processor(s) or central processing unit(s) 804, and peripherals interface 806. Memory interface 802, processor(s) 804 or peripherals interface 806 may be separate components or may be integrated in one or more integrated circuits. One or more communication buses or signal lines may couple the various components.

Sensors, devices, and subsystems may be coupled to peripherals interface 806 to facilitate multiple functions. For example, motion sensor(s) 810, biometric sensor(s) 812, and depth sensor(s) 814 may be coupled to peripherals interface 806 to facilitate motion, orientation, biometric, and depth detection functions. In some implementations, motion sensor(s) 810 (e.g., an accelerometer, rate gyroscope) may be utilized to detect movement and orientation of the wearable multimedia device.

Other sensors may also be connected to peripherals interface 806, such as environmental sensor(s) (e.g., temperature sensor, barometer, ambient light) to facilitate environment sensing functions. For example, a biometric sensor can detect fingerprints, face recognition, heart rate and other fitness parameters. In an embodiment, a haptic motor (not shown) can be coupled to the peripheral interface, which can provide vibration patterns as haptic feedback to the user.

Location processor 815 (e.g., GNSS receiver chip) may be connected to peripherals interface 806 to provide geo-referencing. Electronic magnetometer 816 (e.g., an integrated circuit chip) may also be connected to peripherals interface 806 to provide data that may be used to determine the direction of magnetic North. Thus, electronic magnetometer 816 may be used by an electronic compass application.

Camera subsystem 820 and an optical sensor 822, e.g., a charged coupled device (CCD) or a complementary metal-oxide semiconductor (CMOS) optical sensor, may be utilized to facilitate camera functions, such as recording photographs and video clips. In an embodiment, the camera has a 180° FOV and OIS. The depth sensor can include an infrared emitter that projects dots in a known pattern onto an object/subject. The dots are then photographed by a dedicated infrared camera and analyzed to determine depth data. In an embodiment, a time-of-flight (TOF) camera can be used to resolve distance based on the known speed of light and measuring the time-of-flight of a light signal between the camera and an object/subject for each point of the image.

Communication functions may be facilitated through one or more communication subsystems 824. Communication subsystem(s) 824 may include one or more wireless communication subsystems. Wireless communication subsystems 824 may include radio frequency receivers and transmitters and/or optical (e.g., infrared) receivers and transmitters. Wired communication systems may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data (e.g., a projector).

The specific design and implementation of the communication subsystem 824 may depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, IEEE802.xx communication networks (e.g., WiFi, WiMax, ZigBee™), 3G, 4G, 4G LTE, code division multiple access (CDMA) networks, near field communication (NFC), Wi-Fi Direct and a Bluetooth™ network. Wireless communication subsystems 824 may include hosting protocols such that the device may be configured as a base station for other wireless devices. As another example, the communication subsystems may allow the device to synchronize with a host device using one or more protocols or communication technologies, such as, for example, TCP/IP protocol, HTTP protocol, UDP protocol, ICMP protocol, POP protocol, FTP protocol, IMAP protocol, DCOM protocol, DDE protocol, SOAP protocol, HTTP Live Streaming, MPEG Dash and any other known communication protocol or technology.

Audio subsystem 826 may be coupled to a speaker 828 and one or more microphones 830 to facilitate voice-enabled functions, such as voice recognition, voice replication, digital recording, telephony functions and beamforming.

I/O subsystem 840 may include touch controller 842 and/or another input controller(s) 844. Touch controller 842 may be coupled to a touch surface 846. Touch surface 846 and touch controller 842 may, for example, detect contact and movement or break thereof using any of a number of touch sensitivity technologies, including but not limited to, capacitive, resistive, infrared, and surface acoustic wave technologies, as well as other proximity sensor arrays or other elements for determining one or more points of contact with touch surface 846. In one implementation, touch surface 846 may display virtual or soft buttons, which may be used as an input/output device by the user.

Other input controller(s) 844 may be coupled to other input/control devices 848, such as one or more buttons, rocker switches, thumb-wheel, infrared port, USB port, and/or a pointer device such as a stylus. The one or more buttons (not shown) may include an up/down button for volume control of speaker 828 and/or microphone 830.

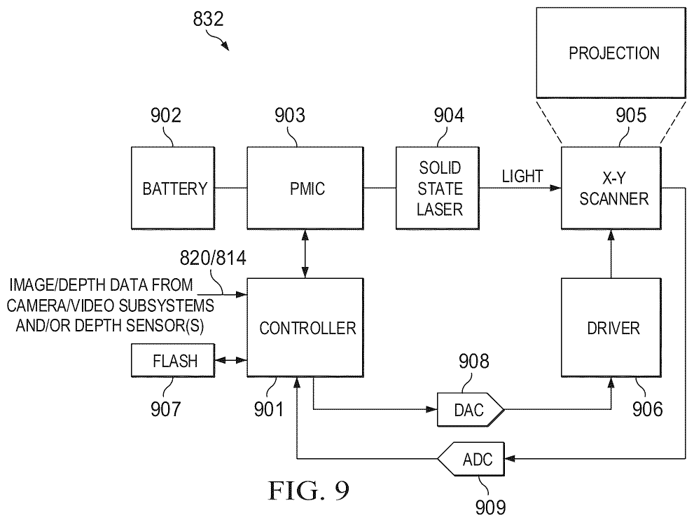

Further, a projector subsystem 832 may be connected to peripherals interface 806 to present information visually to a user in the form of projected light. For example, the projector subsystem 832 can project light onto a surface according to a particular spatial and/or temporal pattern, such that the user perceives text, images, videos, colors, patterns, and/or any other graphical information on the surface. In some implementations, the projector subsystem 832 can project light onto a surface of the user's body, such as the user's hand or palm. In some implementations, the projector subsystem 832 can project light onto a surface other than the user's body, such as a wall, a table, a desk, or any other object. The projector subsystem 832 is described in greater detail with reference to FIG. 9.

In some implementations, the projector subsystem 832 project light onto a surface to provide an interactive virtual interface for a user. For example, the projector subsystem 832 can project light onto the surface, such that the user perceives one or more interactive user interface elements (e.g., selectable buttons, dials, switches, boxes, images, videos, text, icons, etc.). Further, the user can interact with the virtual interface by performing one or more gestures with respect to the virtual interface and the user interface elements. For example, the user can perform a pointing gesture, a tapping gesture, a swiping gesture, a waving gesture, or any other gesture using her hands and/or fingers. In some implementations, a user can perform a gesture using a single hand at a time (e.g., using the hand upon which the VI is projected or her other hand). In some implementations, a user can perform a gesture using two hands concurrently. The wearable multimedia device can detect the performed gestures using one or more sensors (e.g., the camera/video subsystems 820, environment sensor(s) 817, depth sensor(s) 814, etc.), identify one or more commands associated with those gestures, and execute the identified commands (e.g., using the processor(s) 804). Example virtual interfaces are described in further detail below.

In some implementations, the wearable multimedia device 101 can detect the type of surface that is positioned in the projection area of the projector subsystem 832 (e.g., using the camera/video subsystems 820, environment sensor(s) 817, depth sensor(s) 814, etc.), and adjust one or more characteristics of the VI based on the type of surface that is detected. This can be beneficial, for example, in improving the legibility and usability of the VI in different operating environments and/or use cases.

As an example, the wearable multimedia device 101 can detect that a surface of the user's hand (e.g., the user's palm) is positioned in the projection area of the projector subsystem. As the surface area of the user's hand may be constrained (e.g., compared to a surface of a desk or wall), the wearable multimedia device 101 can reduce the overall size of the VI, such that the VI can be presented in its entirety on the user hand. Further, the wearable multimedia device 101 can adjust the size, colors, shapes, spacing, complexity, and/or other visual characteristics of the use interface elements of the VI, such that the user can readily interpret and/or interact with each of the user interface elements.

As an example, the wearable multimedia device 101 can detect that a surface of a wall, table, desk, etc. is positioned in the projection area of the projector subsystem. As the surface area of a wall, table, desk, etc. may be larger (e.g., compared to a surface of the user's hand), the wearable multimedia device 101 can increase the overall size of the VI to make better use of the larger projection surface. Further, the wearable multimedia device 101 can adjust the size, colors, shapes, spacing, complexity, and/or other visual characteristics of the use interface elements of the VI, such that the user can readily interpret and/or interact with each of the user interface elements.

In some implementations, device 800 plays back to a user recorded audio and/or video files (including spatial audio), such as MP3, AAC, spatial audio, and MPEG video files. In some implementations, device 800 may include the functionality of an MP3 player and may include a pin connector or other port for tethering to other devices. Other input/output and control devices may be used. In an embodiment, device 800 may include an audio processing unit for streaming audio to an accessory device over a direct or indirect communication link.

Memory interface 802 may be coupled to memory 850. Memory 850 may include high-speed random access memory or non-volatile memory, such as one or more magnetic disk storage devices, one or more optical storage devices, or flash memory (e.g., NAND, NOR). Memory 850 may store operating system 852, such as Darwin, RTXC, LINUX, UNIX, OS X, IOS, WINDOWS, or an embedded operating system such as VxWorks. Operating system 852 may include instructions for handling basic system services and for performing hardware dependent tasks. In some implementations, operating system 852 may include a kernel (e.g., UNIX kernel).

Memory 850 may also store communication instructions 854 to facilitate communicating with one or more additional devices, one or more computers or servers, including peer-to-peer communications with wireless accessory devices, as described in reference to FIGS. 1-6. Communication instructions 854 may also be used to select an operational mode or communication medium for use by the device, based on a geographic location of the device.

Memory 850 may include sensor processing instructions 858 to facilitate sensor-related processing and functions and recorder instructions 860 to facilitate recording functions, as described in reference to FIGS. 1-6. Other instructions can include GNSS/Navigation instructions to facilitate GNSS and navigation-related processes, camera instructions to facilitate camera-related processes and user interface instructions to facilitate user interface processing, including a touch model for interpreting touch inputs.

Each of the above identified instructions and applications may correspond to a set of instructions for performing one or more functions described above. These instructions need not be implemented as separate software programs, procedures, or modules. Memory 850 may include additional instructions or fewer instructions. Furthermore, various functions of the device may be implemented in hardware and/or in software, including in one or more signal processing and/or application specific integrated circuits (ASICs).

FIG. 9 is a system block diagram of the projector subsystem 832, according to an embodiment. The projector subsystem 832 scans a pixel in two dimensions, images a 2D array of pixels, or mixes imaging and scanning. Scanning projectors directly utilize the narrow divergence of laser beams, and two-dimensional (2D) scanning to “paint” an image pixel by pixel. In some embodiments, separate scanners are used for the horizontal and vertical scanning directions. In other embodiments, a single biaxial scanner is used. The specific beam trajectory also varies depending on the type of scanner used.

In the example shown, the projector subsystem 832 is a scanning pico-projector that includes controller 901, battery 902, power management chip (PMIC) 903, solid state laser 904, X-Y scanner 905, driver 906, memory 907, digital-to-analog converter (DAC) 908 and analog-to-digital converter (ADC) 909.

Controller 901 provides control signals to X-Y scanner 905. X-Y scanner 905 uses moveable mirrors to steer the laser beam generated by solid state laser 904 in two dimensions in response to the control signals. X-Y scanner 95 includes one or more micro-electromechanical (MEMS) micromirrors that have controllable tilt angles in one or two dimensions. Driver 906 includes a power amplifier and other electronic circuitry (e.g., filters, switches) to provide the control signals (e.g., voltages or currents) to X-Y scanner 905. Memory 907 stores various data used by the projector including laser patterns for text and images to be projected. DAC 908 and ADC 909 provide data conversion between digital and analog domains. PMIC 903 manages the power and duty cycle of solid state laser 904, including turning on and shutting of solid state laser 904 and adjusting the amount of power supplied to solid state laser 904. Solid state laser 904 can be, for example, a vertical-cavity surface-emitting laser (VCSEL).

In an embodiment, controller 901 uses image data from the camera/video subsystem 820 and/or depth data from the depth sensor(s) 814 to recognize and track user hand and/or finger positions on the laser projection, such that user input is received by the wearable multimedia device 101 using the laser projection as an input interface.

In another embodiment, the projector subsystem 832 uses a vector-graphic projection display and low-powered fixed MEMS micromirrors to conserve power. Because the projector subsystem 832 includes a depth sensor, the projected area can be masked when necessary to prevent projecting on a finger/hand interacting with the laser projected image. In an embodiment, the depth sensor can also track gestures to control the input on another devices (e.g., swiping through images on a TV screen, interacting with computers, smart speakers, etc.).

In other embodiments, Liquid Crystal on Silicon (LCoS or LCOS), Digital Light Processing (DLP) or Liquid Chrystal Display (LCD) digital projection technology can be used instead of a pico-projector.

### Example Virtual Interfaces with Finger Position Indicators

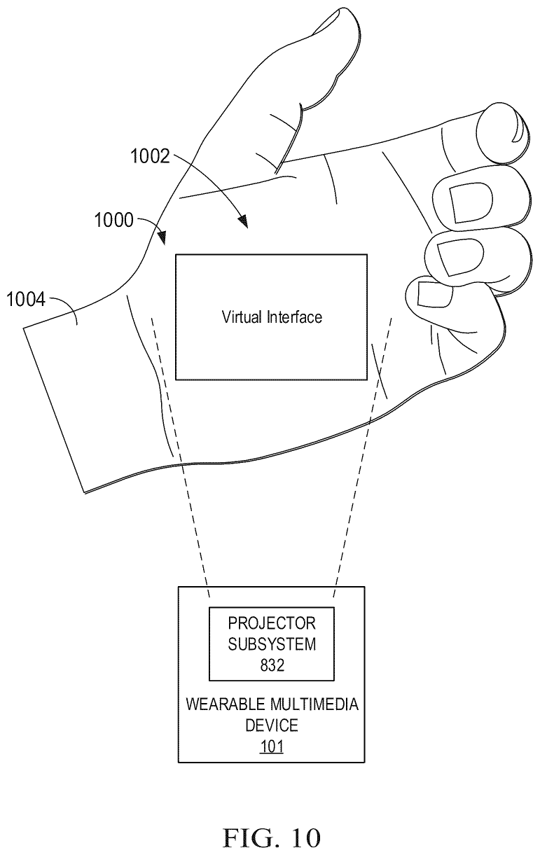

As described above, a wearable multimedia device 101 can include a projector subsystem 832 configured to present information visually to a user in the form of projected light. For example, the projector subsystem 832 can project light onto a surface (e.g., a surface of a user's hand, such as the user's palm) according to a particular spatial and/or temporal pattern, such that the user perceives text, images, videos, colors, patterns, and/or any other graphical information on the surface. As an illustrative example, FIG. 10 shows a virtual interface 1000 projected by a projector subsystem 832 onto a user's palm 1002 (e.g., the palm of the users hand 1004).

In general, the user can perform gestures to interact with one or more user interface elements of the virtual interface. For instance, the user can perform one or more gestures directed at one or more of the user interface elements. As examples, the user can point to a user interface element, touch or tap a user interface element using her finger (e.g., a single time, or multiple times in a sequence), perform a swiping motion along a user interface element using her finger, wave at a user interface element using her hand, hover over the user interface element, or perform any other hand or finger gesture. In some implementations, a user can perform a gesture using a single hand at a time (e.g., using the hand upon which the VI is projected or her other hand). In some implementations, a user can perform a gesture using two hands concurrently. The wearable multimedia device 101 can detect the performed gestures using one or more sensors (e.g., the camera/video subsystems 820, environment sensor(s) 817, depth sensor(s) 814, etc.), identify one or more commands associated with those gestures, and execute the identified commands (e.g., using the processor(s) 804).

At least some of the user interface elements and/or commands can be used to control the operation of the wearable multimedia device 101. For example, at least some of the user interface elements and/or commands can be used to execute or control the generation of video and/or audio content, the viewing of content, the editing of content, the storing and transmission data, and/or any other operation described herein.

In some implementations, there may be little surface area on which to project a detailed virtual interface. For example, a user's palm may be relatively small (e.g., compared to the display screen of a smartphone or tablet). Thus, there may be constraints regarding the size, number, and/or density of user interface elements that are presented on the virtual interface, such that they can be readily discerned by the user while also not overwhelming the user with minute detail.

In some implementations, a wearable multimedia device can present a virtual interface that includes one or more graphical elements (which may also be referred to as “finger position indicators” or “shadow indicators”), where each graphical element visually represents one of the user's fingers that are in proximity to the virtual interface. As an example, a graphical element can mimic a shadow that a user's finger would cast on the virtual interface (e.g., if a light source were to be located at a particular position relative to the user's finger and the virtual interface), and can represent or approximate the position and/or orientation of the user's finger relative to the virtual interface. As the user moves her finger relative to the virtual interface, the wearable multimedia device can continuously modify the position and/or other visual characteristics of the graphical element (e.g., in real time or substantially real time) to provide visual cues to the user regarding the position and orientation of her finger relative to the virtual interface.

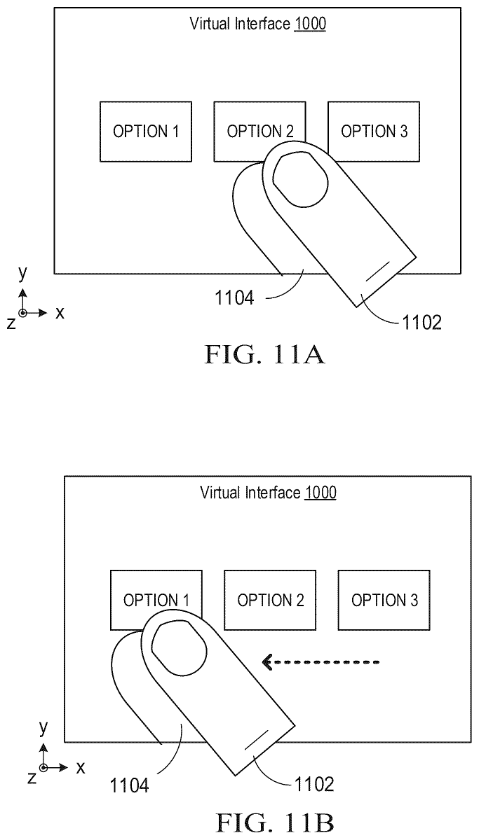

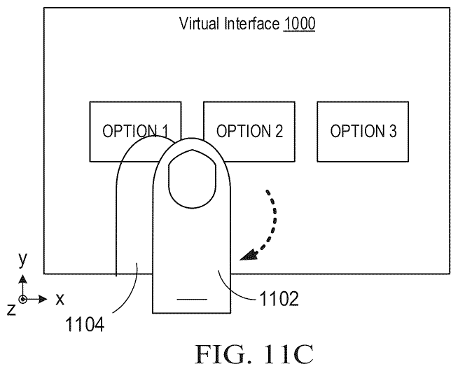

As an example, FIG. 11A shows a virtual interface 1000 having several interactive user interface elements (labeled as “Option 1,” “Option 2,” and “Option 3”). In this example, the user has positioned her finger 1102 in proximity to the virtual interface 1000. For example, the virtual interface 1000 can be presented according to a x-y plane (e.g., a plane parallel to the surface of the user's palm 1002), and the finger 1102 can be hovering above the surface of the user's palm 1002 (e.g., in a positive z-direction orthogonal to the x-y plane) such that the finger 1102 does not directly contact the surface of the user's palm 1002.

In some implementations, the finger 1102 can be a finger from the user's hand 1004 (e.g., the hand upon which the virtual interface 1000 is presented). In some implementations, the finger 1102 can be a finger from the user's hand that is opposite of the hand 1004.

The wearable multimedia device 101 determines the position and the orientation of the finger 1102 relative to the virtual interface 1000 using one or more sensors (e.g., the camera/video subsystems 820, environment sensor(s) 817, depth sensor(s) 814, etc.). In some implementations, the wearable multimedia device 101 can determine the position on a single point in the finger 1102 (e.g., a point on the tip of the finger 1102) in three-dimensional space (e.g., according to x, y, z coordinates). In some implementations, the wearable multimedia device 101 can determine the positions of multiple points on the finger 1102 in three-dimension space. In some implementations, the wearable multimedia device 101 can determine the orientation of the finger 1102 in three-dimensional space (e.g., a three-dimensional vector representing the axis of extension of the finger 1102).

In some implementations, the wearable multimedia device 101 can also determine additional information regarding the finger 1102 using the one or more sensors. For example, the wearable multimedia device 101 can also determine the shape of the finger 1102 and/or a size of the finger 1102.

As shown in FIG. 11A, based on the determined position and the orientation of the finger 1102, the wearable multimedia device 101 generates a graphical element 1104 representing the finger 1102, and presents the graphical element 1104 using the virtual interface 1000. As described above, the graphical element 1104 can mimic a shadow that the user's finger 1102 would cast on the virtual interface 1000 (e.g., if a light source were to be located at a particular position relative to the user's finger 1102 and the virtual interface 1000), and can represent or approximate the position and/or orientation of the user's finger 1102 relative to the virtual interface 1000. In the example shown in FIG. 11A, the graphical element 1104 is offset from the user's finger 1102 in the x-y plane (e.g., to mimic a shadow that would be cast by the user's finger 1102 if a light source were to be positioned at an angle relative to the user's finger 1102 and the virtual interface 1000.

In some implementations, the wearable multimedia device 101 can generate the graphical element 1104 such that it has the same size and/or shape of the finger 1102 (or approximates the size and/or shape of the finger 1102). This can be beneficial, for example, in further mimicking the shadow that the user's finger 1102 would cast on the virtual interface 1000 (e.g., such that the user can more intuitively understand the relationship between the graphical element 1104 and the user's finger 1102).

Nevertheless, in some implementations, the wearable multimedia device 101 can generate the graphical element 1104 such it has a different size and/or shape than the finger 1102. For example, in some implementations, the wearable multimedia device 101 can generate the graphical element 1104 such it is larger in size or smaller in size than the finger 1102. As another example, in some implementations, the wearable multimedia device 101 can generate the graphical element 1104 such it is the shape of a polygon (e.g., triangle, quadrilateral, pentagon, etc.), circle, ellipse, free form shape, or any combination thereof.

As described above, as the user moves her finger 1102 relative to the virtual interface 1000, the wearable multimedia device 101 can continuously modify the position and/or other visual characteristics of the graphical element 1104 (e.g., in real time or substantially real time) to provide visual cues to the user regarding the position and orientation of her finger 1102 relative to the virtual interface 1000. For instance, in the example shown in FIG. 11B, the user has moved her finger 1102 to the left. The wearable multimedia device determines, based on sensor data from the one or more sensors, an updated position of the finger 1102 relative to the virtual interface 1000. Further, the wearable multimedia device 101 modifies the position of the graphical element 1104 to represent the updated position of the finger 1102 (e.g., by moving the graphical element 1104 to the left).

In some implementations, the wearable multimedia device 101 can also modify the orientation of the graphical element 1104 to represent an updated orientation of the finger 1102. For instance, in the example shown in FIG. 11C, the user has re-positioned her finger at a different angle (e.g., relative to the x-y plane). In response, the wearable multimedia device 101 can also modify the orientation of the graphical element 1104 to represent the updated orientation of the finger 1102 (e.g., by changing the angle of the graphical element 1104 relative to the x-y plane).

Presenting a virtual interface with a graphical element representing a user's finger can provide various technical benefits. For example, this technique allows a user to intuitively ascertain the position and/or orientation of her finger relative to the virtual interface, such that she can interact with the virtual interface more precisely and/or more quickly. For instance, based on the visual characteristics of a graphical element 1104 representing her finger 1102, the user can ascertain that her finger 1102 is positioned in a particular position and/or orientation relative to the virtual interface 1000. Further, based on the visual characteristics of the graphical element 1104, she can adjust the position and/or orientation of her finger 1102 until her finger 1102 is positioned and/or oriented in a desired manner (e.g., such that the finger 1102 is aligned with a particular interactive user interface element with which the user wishes to interact). This can be particularly beneficial, for example, if the virtual interface 1000 includes relatively small interactive user interface elements (e.g., buttons, switches, scrollable text boxes, selectable dials, etc.) and/or interactive user elements at are positioned in close proximity to one another.

Further, these techniques can reduce the occurrence of erroneous and/or unintended selections by the user, which can reduce the resources expended by the wearable multimedia device 101 during operation. For instance, if a user selects a particular interactive user interface element in error, the wearable multimedia device 101 may perform certain operations unnecessarily (e.g., contrary to the user's intentions). Further, the user may spend more time interacting with the wearable multimedia device 101 to correct or reverse her erroneous selection. Accordingly, the wearable multimedia device 101 may expend resources—such as computational resources (e.g., CPU cycles), memory resources, storage resources, network resources, and/or battery resources—that might otherwise not need to be expended. By reducing the likelihood of user error in interaction with the virtual interface, the wearable multimedia device 101 can reduce the expenditure of resources in correcting or reversing those errors. Thus, the wearable multimedia device 101 can operate in a more efficient manner.

In the example shown in FIG. 11A-11C, the wearable multimedia device 101 modifies the visual characteristics of the graphical element 1104 (e.g., a position of the graphical element 1104 in the x-y plane) to indicate a change in the position of the user's finger 1102 in the x-direction and/or y-direction. In some implementations, the wearable multimedia device 101 can also modify the visual characteristics of the graphical element 1104 to indicate a change in the position of the user's finger 1102 in the z-direction. As an example, a distance between the graphical element 1104 and the user's finger 1102 (e.g., in the x-y plane) can vary based on the distance between the user's finger 1102 and the surface of the user's palm 1002 (e.g., in the z-direction).

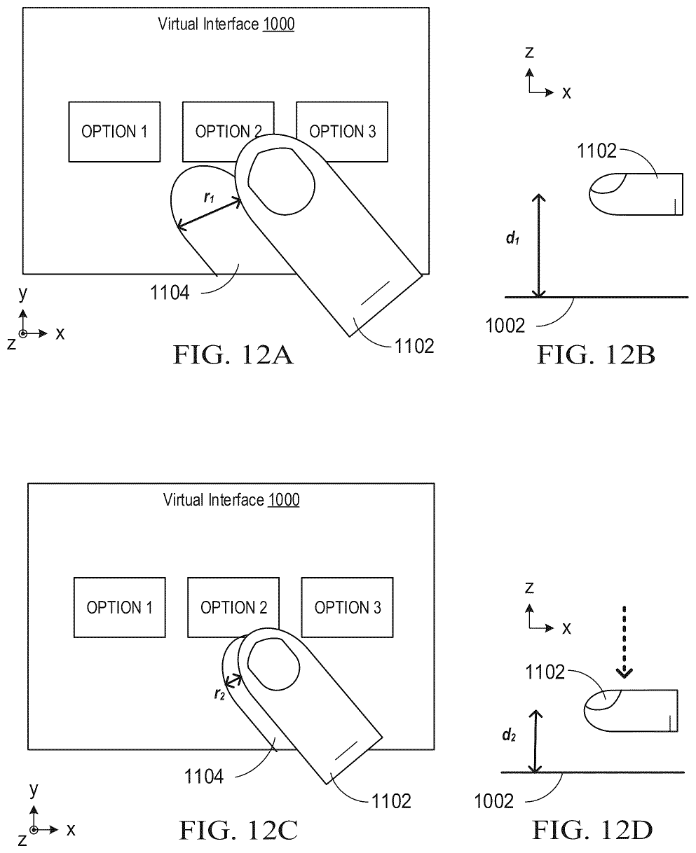

For instance, FIG. 12A shows a virtual interface 1000 having several interactive user interface elements (labeled as “Option 1,” “Option 2,” and “Option 3”). In this example, the user has positioned her finger 1102 in proximity to the virtual interface 1000. For example, as shown in FIGS. 12A and 12B, the virtual interface 1000 can be presented according to a x-y plane (e.g., a plane parallel to the surface of the user's palm 1002), and the finger 1102 can be hovering above the surface of the user's palm 1002 by a distance d₁ (e.g., in a positive z-direction orthogonal to the x-y plane) such that the finger 1102 does not directly contact the surface of the user's palm 1002.

As described above (e.g., with reference to FIGS. 11A-11C), the wearable multimedia device 101 can determine the position and the orientation of the finger 1102 relative to the virtual interface 1000 using one or more sensors, generate a graphical element 1104 representing the finger 1102, and present the graphical element 1104 using the virtual interface 1000. In the example shown in FIG. 12A, the graphical element 1104 is offset from the user's finger 1102 in the x-y plane by a distance r₁ (e.g., to mimic a shadow that would be cast by the user's finger 1102 if a light source were to be positioned at an angle relative to the user's finger 1102 and the virtual interface 1000).

As described above, as the user moves her finger 1102 relative to the virtual interface 1000, the wearable multimedia device 101 can continuously modify the visual characteristics of the graphical element 1104 (e.g., in real time or substantially real time) to provide visual cues to the user regarding the position and orientation of her finger 1102 relative to the virtual interface 1000. For instance, in the example shown in FIGS. 12C and 12D, the user has moved her finger 1102 towards the surface of the user's palm 1002 (e.g., in the negative z-direction), such that the finger 1102 is hovering above the surface of the user's palm 1002 by a distance d₂ (e.g., in z-direction), where d₁>d₂. The wearable multimedia device determines, based on sensor data from the one or more sensors, an updated position of the finger 1102 relative to the virtual interface 1000. Further, the wearable multimedia device 101 modifies the position of the graphical element 1104 to represent the updated position of the finger 1102 (e.g., by moving the graphical element 1104 closer to the finger 1102, such that they are offset from one another in the x-y plane by a distance r₂, where r₁>r₂).

In some implementations, the distance between the graphical element 1104 and the user's finger 1102 (e.g., in the x-y plane) can vary proportionally with the distance between the user's finger 1102 and the surface of the user's palm 1002 (e.g., in the z-direction). In some implementations, the distance between the graphical element 1104 and the user's finger 1102 (e.g., in the x-y plane) can vary with the distance between the user's finger 1102 and the surface of the user's palm 1002 (e.g., in the z-direction) according to some other relationship (e.g., a non-linear relationship, exponential relationship, hyperbolic relationship, asymptotic relationship, etc.).

As another example, the wearable multimedia device 101 can vary an opacity, transparency, and/or color of the graphical element 1104 based on the distance between the user's finger 1102 and the surface of the user's palm 1002 (e.g., in the z-direction).

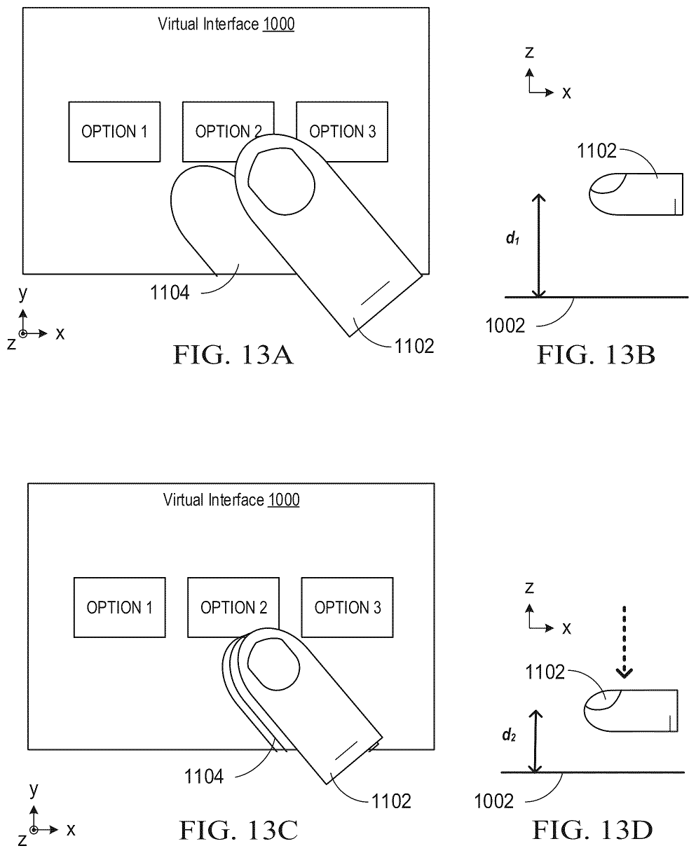

For instance, FIG. 13A shows a virtual interface 1000 having several interactive user interface elements (labeled as “Option 1,” “Option 2,” and “Option 3”). In this example, the user has positioned her finger 1102 in proximity to the virtual interface 1000. For example, as shown in FIGS. 13A and 13B, the virtual interface 1000 can be presented according to a x-y plane (e.g., a plane parallel to the surface of the user's palm 1002), and the finger 1102 can be hovering above the surface of the user's palm 1002 by a distance d₁ (e.g., in a positive z-direction orthogonal to the x-y plane) such that the finger 1102 does not directly contact the surface of the user's palm 1002.

As described above (e.g., with reference to FIGS. 11A-11C the wearable multimedia device 101 can determine the position and the orientation of the finger 1102 relative to the virtual interface 1000 using one or more sensors, generate a graphical element 1104 representing the finger 1102, and present the graphical element 1104 using the virtual interface 1000. In the example shown in FIG. 13A, the graphical element 1104 is offset from the user's finger 1102 in the x-y plane (e.g., to mimic a shadow that would be cast by the user's finger 1102 if a light source were to be positioned at an angle relative to the user's finger 1102 and the virtual interface 1000). Further, the graphical element 1104 is presented according to a particular opacity, transparency, and/or color.

As described above, as the user moves her finger 1102 relative to the virtual interface 1000, the wearable multimedia device 101 can continuously modify the visual characteristics of the graphical element 1104 (e.g., in real time or substantially real time) to provide visual cues to the user regarding the position and orientation of her finger 1102 relative to the virtual interface 1000. For instance, in the example shown in FIGS. 13C and 13D, the user has moved her finger 1102 towards the surface of the user's palm 1002 (e.g., in the negative z-direction), such that the finger 1102 is hovering above the surface of the user's palm 1002 by a distance d₂ (e.g., in z-direction), where d₁>d₂. The wearable multimedia device determines, based on sensor data from the one or more sensors, an updated position of the finger 1102 relative to the virtual interface 1000. Further, the wearable multimedia device 101 modifies the position of the graphical element 1104 to represent the updated position of the finger 1102 (e.g., by moving the graphical element 1104 closer to the finger 1102).

Further still, the wearable multimedia device 101 modifies the opacity, transparency, and/or color of the graphical element 1104. For example, the wearable multimedia device 101 can increase the opacity of the graphical element 1104. As another example, the wearable multimedia device 101 can decrease the transparency of the graphical element 1104. As another example, the wearable multimedia device 101 can darken in the color of the graphical element 1104 (e.g., decrease the brightness or luminosity of the graphical element 1104).

In some implementations, the opacity of the graphical element 1104 can vary inverse proportionally with the distance between the user's finger 1102 and the surface of the user's palm 1002 (e.g., in the z-direction). In some implementations, the opacity of the graphical element 1104 can vary with the distance between the user's finger 1102 and the surface of the user's palm 1002 (e.g., in the z-direction) according to some other relationship (e.g., a non-linear relationship, exponential relationship, hyperbolic relationship, asymptotic relationship, etc.).

In some implementations, the transparency of the graphical element 1104 can vary proportionally with the distance between the user's finger 1102 and the surface of the user's palm 1002 (e.g., in the z-direction). In some implementations, the transparency of the graphical element 1104 can vary with the distance between the user's finger 1102 and the surface of the user's palm 1002 (e.g., in the z-direction) according to some other relationship (e.g., a non-linear relationship, exponential relationship, hyperbolic relationship, asymptotic relationship, etc.).

In some implementations, the brightness or luminosity of the graphical element 1104 can vary inverse proportionally with the distance between the user's finger 1102 and the surface of the user's palm 1002 (e.g., in the z-direction). In some implementations, the brightness or luminosity of the graphical element 1104 can vary with the distance between the user's finger 1102 and the surface of the user's palm 1002 (e.g., in the z-direction) according to some other relationship (e.g., a non-linear relationship, exponential relationship, hyperbolic relationship, asymptotic relationship, etc.).

As another example, the wearable multimedia device 101 can change a sharpness or blurriness of the graphical element 1104 based on the distance between the user's finger 1102 and the surface of the user's palm 1002 (e.g., in the z-direction).

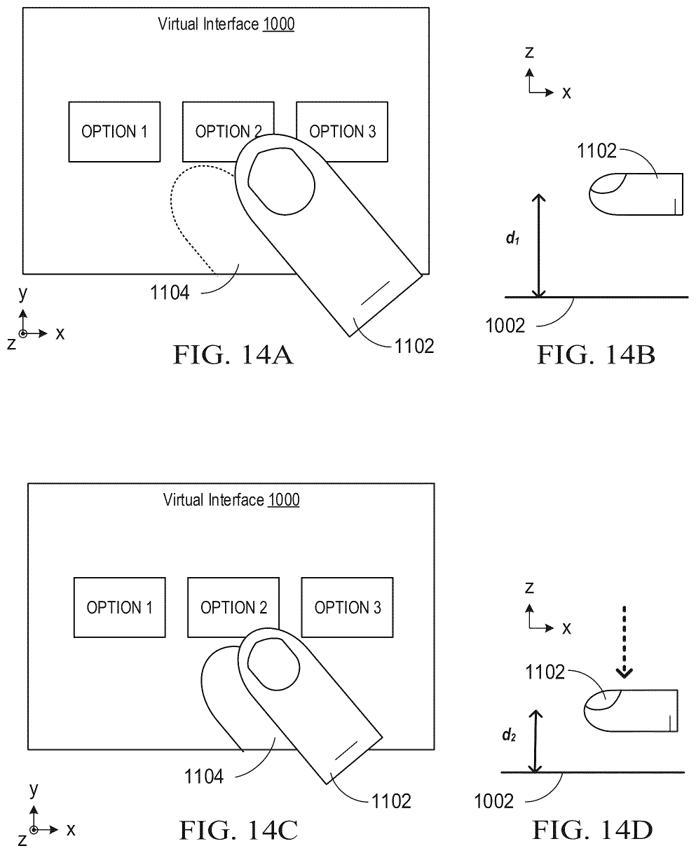

For instance, FIG. 14A shows a virtual interface 1000 having several interactive user interface elements (labeled as “Option 1,” “Option 2,” and “Option 3”). In this example, the user has positioned her finger 1102 in proximity to the virtual interface 1000. For example, as shown in FIGS. 14A and 14B, the virtual interface 1000 can be presented according to a x-y plane (e.g., a plane parallel to the surface of the user's palm 1002), and the finger 1102 can be hovering above the surface of the user's palm 1002 by a distance d₁ (e.g., in a positive z-direction orthogonal to the x-y plane) such that the finger 1102 does not directly contact the surface of the user's palm 1002.

As described above (e.g., with reference to FIGS. 11A-11C), the wearable multimedia device 101 can determine the position and the orientation of the finger 1102 relative to the virtual interface 1000 using one or more sensors, generate a graphical element 1104 representing the finger 1102, and present the graphical element 1104 using the virtual interface 1000. In the example shown in FIG. 14A, the graphical element 1104 is offset from the user's finger 1102 in the x-y plane (e.g., to mimic a shadow that would be cast by the user's finger 1102 if a light source were to be positioned at an angle relative to the user's finger 1102 and the virtual interface 1000). Further, the graphical element 1104 is presented according to a particular degree of sharpness or blurriness.

As described above, as the user moves her finger 1102 relative to the virtual interface 1000, the wearable multimedia device 101 can continuously modify the visual characteristics of the graphical element 1104 (e.g., in real time or substantially real time) to provide visual cues to the user regarding the position and orientation of her finger 1102 relative to the virtual interface 1000. For instance, in the example shown in FIGS. 14C and 14D, the user has moved her finger 1102 towards the surface of the user's palm 1002 (e.g., in the negative z-direction), such that the finger 1102 is hovering above the surface of the user's palm 1002 by a distance d₂ (e.g., in z-direction), where d₁>d₂. The wearable multimedia device 101 determines, based on sensor data from the one or more sensors, an updated position of the finger 1102 relative to the virtual interface 1000. Further, the wearable multimedia device 101 modifies the position of the graphical element 1104 to represent the updated position of the finger 1102 (e.g., by moving the graphical element 1104 closer to the finger 1102).

Further still, the wearable multimedia device 101 modifies the degree of sharpness or blurriness of the graphical element 1104. For example, the wearable multimedia device 101 can increase the sharpness of the graphical element 1104. As another example, the wearable multimedia device 101 can decrease the blurriness of the graphical element 1104.

In some implementations, the sharpness of the graphical element 1104 can vary proportionally with the distance between the user's finger 1102 and the surface of the user's palm 1002 (e.g., in the z-direction). In some implementations, the sharpness of the graphical element 1104 can vary with the distance between the user's finger 1102 and the surface of the user's palm 1002 (e.g., in the z-direction) according to some other relationship (e.g., a non-linear relationship, exponential relationship, hyperbolic relationship, asymptotic relationship, etc.).

In some implementations, the blurriness of the graphical element 1104 can vary inverse proportionally with the distance between the user's finger 1102 and the surface of the user's palm 1002 (e.g., in the z-direction). In some implementations, the blurriness of the graphical element 1104 can vary with the distance between the user's finger 1102 and the surface of the user's palm 1002 (e.g., in the z-direction) according to some other relationship (e.g., a non-linear relationship, exponential relationship, hyperbolic relationship, asymptotic relationship, etc.).

In some implementations, the sharpness or blurriness of the graphical element 1104 can be modified using one or more image filters. As an example, a sharpness of a graphical element 1104 can be increased by applying a sharpen filter (e.g., an unsharp mask filter, high pass filter, Laplacian filter, etc.) to the graphical element 1104, or increasing a strength of the sharpen filter. As another example, a sharpness of a graphical element 1104 can be decreased by removing a sharpen filter that had been applied to a graphical element 1104, or decreasing a strength of the sharpen filter.

As another example, a blurriness of a graphical element 1104 can be increased by applying a blur filter (e.g., Gaussian blur filter, average filter, radial filter, etc.) to the graphical element 1104, or increasing a strength of the blur filter. As another example, a blurriness of a graphical element 1104 can be decreased by removing a blur filter that had been applied to a graphical element 1104, or decreasing a strength of the blur filter.

In the examples shown in FIGS. 11A-14D, a wearable multimedia device presents a virtual interface 1000 having a single graphical element 1104 to represent a single finger 1102. However, in practice, wearable multimedia device can present a virtual interface 1000 having any number of graphical element to represent any number of fingers (e.g., one, two, three, four, etc.).

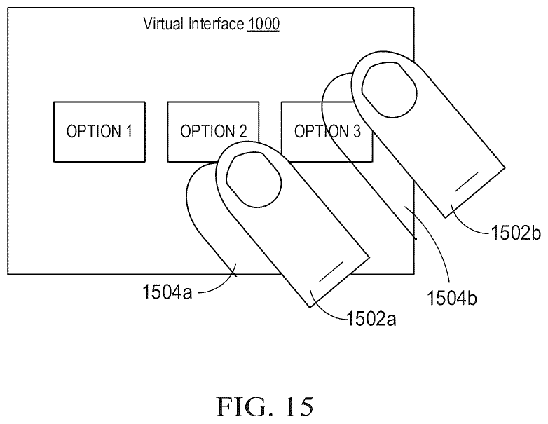

As an example, FIG. 15 shows a virtual interface 1000 having several interactive user interface elements (labeled as “Option 1,” “Option 2,” and “Option 3”). In this example, the user has positioned two fingers 1502a and 1502b in proximity to the virtual interface 1000. As described above (e.g., with reference to FIGS. 11A-11C), the wearable multimedia device 101 can determine the position and the orientation of the finger 1502a relative to the virtual interface 1000 using one or more sensors, generate a graphical element 1504a representing the finger 1502a, and present the graphical element 1504a using the virtual interface 1000. Similarly, wearable multimedia device 101 can determine the position and the orientation of the finger 1502b relative to the virtual interface 1000 using one or more sensors, generate a graphical element 1504b representing the finger 1502b, and present the graphical element 1504b using the virtual interface 1000 (e.g., concurrently with the presentation of the graphical element 1504a).

In some implementations, the wearable multimedia device can selectively present one or more graphical elements (e.g., representing one or more fingers of the user) in certain portions of the virtual interface 1000 (e.g., when a user positions one or more fingers in proximity to those portions of the virtual interface 1000). Further, the wearable multimedia device 101 can selectively refrain from presenting any of the graphical elements in other portions of the virtual interface 1000 (e.g., even if a user positions one or more fingers in proximity to the other portions of the virtual interface 1000). As an example, the wearable multimedia device can selectively present one or more graphical elements representing one or more fingers of the user in a portion of the virtual interface 1000 that contains interactive user interface elements (e.g., buttons, switches, scrollable text boxes, selectable dials, etc.), such that the user can intuitively ascertain the position and/or orientation of her fingers relative to the interactive user interface elements. Further, the wearable multimedia device can selectively refrain from presenting any graphical elements representing finger(s) of the user in a portion of the virtual interface 1000 that does not contain any interactive user interface, such that the user's view of that portion of the virtual interface 1000 is not obstructed. Non-interactive user interface elements can include user interface elements with which the user cannot interact via gestures (e.g., using her fingers). Example non-interactive user interface elements include bar codes, QR codes, and non-scrollable and non-selectable portions of content (e.g., text, images, videos, etc.).

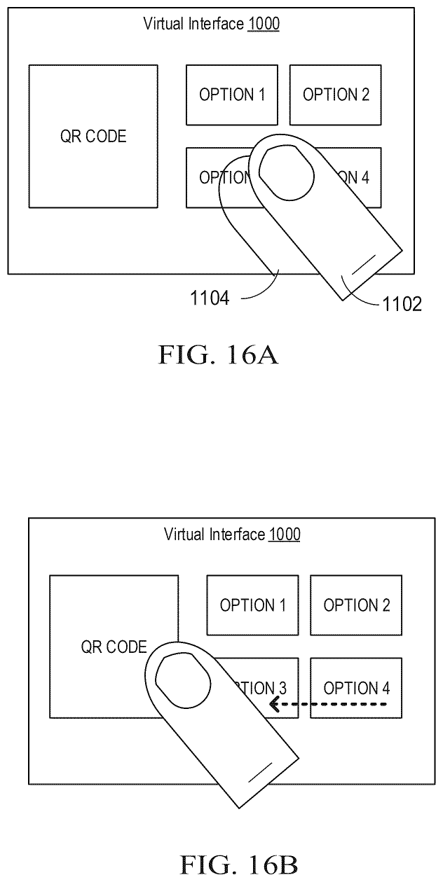

As an example, FIG. 16A shows a virtual interface 1000 having two portions 1602a and 1602b. The first portion 1602a includes several interactive user interface elements (labeled as “Option 1,” “Option 2,” “Option 3,” and “Option 4”). The second portion 1602b includes only non-interactive user interface elements (e.g., a QR code).

In the example shown in FIG. 16A, the user has positioned a finger 1102 in proximity to the first portion 1602a of the virtual interface 1000. As described above (e.g., with reference to FIGS. 11A-11C), the wearable multimedia device 101 can determine the position and the orientation of the finger 1102 relative to the virtual interface 1000 using one or more sensors, generate a graphical element 1104 representing the finger 1102, and present the graphical element 1104 using the virtual interface 1000.

In the example shown in FIG. 16B, the user has moved her finger 1102 to the left, such that the finger 1102 is instead in proximity to the second portion 1602b of the virtual interface 1000. In response, the wearable multimedia device 101 can cease presenting the graphical element 1104 in the virtual interface 1000 (e.g., such that the user can view the second portion 1602b of the virtual interface 1000 more clearly).

In the examples shown in FIGS. 11A-16B, a graphical element has a visual appearance that represents or approximate a user's finger (e.g., a “shadow” that mimics a shadow that the user's finger would cast on the virtual interface). In some implementations, a graphical element can also include additional information to aid the user in navigating the virtual interface. For instance, a graphical element can additionally display icons, symbols, pictogram text, images, videos, or other information indicating one or more gesture, interactions, or other inputs that the user can perform with respect to the virtual interface.

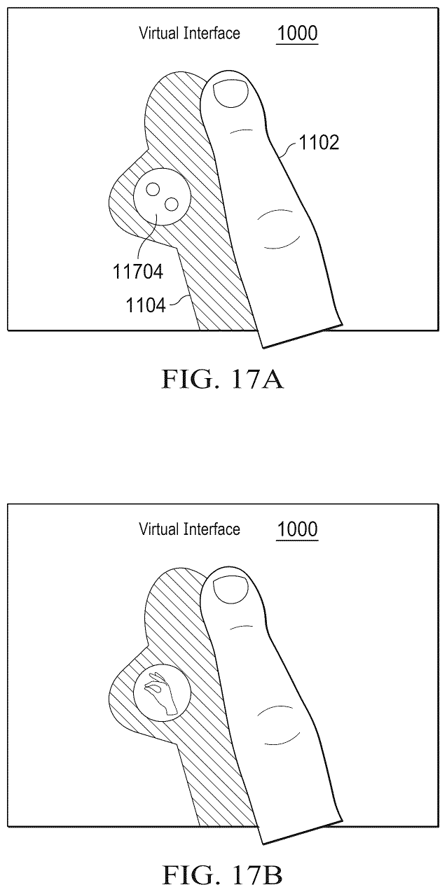

As an example as shown in FIG. 17A, the wearable multimedia device 101 can determine the position and the orientation of the finger 1102 relative to the virtual interface 1000 using one or more sensors, generate a graphical element 1104 representing the finger 1102, and present the graphical element 1104 using the virtual interface 1000. The graphical element 1104 can include a first portion 1702 having a visual appearance that represents or approximate the user's finger 1102. Further, the graphical element 1104 can include a second portion 1704 (e.g., an icon) indicating a gesture that the user can perform with respect to the virtual interface 1000. For instance, an icon having two dots can indicate that a user can pinch two of his fingers together to cause the wearable multimedia device 101 to perform a particular operation.

As another example as shown in FIG. 17B, the graphical element 1104 can include a second portion 1706 (e.g., a pictogram) indicating a gesture that the user can perform with respect to the virtual interface 1000. For instance, a pictogram depicting a pinching gesture can indicate that a user can perform that pinching gesture to cause the wearable multimedia device 101 to perform a particular operation.

In the examples shown in FIGS. 17A and 17B, a graphical element has a single additional portion for presenting information to a user. However, in practice, a graphical element can have any number of additional portions for presenting information to a user (e.g., one, two, three, four, or more). For instance, a graphical element can include multiple icons, symbols, pictogram text, images, videos, and/or other content to indicate multiple gestures, interactions, or other inputs that a user can perform with respect to the virtual interface.

Although example graphical elements are described with reference to FIGS. 12A-17B, there are merely illustrative examples. In practice, a wearable multimedia device can present other graphical elements to present a user's finger, either instead of or in addition to those described above.

Further, although FIGS. 10-17B describe example operations that can be performed using a virtual interface (e.g., a virtual interface that is projected by a projector subsystem 832), in practice, similar operations also can be performed using other types of user interfaces. As an example, some or all of these operations can be performed using a user interface that is presented using a display device such as a computer monitor or a touch sensitive display panel.

### Example Dynamic Virtual Interfaces

As described above, a wearable multimedia device 101 can include a projector subsystem 832 configured to present information visually to a user in the form of projected light. For example, the projector subsystem 832 can project light onto a surface (e.g., a surface of a user's hand, such as the user's palm) according to a particular spatial and/or temporal pattern, such that the user perceives text, images, videos, colors, patterns, and/or any other graphical information on the surface.

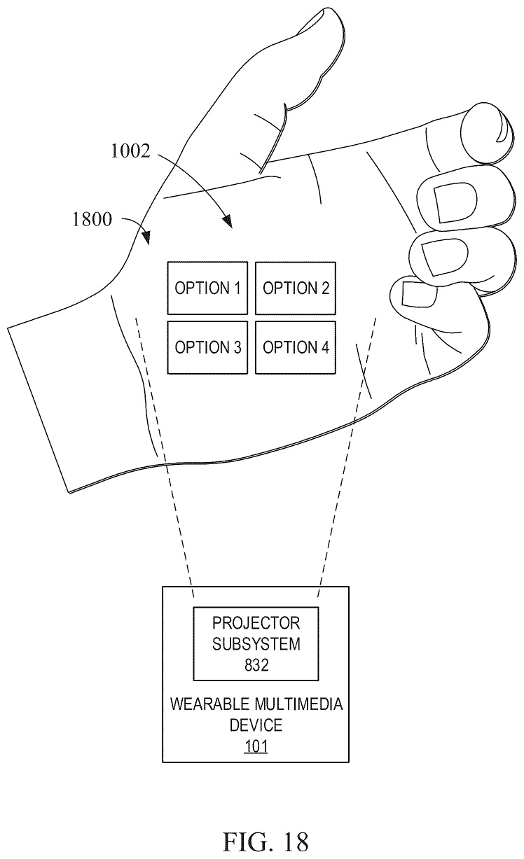

As an illustrative example, FIG. 18 shows a virtual interface 1800 projected by a projector subsystem 832 onto a user's palm 1802. In this example, the virtual interface 1800 includes a number of selectable user interface elements (labeled as “Option 1” to “Option 4”).

In general, the user can perform gestures to interact with one or more of the user interface elements. For instance, the user can perform one or more gestures directed at one or more of the user interface elements. As examples, the user can point to a user interface element, touch or tap a user interface element using her finger (e.g., a single time, or multiple times in a sequence), perform a swiping motion along a user interface element using her finger, wave at a user interface element using her hand, hover over the user interface element, or perform any other hand or finger gesture. In some implementations, a user can perform a gesture using a single hand at a time (e.g., using the hand upon which the VI is projected or her other hand). In some implementations, a user can perform a gesture using two hands concurrently. The wearable multimedia device 101 can detect the performed gestures using one or more sensors (e.g., the camera/video subsystems 820, environment sensor(s) 817, depth sensor(s) 814, etc.), identify one or more commands associated with those gestures, and execute the identified commands (e.g., using the processor(s) 804).

At least some of the user interface elements and/or commands can be used to control the operation of the wearable multimedia device 101. For example, at least some of the user interface elements and/or commands can be used to execute or control the generation of video and/or audio content, the viewing of content, the editing of content, the storing and transmission data, and/or any other operation described herein.

In some implementations, there may be little surface area on which to project a detailed virtual interface. For example, a user's palm may be relatively small (e.g., compared to the display screen of a smartphone or tablet). Thus, there may be constraints regarding the size, number, and/or density of user interface elements that are presented on the virtual interface, such that they can be readily discerned by the user while also not overwhelming the user with minute detail.

In some implementations, the wearable multimedia device 101 can detect a user positioning her hand (or a portion thereof) in proximity with a particular user interface element, and in response, selectively modify the virtual interface to accentuate that user interface element. As an example, the wearable multimedia device 101 can present a virtual interface on the palm of one hand of user, and detect the user moving a finger from her other hand such that the finger is hovering over a particular user interface element. In response, the wearable multimedia device 101 can modify the virtual interface to increase the visibility of that user interface element to the user. As examples, the wearable multimedia device 101 can increase the size of that user interface element, zoom into that virtual interface element, and/or move that virtual interface element towards the user's finger. As other examples, the wearable multimedia device 101 can decrease the size of the other user interface elements and/or move the other virtual interface element away the user's finger.

This can be beneficial, for example, in allowing a user to interpret the virtual interface and interact with the virtual interface in a more intuitive manner. For instance, as discussed above, there may be little surface area on which to project a detailed virtual interface. Therefore, a user might otherwise have difficulty discerning user interface elements from one another, particularly if the user interface elements are small and/or presented in a dense manner. However, by selectively accentuating certain user interface elements over another, the wearable multimedia device 101 can allow the user to browse through the user interface elements and interact with the user interface elements more easily. For instance, a user can move her finger across several user interface elements in sequence (e.g., to view each of those user interface elements more clearly), and select one or more of the user interface elements after reviewing her options.

Further, these techniques can reduce the occurrence of erroneous and/or unintended selections by the user, which can reduce the resources expended by the wearable multimedia device during operation. For instance, if a user selects a particular user interface element in error, the wearable multimedia device may perform certain operations unnecessarily (e.g., contrary to the user's intentions). Further, the user may spend more time interacting with the wearable multimedia device to correct or reverse her erroneous selection. Accordingly, the wearable multimedia device may expend resources—such as computational resources (e.g., CPU cycles), memory resources, storage resources, network resources, and/or battery resources—that might otherwise not need to be expended. By reducing the likelihood of user error in interaction with the virtual interface, the wearable multimedia device can reduce the expenditure of resources in correcting or reversing those errors. Thus, the wearable multimedia device can operate in a more efficient manner.

In some implementations, the wearable multimedia device 101 can determine the position of a user's finger relative to the virtual interface using one or more sensors (e.g., the camera/video subsystems 820, environment sensor(s) 817, depth sensor(s) 814, etc.).

As an example, using the camera/video subsystems 820, the wearable multimedia device 101 can determine the positions of the virtual interface and the user's finger along a two-dimensional field of view (e.g., an x-y plane). Further, using the depth sensor(s) 814, the wearable multimedia device 101 can determine the depths of the virtual interface and the user's finger from the wearable multimedia device 101 (e.g., along a z-direction extending normally from the x-y plane). Based on this information, the wearable multimedia device 101 can determine the relative distance between the user's finger from each of the user interface elements in three dimensions.

Further, based on this information, the wearable multimedia device 101 can determine whether the user has aligned her finger with a particular user interface element, such that it is hovering over or near, but not touching, the user interface element. For instance, the wearable multimedia device 101 can determine that the tip of the user's finger coincides with a particular user interface element with respect to the x-y plane, but that the tip of the user's finger is separated from the user interface element along the z-direction. Based on this determination, the wearable multimedia device 101 can selectively modify the virtual interface to increase the visibility of the user interface element to the user.

In some implementations, the wearable multimedia device 101 can detect that the user has moved her finger in proximity to a particular user interface element (e.g., such that the user's finger is hovering over the user interface element). In response, the wearable multimedia device 100 can modify the virtual interface to accentuate that user interface element. As an example, the wearable multimedia device 100 can modify the user interface element to increase the visibility of that user interface element relative to the other user interface elements. As another example, the wearable multimedia device 100 can modify the user interface element to decrease the visibility of the other user interface element relative to that user interface element.

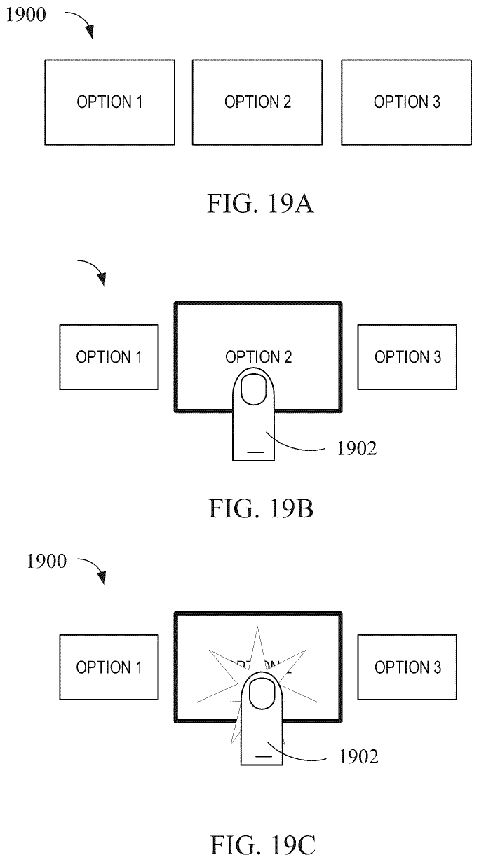

As an example, FIG. 19A shows an example virtual interface 1900 having a three user interface elements (“Option 1,” “Option 2,” and “Option 3”). As shown in FIG. 19B, upon determining that the user has placed her finger 1902 in proximity with the second user interface element, the wearable multimedia device 101 modifies the virtual interface 1900 such that the size of the second user interface element is increased (e.g., relative to the other user interface elements). For instance, prior to the modification, each of the first, second, and third user interface elements can have the same size. After the modification, the second user interface element can have a larger size than the first and second user interface elements.

In some implementations, the wearable multimedia device 101 can modify the virtual interface 1900 to accentuate the second user interface element further. For example, the wearable multimedia device 101 can present the second user interface element according to a different color, texture, visual pattern, shape, and/or animation (e.g., compared to at least some of the other user interface elements). As another example, the wearable multimedia device 101 can present the second user interface element according to a different level of opacity or transparency (e.g., compared to at least some of the other user interface elements). As another example, the wearable multimedia device 101 can present the second user interface element with a different border, such as a border having a different border thickness, pattern, or color (e.g., compared to at least some of the other user interface elements).

Further, the user can select a particular user interface element and confirm her selection by performing one or more gestures. The gestures can be performed with the hand upon which the VI 1900 is projected, her other hand, or both.

As an example, as shown in FIG. 19B, the user can select the second user interface element by hovering her finger 1902 over the second user interface element. Further, as shown in FIG. 19C, the user can confirm her selection by performing a gesture using her finger 1902 (e.g., by tapping or pressing her finger 1902 on the surface upon which the VI 1900 is projected, such that the tip of the user's finger 1902 coincides with the second user interface element).

As another example, the user can select a particular user interface element by hovering her finger 1902 over the user interface element. Further, while the user is hovering her finger 1902 the user interface element, the user can confirm her selection by performing a gesture using the hand upon which the VI 1900 is projected (e.g., by touching the tip of her thumb with the tip of another finger, such as her index finger).

In some implementations, the wearable multimedia device 101 can detect that the user has moved her finger in proximity to a particular user interface element (e.g., such that the user's finger is hovering over the user interface element). In response, the wearable multimedia device 100 can modify the positions of one or more of the user interface elements in the virtual interface.

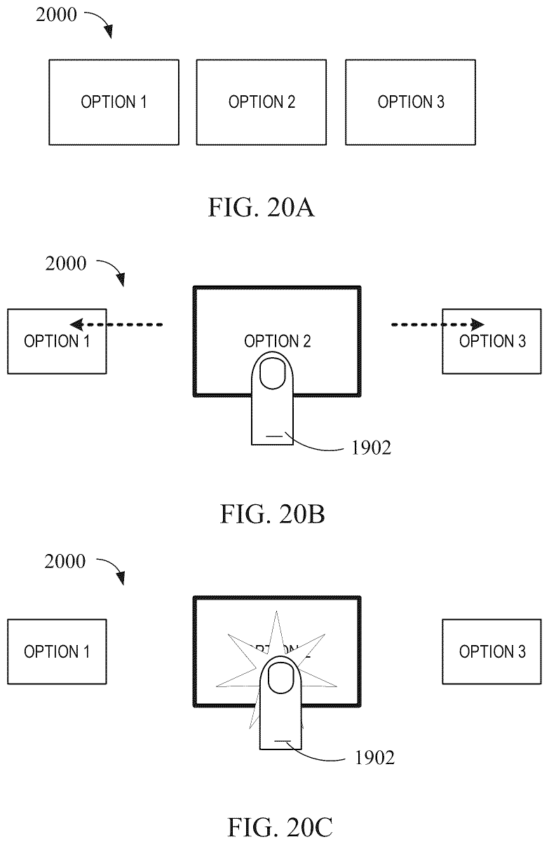

As an example, FIG. 20A shows an example virtual interface 2000 having a three user interface elements (“Option 1,” “Option 2,” and “Option 3”). As shown in FIG. 20B, upon determining that the user has placed her finger 1902 in proximity with the second user interface element, the wearable multimedia device 101 modifies the virtual interface 2000 such that the first and second user interface elements are moved away from the second user interface element. This can be beneficial, for example, in allowing the user to intuitively ascertain which of the user interface elements that her finger is hovering over. Further, the user is less likely to unintentionally select one of the other user interface elements (e.g., as the other user interface elements have been moved away from her finger).

As described above, the user can select a particular user interface element and confirm her selection by performing one or more gestures. The gestures can be performed with the hand upon which the VI 2000 is projected, her other hand, or both. As an example, as shown in FIG. 20B, the user can select the second user interface element by hovering her finger 1902 over the second user interface element. Further, as shown in FIG. 20C, the user can confirm her selection by performing a gesture using her finger 1902 (e.g., by tapping or pressing her finger 1902 on the surface upon which the VI 2000 is projected, such that the tip of the user's finger 1902 coincides with the second user interface element).

In some implementations, the wearable multimedia device 101 can determine the distance between the user's finger from the surface upon which the VI is projected (e.g., the user's palm). When this distance is within a first distance range, the wearable multimedia device 101 can continuously detect whether the user is positioning her finger in proximity with a particular user interface element, and continuously modify the VI to accentuate certain user interface elements based on the detection. However, when this distance is within a second distance range (e.g., a distance range that is less than the first distance range), the wearable multimedia device 101 can “lock” the user's selection to a particular one of the user interface elements, and refrain from allowing the user to select another one of the user interface elements unless the user has moved her finger beyond a boundary region enclosing the selected user interface element and/or beyond the second distance range. This can be beneficial, for example, in avoiding sudden changes to the VI when the user is positioning her finger to make a selection, which might otherwise confuse or frustrate the user.

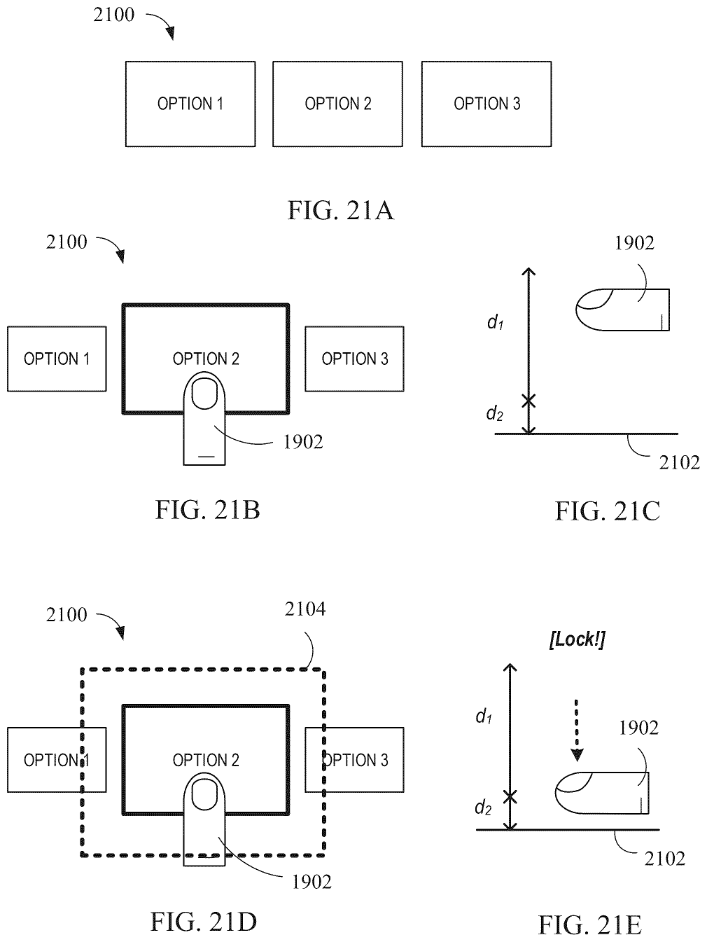

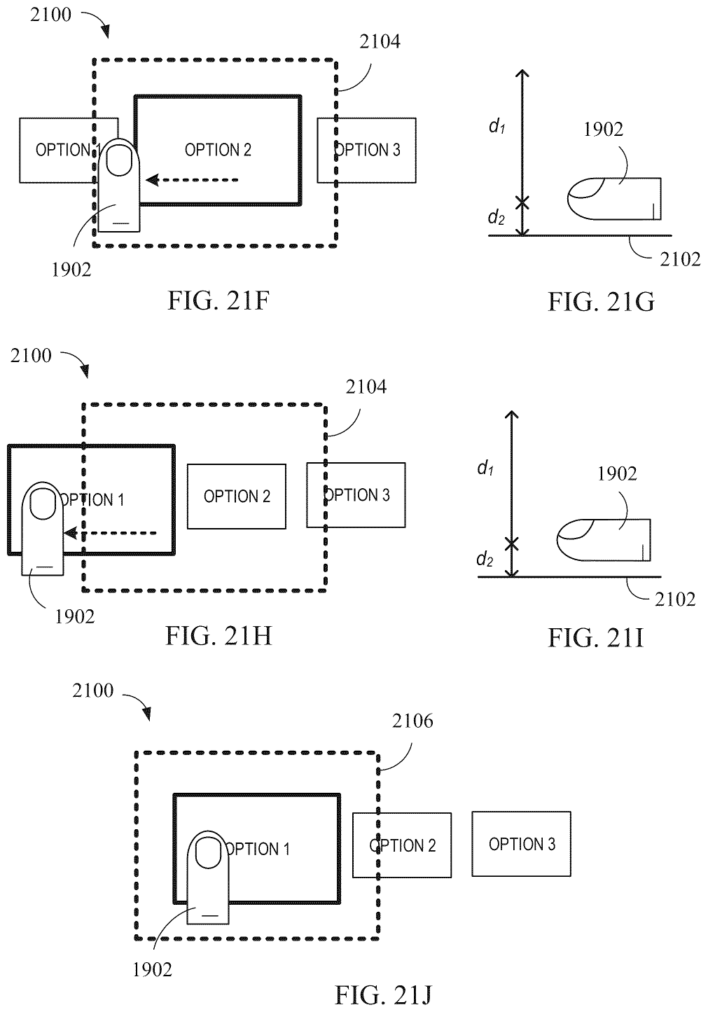

As an example, FIG. 21A shows an example virtual interface 2100 having a three user interface elements (“Option 1,” “Option 2,” and “Option 3”).

As shown in FIGS. 21B and 21C, the user positions her finger 1902 in a first distance range d₁ from the surface 2102 upon which the virtual interface 2100 is projected (e.g., the user's palm) and in proximity with the second user interface element. In response, the wearable multimedia device 101 modifies the virtual interface 2100 to accentuate the second user interface element. For example, the wearable multimedia device 101 can change the size, color, visual pattern, opacity, transparency, color, and/or any other visual characteristic of the second user interface element relative to the other user interface elements (e.g., as described with reference to FIGS. 19A-19C).

While the user's finger 1902 remains in the first distance range d₁, the wearable multimedia device 101 continuously detects whether the user is positioning her finger 1902 in proximity with a particular user interface element, and continuously modifies the VI to accentuate certain user interface elements based on the detection. For example, if the user moves her finger such that it is instead in proximity to the first user interface element (while maintaining her finger in the first distance range d₁), the wearable multimedia device 101 can modify the virtual interface 2100 to accentuate the first user interface element.

As described above, when the user moves her finger within a second distance range from the surface 2102 (e.g., a distance range that is less than the first distance range), the wearable multimedia device 101 can “lock” the user's selection to a particular one of the user interface elements. As an example, as shown in FIGS. 21D and 21E, the user moves her finger 1902 closer to the surface 2102, such that her finger 1902 remains in proximity with the second user interface element, but is within a second distance range d₂ from the surface 2102. In response, the wearable multimedia device 101 locks the user's selection to the second user interface element.

Further, as shown in FIG. 21D, the wearable multimedia device 101 defines a boundary region 2104 that encloses second user interface element. When the user's finger 1902 remains within the boundary region 2104 and within the second distance range d₂, the wearable multimedia device 101 refrains from allowing the user to select another one of the user interface elements, even if she moves her finger in proximity with another one of the user interface elements.

For example, as shown in FIGS. 21F and 21G, the user moves her finger 1902 away from the second user interface element, while maintaining her finger 1902 within the second distance range d₂ from the surface 2102. In this example, the user's finger 1902 is now in proximity with the first user interface element. However, because the user's finger 1902 remains within the boundary region 2104, the wearable multimedia device 101 maintains the user's selection of the second user interface element, and refrains from allowing the user to select the first user interface element.

Further, as shown in FIGS. 21H and 21I, the user moves her finger 1902 even farther away from the second user interface element, while maintaining her finger 1902 within the second distance range d₂ from the surface 2102. In this example, the user's finger 1902 is in proximity with the first user interface element, and is beyond the boundary region 2104. In response, the wearable multimedia device 101 update the user's selection to the first user interface element and visually accentuates the first user interface element to the user. Further, as shown in FIG. 21J, the wearable multimedia device 101 defines a new boundary region 2106 that encloses first user interface element (e.g., to lock the user's selection of the first user interface element until the user moves her finger beyond the boundary region 2106 and/or beyond the second distance range d₂).

In general, a boundary region can be larger in size than its corresponding user interface element. For example, a boundary region can fully enclose its corresponding user interface element, and can be larger than its corresponding user interface element in height and/or width. In some implementations, a boundary region can be centered on its corresponding user interface element (e.g., such that the user interface element is in the center of the boundary region). In some implementations, a boundary region can be offset from its corresponding user interface element (e.g., such that the user interface element is off center from the boundary region).

In some implementations, a boundary region can have the same shape as its corresponding user interface element. In some implementation, a boundary region can be polygonal (e.g., having the shape of a triangle, quadrilateral, pentagon, hexagon, etc.), circular, ovular, elliptical, free form, any other shape, or any combination thereof.

As an example, in FIGS. 21A-21J, each of the user interface elements is a rectangle. In some implementations, the corresponding boundary regions also can be rectangles (e.g., rectangles that are larger than the user interface elements, but otherwise having a similar shape). As another example, a user interface element can be a circle, and the corresponding boundary region also can be a circle (e.g., a circle that is larger than the user interface element). As another example, a user interface element can be a free form shape, and the corresponding boundary region can be the same free form shape (e.g., the same free form shape, but larger in size larger than the user interface element). For instance, the user interface can be an outline of a city or country (e.g., in an interactive map), an outline of an object (e.g., in an interactive image of video), or any other free form shape.

In some implementations, a boundary region can have a shape this is different from that of its corresponding user interface element. As an example, in FIGS. 21A-21J, each of the user interface elements is a rectangle. In some implementations, the corresponding boundary regions can be ellipses or some other non-rectangular shape.

Further, in some implementations, the wearable multimedia device 101 can refrain from visually presenting the boundary region to the user (e.g., such that the boundary region is “invisible” to the user). This is can be beneficial, for example, in reducing clutter in the virtual interface, which may confuse the user. Nevertheless, in some in some implementations, the wearable multimedia device 101 can visually present the boundary region to the user (e.g., such that the boundary region is visible to the user).

In some implementations, the size of a boundary region can remain the same, regardless of the distance between the user's finger and the surface upon which the virtual interface is projected (e.g., the user's palm). In some implementations, the size of a boundary can vary depending on a distance between the user's finger and the surface. For instance, the size of the boundary region can increase with a decrease in the distance between the user's finger and the surface.

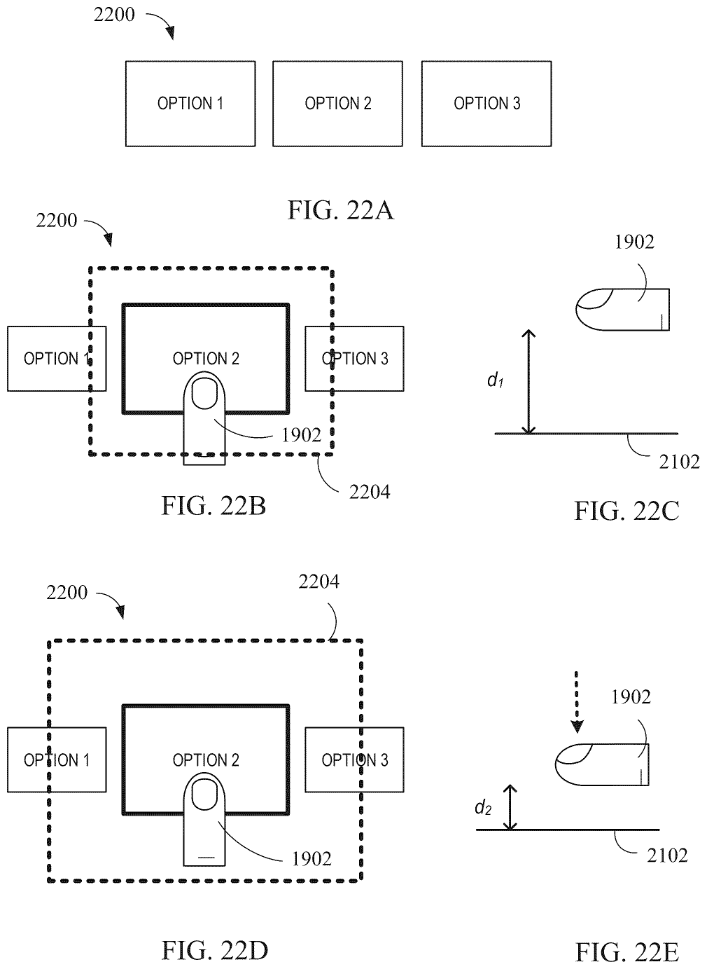

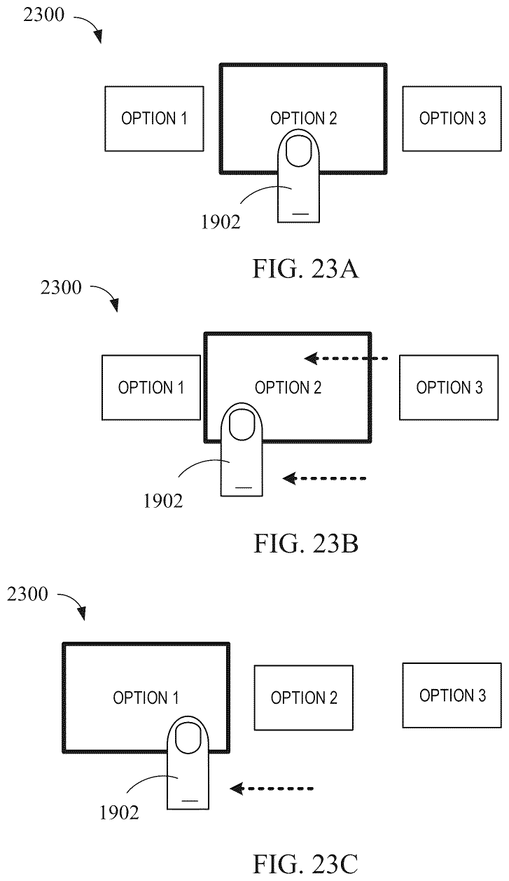

As an example, FIG. 22A shows an example virtual interface 2200 having a three user interface elements (“Option 1,” “Option 2,” and “Option 3”).

As shown in FIGS. 22B and 22C, the user positions her finger 1902 a first distance d₁ from the surface 2102 upon which the virtual interface 2200 is projected (e.g., the user's palm) and in proximity with the second user interface element. In response, the wearable multimedia device 101 modifies the virtual interface 2200 to accentuate the second user interface element. For example, the wearable multimedia device 101 can change the size, color, visual pattern, opacity, transparency, color, and/or any other visual characteristic of the second user interface element relative to the other user interface elements (e.g., as described with reference to FIGS. 19A-19C).

Further, as shown in FIG. 22B, the wearable multimedia device 101 defines a boundary region 2204 that encloses second user interface element. When the user's finger 1902 remains within the boundary region 2204, the wearable multimedia device 101 refrains from allowing the user to select another one of the user interface elements, even if she moves her finger in proximity with another one of the user interface elements.

Further, as shown in FIGS. 22D and 22E, when the user moves her finger 1902 closer to the surface 2102 (e.g., such that it is a second distance d₂ from the surface 2102), the wearable multimedia device 101 increases the size of the boundary region 2204 enclosing the second user interface element. Accordingly, in order to select another one of the user interface elements, the user must move her finger even further from the second user interface element (e.g., such that it is not within the boundary region 2204) and/or increase the distance between the finger and the surface (e.g., to decrease the size of the boundary region 2204).

In some implementations, the size of a boundary region (e.g., the area of the boundary region) can be inversely proportional of the distance between the user's finger and the surface upon which the virtual interface is projected (e.g., in a direction orthogonal to the surface).

In some implementations, the wearable multimedia device 101 can detect a user hovering above the surface upon which the virtual interface is projected and moving in a particular direction along one of the user interface elements. In response, the wearable multimedia device 101 can move that user interface element in the same direction, such that the user interface element is moved along with the user's finger. This can be beneficial, for example, in allowing the user to intuitively ascertain which of the user interface elements that her finger is hovering over.

As an example, FIG. 23A shows an example virtual interface 2300 having a three user interface elements (“Option 1,” “Option 2,” and “Option 3”). Upon determining that the user has placed her finger 1902 in proximity with the second user interface element, the wearable multimedia device 101 modifies the virtual interface 2300 to accentuate the second user interface element. For example, the wearable multimedia device 101 can change the size, color, visual pattern, opacity, transparency, color, and/or any other visual characteristic of the second user interface element relative to the other user interface elements (e.g., as described with reference to FIGS. 19A-19C).

Further, as shown in FIG. 23B, the user moves her finger 1902 towards the first user interface element. In response, the wearable multimedia device 101 moves the second user interface element in the same direction as the user's finger 1902. This gives the appearance that the second user interface element is being dragged by the user's finger 1102.

Further, as shown in FIG. 23C, the user continues moving her finger 1902 towards the first user interface element, such that her finger 1902 coincides with the first user interface element instead of the second user interface element. In response, the wearable multimedia device 101 modifies the virtual interface 2300 to accentuate the first user interface element instead. For example, the wearable multimedia device 101 can change the size, color, visual pattern, opacity, transparency, color, and/or any other visual characteristic of the first user interface element relative to the other user interface elements (e.g., as described with reference to FIGS. 19A-19C).

In the examples shown in FIGS. 19A-23C, a virtual interface includes user interface elements arranged in a row. However, in practice, a virtual interface can include user interface elements having any arrangement.

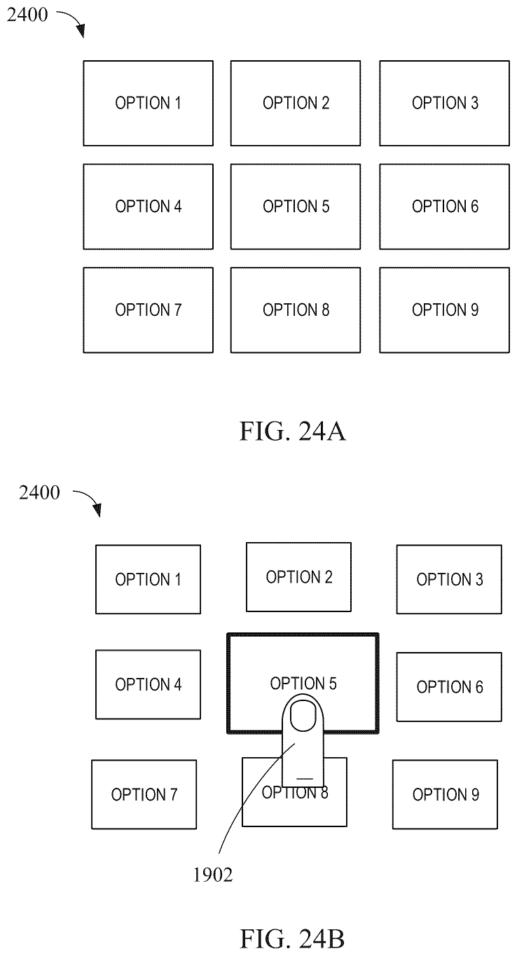

For example, as shown in FIG. 24A, a virtual interface 2400 can include several user interface elements arranged in a two-dimensional grid. Further, as shown in FIG. 24B, upon determining that the user has placed her finger 1902 in proximity with a particular one of the user interface elements (“Option 5”), the wearable multimedia device 101 can modify the virtual interface 2400 to accentuate that user interface element. For example, the wearable multimedia device 101 can change the size, color, visual pattern, opacity, transparency, color, and/or any other visual characteristic of that user interface element relative to the other user interface elements (e.g., as described with reference to FIGS. 19A-19C).

As another example, a virtual interface can include user interface elements arranged in a column. As another example, a virtual interface can include user interface elements that are freely arranged (e.g., such that they are not necessarily aligned in one or more rows and/or columns).

In some implementations, upon determining that the user has placed her finger 1902 in proximity with a particular user interface element, the wearable multimedia device 101 can performing a zoom in operation on the virtual interface (e.g., such that the field of view of the virtual interface is zoomed into the user interface element). Further, the user can scroll and/or pan through the virtual interface by moving her finger in one or more directions. This can be beneficial, for example, in allowing the user to see a particular portion of the virtual interface in greater detail (e.g., such that she can make a selection more accurate), while also allowing the user to see other portions of the virtual interface if desired.

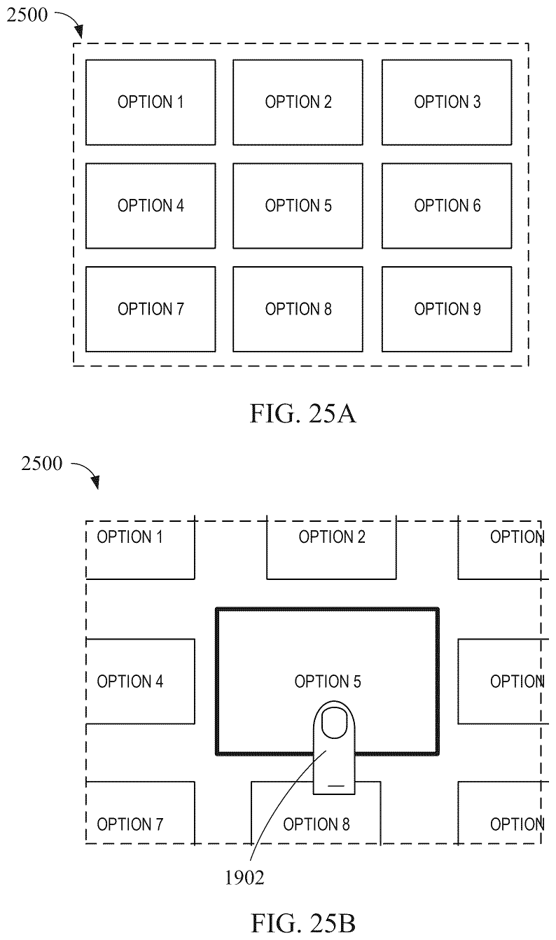

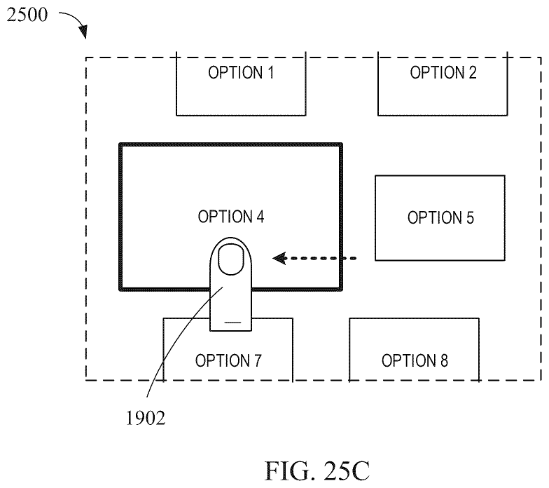

For example, as shown in FIG. 25A, a virtual interface 2500 can include several user interface elements arranged in a two-dimensional grid. Further, as shown in FIG. 25B, upon determining that the user has placed her finger 1902 in proximity with a particular one of the user interface elements (“Option 5”), the wearable multimedia device 101 can modify the virtual interface 2500 to accentuate that user interface element. For example, the wearable multimedia device 101 can change the size, color, visual pattern, opacity, transparency, color, and/or any other visual characteristic of that user interface element relative to the other user interface elements (e.g., as described with reference to FIGS. 19A-19C).

Further, the wearable multimedia device 101 can perform a zoom in operation on the virtual interface 2500, such that the field of view of the virtual interface 2500 is zoomed into the selected user interface element (“Option 5”). In some implementations, a zoom in operation can result in one or more portions of the virtual interface 2500 being positioned beyond the field of the view of the virtual interface 2500 (e.g., such that they are not visible to the user).

Further, the user can scroll and/or pan through the virtual interface 2500 by moving her finger 1902 in one or more directions. For example, as shown in FIG. 25C, upon the user moving her finger in a leftward direction, the wearable multimedia device 101 can scroll and/or pan the virtual interface 2500 to the left, such that the user can see portions of the virtual interface 2500 to the left. Further, upon determining that the user has placed her finger 1902 in proximity with another one of the user interface elements (“Option 4”), the wearable multimedia device 101 can modify the virtual interface 2500 to accentuate that user interface element. Similarly, the user can move her finger rightward, upward, and/or downward to scroll and/or pan through other portions of the virtual interface 1700.

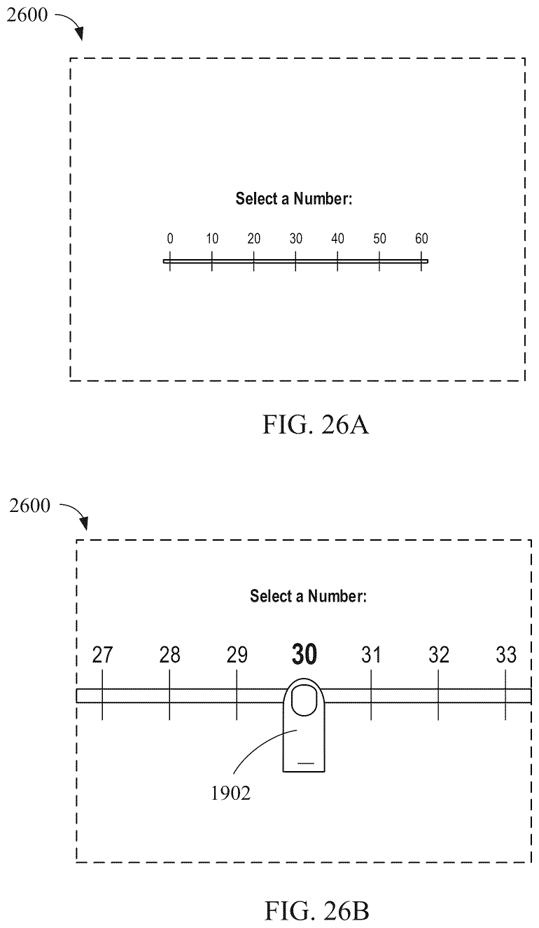

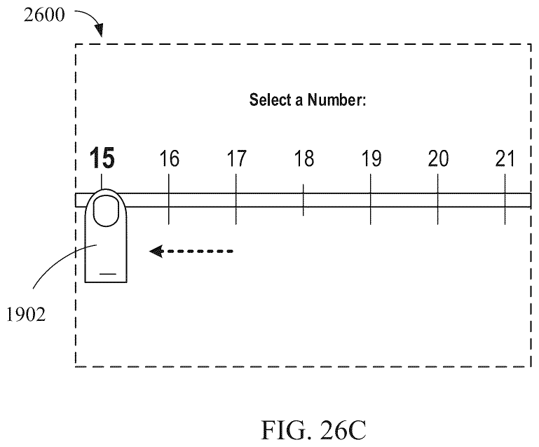

As another example, as shown in FIG. 26A, a virtual interface 2600 can include several user interface elements arranged in a row or axis. For instance, the user interface elements can represent a range of numbers that can be selected by a user.

Further, as shown in FIG. 26B, upon determining that the user has placed her finger 1902 in proximity with a particular one of the user interface elements (e.g., a user interface element representing the number 30), the wearable multimedia device 101 can modify the virtual interface 2600 to accentuate that user interface element. For example, the wearable multimedia device 101 can change the size, color, visual pattern, opacity, transparency, color, and/or any other visual characteristic of that user interface element relative to the other user interface elements (e.g., as described with reference to FIGS. 19A-19C).

Further, the wearable multimedia device 101 can perform a zoom in operation on the virtual interface 2600, such that the field of view of the virtual interface 2600 is zoomed into the selected user interface element (the user interface element representing the number 30). In some implementations, a zoom in operation can result in one or more portions of the virtual interface 2600 being positioned beyond the field of the view of the virtual interface 2600 (e.g., such that they are not visible to the user).

Further, the user can scroll and/or pan through the virtual interface 2600 by moving her finger 1902 in one or more directions. For example, as shown in FIG. 26C, upon the user moving her finger in a leftward direction, the wearable multimedia device 101 can scroll and/or pan the virtual interface 2600 to the left, such that the user can see portions of the virtual interface 2600 to the left. Further, upon determining that the user has placed her finger 1902 in proximity with another one of the user interface elements (e.g., a user interface element representing the number 15), the wearable multimedia device 101 can modify the virtual interface 2600 to accentuate that user interface element. Similarly, the user can move her finger rightward to scroll and/or pan through other portions of the virtual interface 2600.

In the example shown in FIG. 26A-26C, a virtual interface can allow a user to select a number from a range of numbers. However, in practice, a virtual interface can allow a user to select any element from a set of elements. For example, a virtual interface can allow a user to select an alphanumeric character from a set of alphanumeric characters. As another example, a virtual interface can allow a user to select a word or phrase from a set of words or phrases. As another example, a virtual interface can allow a user to select an object from a set of objects. As another example, a virtual interface can allow a user to select a name from a set of names. As another example, a virtual interface can allow a user to select a parameter value (e.g., system volume, display brightness, etc.) from a range of parameter values. As another example, a virtual interface can allow a user to select a color from a range of colors.

Although example modifications are described with reference to FIGS. 19A-26C, there are merely illustrative examples. In practice, other modifications can be performed to accentuate one user interface element from other user interface elements, either instead of or in addition to those described above. Further, although example modifications are described separately with reference to FIGS. 19A-26C, in practice, one or more of these modifications can be performed concurrently.

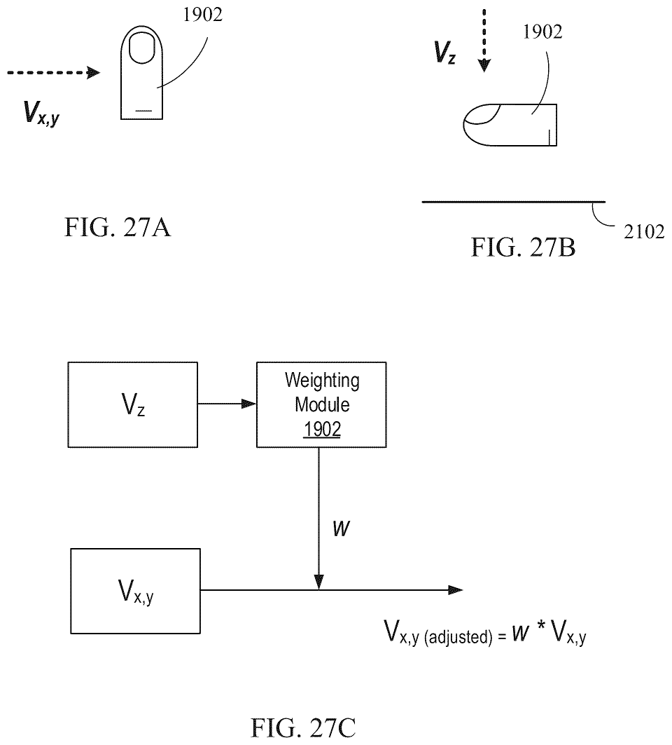

In some implementations, the wearable multimedia device can track a movement of a user's finger 1902 in a planar direction (e.g., in an x-y direction parallel to the surface upon which a virtual interface is projected, as shown in FIG. 27A). Further, the wearable multimedia device can track a movement of a user's finger 1902 in a vertical direction (e.g., in a z direction orthogonal to the surface 2102, as shown in FIG. 27B). Further, the wearable multimedia device 101 can determine a user input corresponding to the movement of the user's finger 1902, at least in part by weighing the velocity of the user's finger 1902 in the planar direction based on the velocity of the user's finger 1902 in the vertical direction.

As an example, as shown in FIG. 27C, the wearable multimedia device 101 can include a weighting module 2702 configured to receive an input value representing the velocity of the user's finger 1902 in the vertical direction V_{z}, and determine a corresponding weighting value w based on the velocity V_{z}. The weighting value w can be multiplied with the velocity of the user's finger 1902 in the planar direction V_{x,y} to determine an adjusted velocity of the user's finger 1902 in the in the planar direction V_{x,y (adjusted)}. In some implementations, the wearable multimedia device 101 can use the adjusted velocity V_{x,y (adjusted)} to track the movement of the user's finger 1902 with respect to the virtual interface (e.g., to determine whether the user has moved her finger 1902 in proximity to one or more user interface elements, as described above).

In some implementations, the weighting value w can be inversely related (e.g., inversely proportional) to the velocity V_{z}. For example, an increase in the velocity V_{z} can correspond to a decrease in the weighting value w, whereas a decrease in the velocity V_{z} can correspond to an increase in the weighting value w. Accordingly, when the movement of the user's finger 1902 in the vertical direction is stable (e.g., the user is not rapidly moving her finger in the vertical direction), the wearable multimedia device 101 is more sensitive to the movement of the user's finger 1902 in the planar direction. Further, when the movement of the user's finger 1902 in the vertical direction is less stable (e.g., the user is rapidly moving her finger in the vertical direction), the wearable multimedia device 101 is less sensitive to the movement of the user's finger 1902 in the planar direction. This can be beneficial, for example, in detecting a user's inputs with a greater degree of sensitivity when the user is more likely to be making intentional movements (e.g., when the user's finger is stable in the vertical direction), while reducing the likelihood of detected unintentional movements (e.g., when the user's finger is less stable in the vertical direction).

Although FIGS. 18-27C describe example operations that can be performed using a virtual interface (e.g., a virtual interface that is projected by a projector subsystem 832), in practice, similar operations also can be performed using other types of user interfaces. As an example, some or all of these operations can be performed using a user interface that is presented using a display device such as a computer monitor or a touch sensitive display panel.

### Example Scrollable Virtual Interfaces

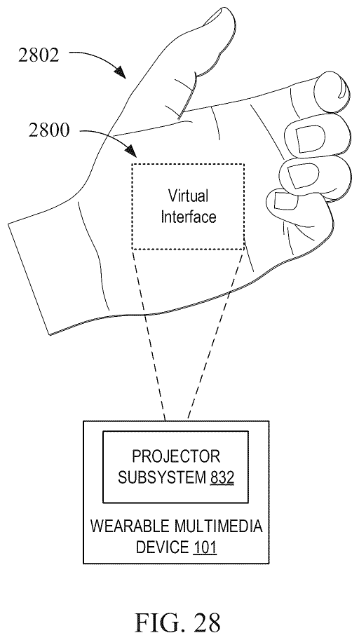

As described above, a wearable multimedia device 101 can include a projector subsystem 832 configured to present information visually to a user in the form of projected light. For example, the projector subsystem 832 can project light onto a surface (e.g., a surface of a user's hand, such as the user's palm) according to a particular spatial and/or temporal pattern, such that the user perceives text, images, videos, colors, patterns, and/or any other graphical information on the surface. As an illustrative example, FIG. 28 shows a virtual interface 2800 projected by a projector subsystem 832 onto a user's palm 2802.

In general, the user can perform gestures to interact with one or more user interface elements of the virtual interface. For instance, the user can perform one or more gestures directed at one or more of the user interface elements. As examples, the user can point to a user interface element, touch or tap a user interface element using her finger (e.g., a single time, or multiple times in a sequence), perform a swiping motion along a user interface element using her finger, wave at a user interface element using her hand, hover over the user interface element, or perform any other hand or finger gesture. In some implementations, a user can perform a gesture using a single hand at a time (e.g., using the hand upon which the VI is projected or her other hand). In some implementations, a user can perform a gesture using two hands concurrently. The wearable multimedia device 101 can detect the performed gestures using one or more sensors (e.g., the camera/video subsystems 820, environment sensor(s) 817, depth sensor(s) 814, etc.), identify one or more commands associated with those gestures, and execute the identified commands (e.g., using the processor(s) 804).

At least some of the user interface elements and/or commands can be used to control the operation of the wearable multimedia device 101. For example, at least some of the user interface elements and/or commands can be used to execute or control the generation of video and/or audio content, the viewing of content, the editing of content, the storing and transmission data, and/or any other operation described herein.

In some implementations, there may be little surface area on which to project a detailed virtual interface. For example, a user's palm may be relatively small (e.g., compared to the display screen of a smartphone or tablet). Thus, there may be constraints regarding the size, number, and/or density of user interface elements that are presented on the virtual interface, such that they can be readily discerned by the user while also not overwhelming the user with minute detail.

In some implementations, a wearable multimedia device 101 can present information to a user using a scrollable virtual interface. For instance, the wearable multimedia device 101 can present a portion of a virtual interface to a user, and allow the user to scroll or pan the virtual interface to view other portions of the virtual interface. This can be beneficial, for example, in allowing the user to see a particular portion of the virtual interface in greater detail, while also allowing the user to see other portions of the virtual interface if desired.

For instance, the wearable multimedia device 101 can present text, images, videos, and/or other content to the user according to a particular layout, whereby at least some of the content is beyond a field of view of the virtual interface. Further, the wearable multimedia device can allow a user to selectively scroll or pan to different portions of the virtual interface, such that the user can view different portions of the content.

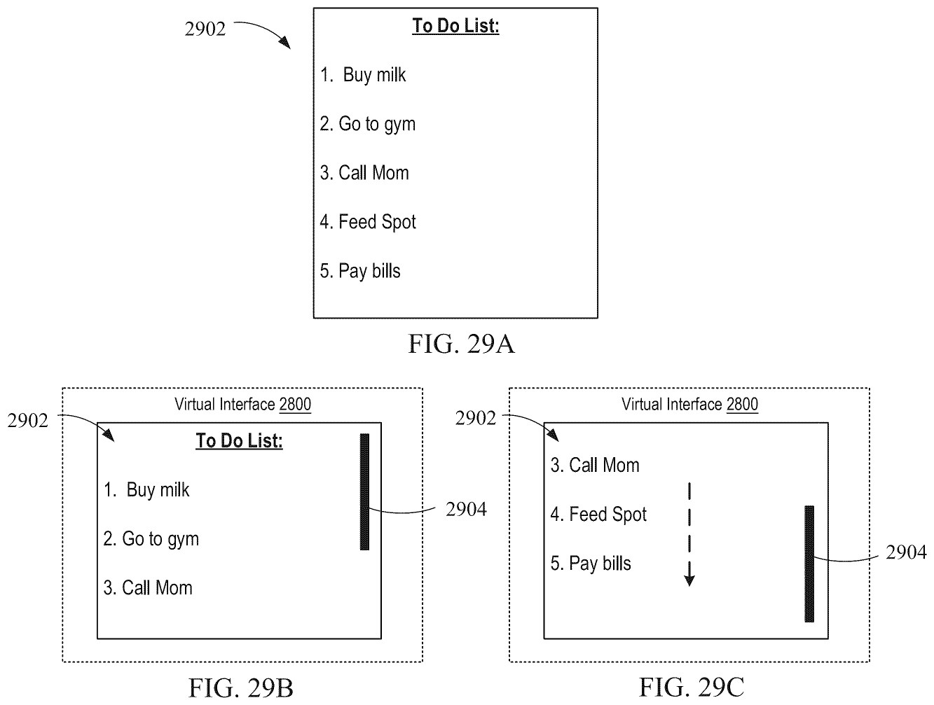

As an example, FIG. 29A shows content 2902 that can be displayed by a virtual interface. In this example, the content 2902 includes text content (e.g., in the form of a list). However, in practice, content 2902 can include any combination of text, images, videos, and/or other content.

As shown in FIG. 29B, the wearable multimedia device 101 can present a portion of the content 2902 (e.g., an upper portion of the content 2902) in the virtual interface 2800. Further, as shown in FIG. 29C, the wearable multimedia device 101 can allow a user to scroll the virtual interface 2800 to view other portions of the content 2902. For example, the user can instruct the wearable multimedia device 101 to scroll in a downward direction to view a lower portion of the content 2902. In some implementations, a user interface element 2904 (e.g., a scroll bar) can be used to visually indicate the portion of the content that is being shown.

In some implementations, the wearable multimedia device 101 can be configured to scroll a virtual interface in response to one or more gestured performed by the user. As an example, a user can perform one or more first gestures to instruct the wearable multimedia device 101 to scroll a virtual interface in a first direction (e.g., upward), one or more second gestures to instruct the wearable multimedia device 101 to scroll a virtual interface in a second direction (e.g., downward), one or more third gestures to instruct the wearable multimedia device 101 to scroll a virtual interface in a third direction (e.g., rightward), and so forth. The wearable multimedia device 101 can detect the user performing these gestures using one or more sensors (e.g., the camera/video subsystem 820, depth sensor(s) 814, motion sensor(s) 810, and/or any other sensors), and scroll the virtual interface in accordance with the user's instructions. Example gestures are described in further detail below.

The implementations described herein can provide various technical benefits. For example, at least some of these implementations allow a user to interpret a virtual interface and interact with the virtual interface in a more intuitive manner. For instance, as discussed above, there may be little surface area on which to project a detailed virtual interface. Therefore, a user might otherwise have difficulty discerning the contents of the virtual interface, particularly if the user interface elements in the virtual interface are small and/or presented in a dense manner. However, by allowing a user to scroll through the virtual content through the performance of gestures, the wearable multimedia device 101 can present content to the user according to a larger size and/or in a less dense manner. Accordingly, the user can browse through the contents of the virtual interface and interact with the virtual interface more easily and accurately.

Further, these techniques can reduce the occurrence of erroneous and/or unintended selections by the user, which can reduce the resources expended by the wearable multimedia device 101 during operation. For instance, if a user selects a particular user interface element in error, the wearable multimedia device 101 may perform certain operations unnecessarily (e.g., contrary to the user's intentions). Further, the user may spend more time interacting with the wearable multimedia device 101 to correct or reverse her erroneous selection. Accordingly, the wearable multimedia device 101 may expend resources—such as computational resources (e.g., CPU cycles), memory resources, storage resources, network resources, and/or battery resources—that might otherwise not need to be expended. By reducing the likelihood of user error in interaction with the virtual interface, the wearable multimedia device 101 can reduce the expenditure of resources in correcting or reversing those errors. Thus, the wearable multimedia device 101 can operate in a more efficient manner.

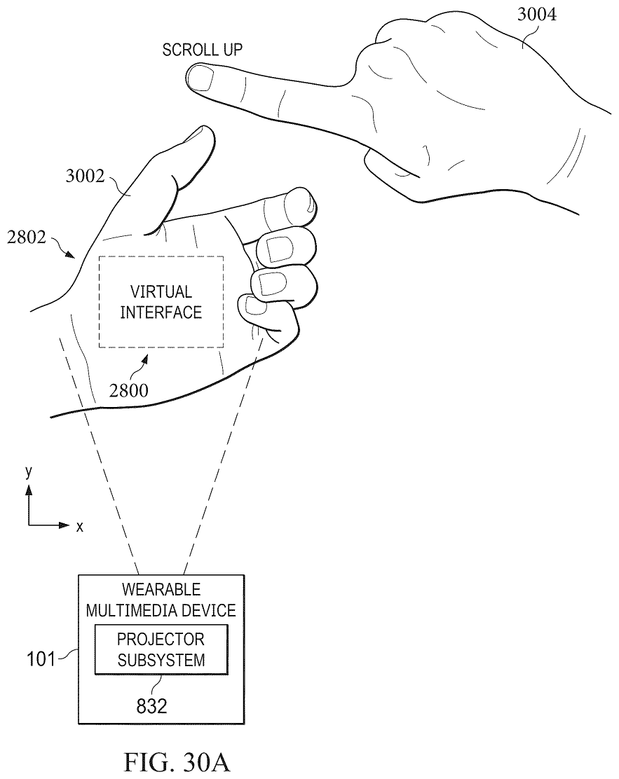

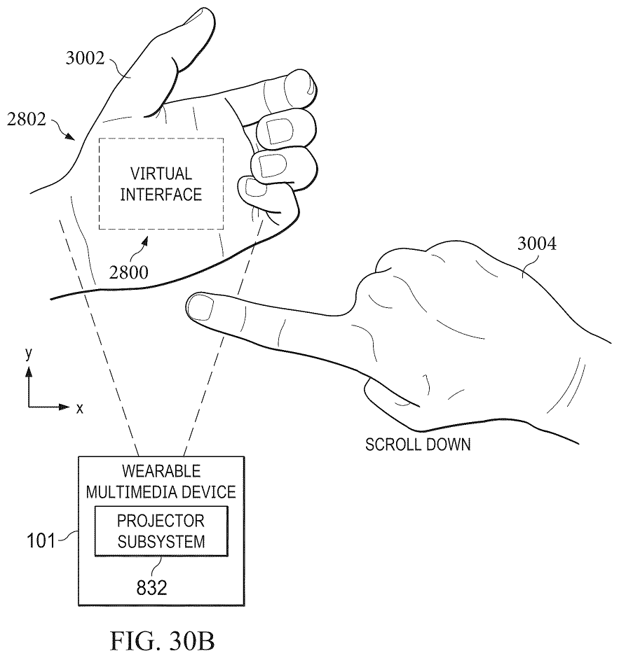

FIGS. 30A and 30B show example gestures that can be performed by a user to scroll a virtual interface 2800. In this example, the virtual interface 2800 is presented according to an x-y plane (e.g., on a plane parallel to the surface 1802) on a hand 3002 of the user. As shown in FIG. 30A, a user can position her opposite hand 3004 above the virtual interface 2800 (e.g., in the positive y-direction) with a single finger (e.g., index finger) pointing outward to instruct the wearable multimedia device 101 to scroll the virtual interface 2800 in an upward direction. Further, as shown in FIG. 30B, the user can position her hand 3004 below the virtual interface 2800 (e.g., in the negative y-direction) with the single finger pointing outward to instruct the wearable multimedia device 101 to scroll the virtual interface 2800 in a downward direction.

In some implementations, the wearable multimedia device 101 can continuously scroll the virtual interface upward when the user's hand 3004 is performing the gesture shown in FIG. 30A, and cease the upward scrolling when the user's hand 3004 is no longer performing that gesture. Further, the wearable multimedia device 101 can continuously scroll the virtual interface downward when the user's hand 3004 is performing the gesture shown in FIG. 30B, and cease the downward scrolling when the user's hand 3004 is no longer performing that gesture.

In the example gestures shown in FIGS. 30A and 30B, the user's hand 3004 has a single finger (e.g., the index finger) pointing outward. However, in some implementations, the wearable multimedia device 101 can be configured to scroll the virtual interface 2800 in response to the user performing gestures in which other numbers of fingers and/or other combinations of fingers are pointed outward. As an example, the wearable multimedia device 101 can be configured to scroll the virtual interface 2800 in an upward direction in response to the user positioning her hand 3004 above the virtual interface 2800 with two fingers (e.g., an index finger and a middle finger) pointed outward, and to scroll the virtual interface 2800 in a downward direction in response to the user positioning her hand 3004 below the virtual interface 2800 with two fingers (e.g., the index finger and the middle finger) pointed outward.

As described above, the wearable multimedia device 101 can continuously scroll the virtual interface when the user is performing a particular gesture, and cease the scrolling when the user is no longer performing that gesture. In some implementations, the wearable multimedia device 101 can continuously scroll the virtual interface according to a variable scrolling speed. The variable scrolling speed can vary based on the position of the user's hand 3004 relative to the position of the user's hand 3002 and/or virtual interface 2800. For example, the user can control the speed at which the virtual interface 2800 is scrolled by moving her hand to a particular position, and adjusting the position of her hand until the desired scrolling speed is selected.

In some implementations, the variable scrolling speed can increase with an increase in distance between (i) the position of a particular portion of the user's hand 3004 and (ii) the position of a particular portion of the user's hand 3002 and/or virtual interface 2800. In some implementations, the variable scrolling speed can be vary proportionally with the distance between (i) the position of a particular portion of the user's hand 3004 and (ii) the position of a particular portion of the user's hand 3002 and/or virtual interface 2800.

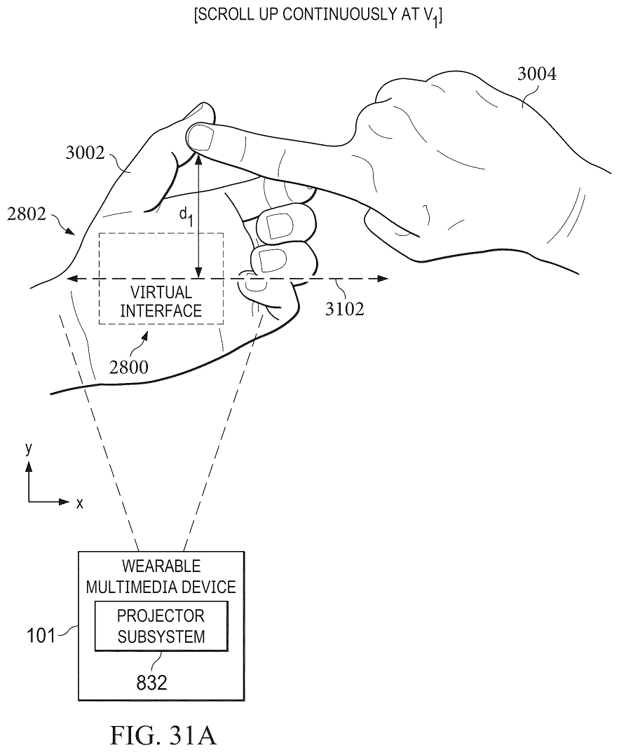

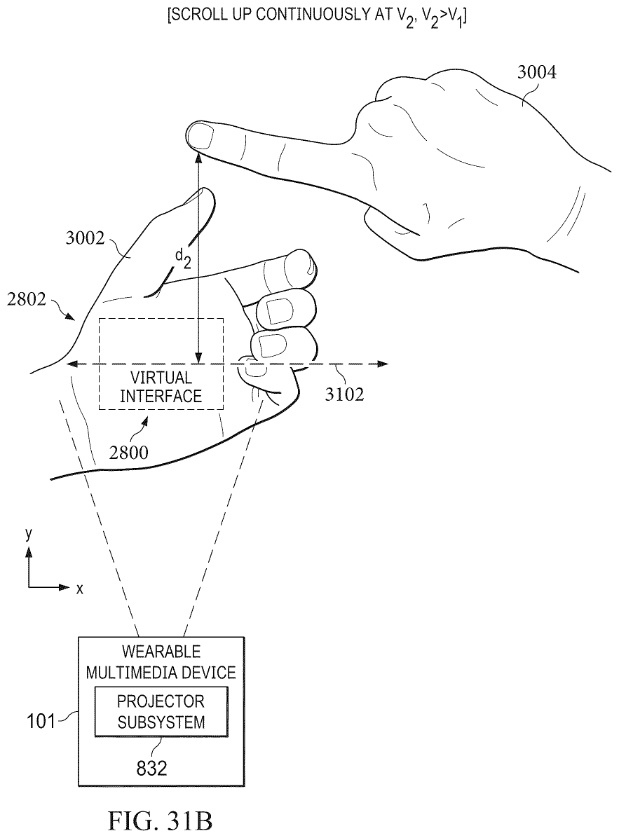

As an example, as shown in FIG. 31A, a user can position her hand 3004 above the virtual interface 2800 (e.g., in the positive y-direction) with a single finger (e.g., index finger) pointing outward to instruct the wearable multimedia device 101 to scroll the virtual interface 2800 in an upward direction. The wearable multimedia device 101 determines that a distance d₁ separates the position of a portion of the user's hand 3004 (e.g., the tip of the index finger) from a reference line 3102 extending through the virtual interface 2800 (e.g., extending along the x-direction). The wearable multimedia device 101 determines a scrolling speed V₁ based on the distance d₁, and continuously scrolls the virtual interface 2800 according to the scrolling speed V₁ while the user's hand remains in the position shown in FIG. 31A.

As shown in FIG. 31B, the user can move her hand 3004 upward (e.g., in the positive y-direction). The wearable multimedia device 101 determines that a distance d₂ separates the position of a portion of the user's hand 3004 (e.g., the tip of the index finger) from the reference line 3102. The wearable multimedia device 101 determines a new scrolling speed V₂ based on the distance d₂, and continuously scrolls the virtual interface 2800 according to the scrolling speed V₂ while the user's hand remains in its position shown in FIG. 31B.

In some implementations, the scrolling speed V₂ can be greater than the scrolling speed V₁. In some implementations, the increase in speed from V₁ to V₂ can be proportional to the increase in distance from d₁ to d₂. In some implementations, scrolling speed can vary according to some other relationship with distance (e.g., non-linear relationship, exponential relationship, hyperbolic relationship, asymptotic relationship, etc.).

In some implementations, the reference line 3102 can extend through a center of the virtual interface 2800. In some implementations, the reference line 3102 can extend through some other portion of the virtual interface 2800 (e.g., an upper portion, lower portion, etc.).

In the example shown in FIGS. 31A and 31B, the measured distances (e.g., d₁ and d₂) represent the distance between a particular portion of a user's hand 3004 (e.g., a tip of the index finger) and a reference line 3102. However, in practice, the measured distances can represent the distance between (i) any portion of the user's hand 3004 (e.g., a tip of another finger, a joint, the palm, etc.), and (ii) any other reference line or point (e.g., a top of the virtual interface 2800, a bottom of the virtual interface 2800, a point on the user's hand 3002, etc.).

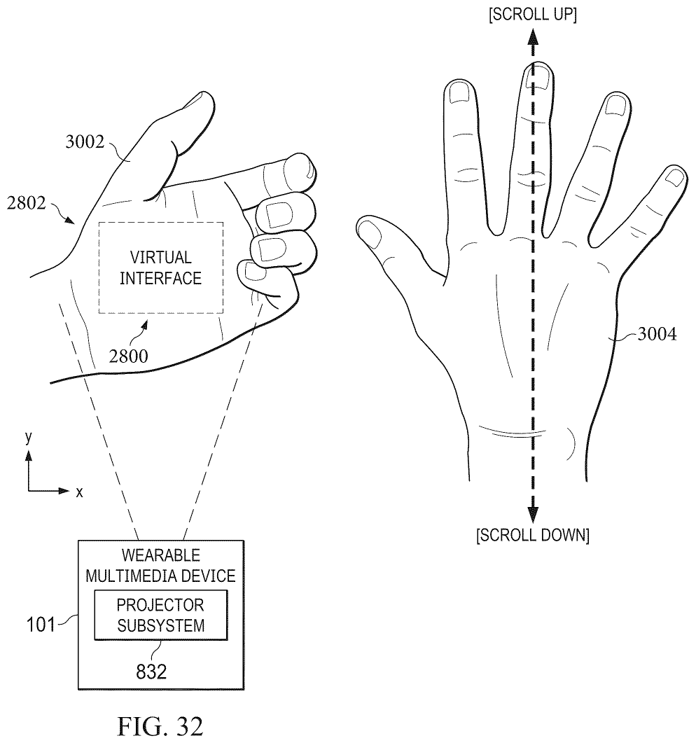

FIG. 32 show another example gesture that can be performed by a user to scroll a virtual interface 2800. In this example, the virtual interface 2800 is presented according to an x-y plane (e.g., on a plane parallel to the surface 2802) on a hand 3002 of the user. A user can position her opposite hand 3004 beside the virtual interface 2800 with a particular number and/or combination of fingers pointed outward (in this case, all five fingers) and move her hand in an upward direction (e.g., in the positive y-direction) to instruct the wearable multimedia device 101 to scroll the virtual interface 2800 in an upward direction. Further, the user can instead move her hand in a downward direction (e.g., in the negative y-direction) to instruct the wearable multimedia device 101 to scroll the virtual interface 2800 in a downward direction.

In some implementations, the wearable multimedia device 101 can scroll the virtual interface 2800 by a particular amount based on the distance that the user moves her hand 3004. For example, if the user moves her hand upward by 1 inch, the wearable multimedia device 101 can scroll the virtual interface 2800 upward by a particular number of units (e.g., 100 pixels). As another example, if the user moves her hand upward by 2 inches, the wearable multimedia device 101 can scroll the virtual interface 2800 upward by a greater number of units (e.g., 200 pixels). In some implementations, the wearable multimedia device 101 can continuously determine the position of the user's hand 3004, and scroll the virtual interface 2800 upward or downward in real time based on the movements of the user's hand 3004.

In some implementations, the wearable multimedia device 101 can continuously scroll the virtual interface upward when the user's hand 3004 is performing a particular gesture, and cease the upward scrolling when the user's hand 3004 is no longer performing that gesture. Further, the wearable multimedia device 101 can continuously scroll the virtual interface downward when the user's hand 3004 is performing another gesture, and cease the downward scrolling when the user's hand 3004 is no longer performing that gesture.

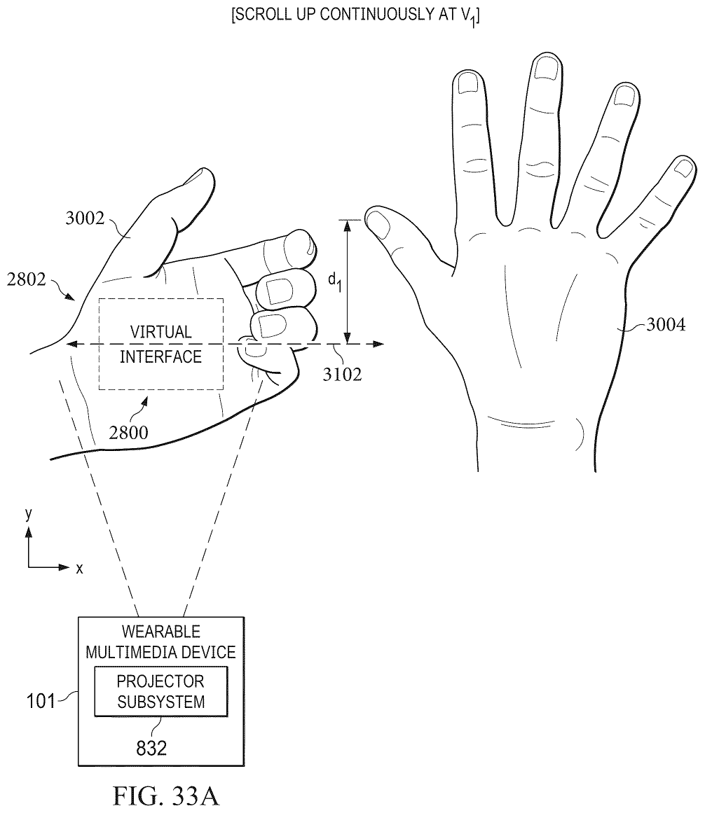

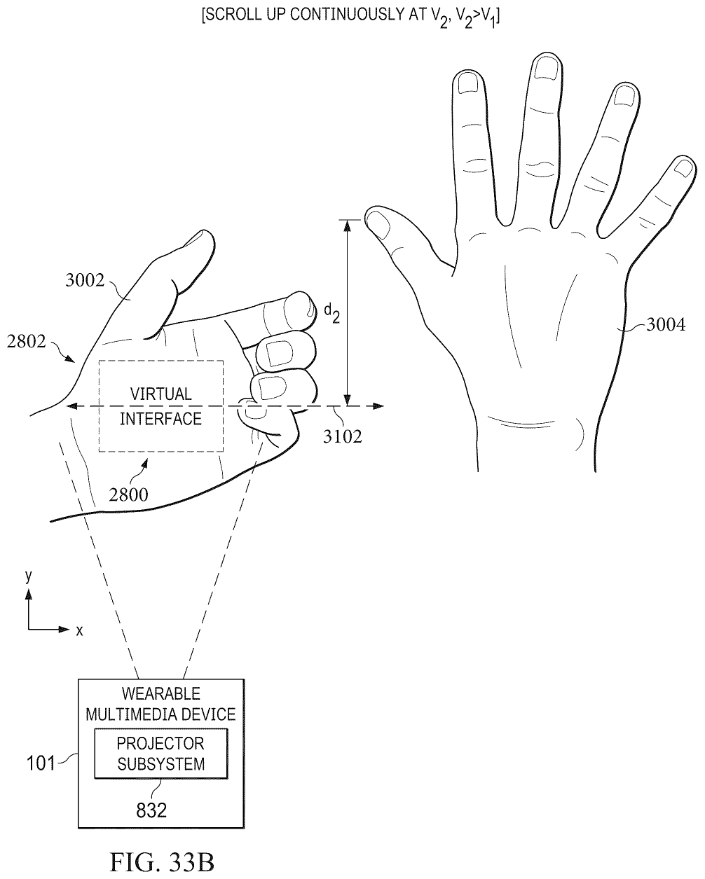

For example, FIG. 33A shows a gesture in which the user's hand 3004 has a particular number of fingers pointing outward (in this case, all five fingers), and is positioned higher than a reference line 3102 (e.g., in the positive y-direction) that extends through the virtual interface 2800. The wearable multimedia device 101 can detect the user performing this gesture, and in response, continuously scroll the virtual interface upward while the user's hand 3004 is performing this gesture.

As another example, FIG. 33B shows a gesture in which the user's hand 3004 has a particular number of fingers pointing outward (in this case, all five fingers), and is positioned lower than the reference line 3102 (e.g., in the negative y-direction). The wearable multimedia device 101 can detect the user performing this gesture, and in response, continuously scroll the virtual interface downward while the user's hand 3004 is performing this gesture.

In some implementations, the variable scrolling speed can increase with an increase in distance between (i) the position of a particular portion of the user's hand 3004 and (ii) the position of a particular portion of the user's 3002 and/or virtual interface 2800. In some implementations, the variable scrolling speed can be vary proportionally with the distance between (i) the position of a particular portion of the user's hand 3004 and (ii) the position of a particular portion of the user's 3002 and/or virtual interface 2800.

As an example, as shown in FIG. 33A, a user can position her hand 3004 higher than the virtual interface 2800 (e.g., in the positive y-direction) with five fingers pointing outward to instruct the wearable multimedia device 101 to scroll the virtual interface 2800 in an upward direction. The wearable multimedia device 101 determines that a distance d₁ separates the position of a portion of the user's hand 3004 (e.g., a center of the user's palm) from a reference line 3102 extending through the virtual interface 2800 (e.g., extending along the x-direction). The wearable multimedia device 101 determines a scrolling speed V₁ based on the distance d₁, and continuously scrolls the virtual interface 2800 according to the scrolling speed V₁ while the user's hand remains in the position shown in FIG. 33A.

As shown in FIG. 33B, the user can move her hand 3004 upward (e.g., in the positive y-direction). The wearable multimedia device 101 determines that a distance d₂ separates the position of a portion of the user's hand 3004 (e.g., the center of the user's palm) from the reference line 3102. The wearable multimedia device 101 determines a new scrolling speed V₂ based on the distance d₂, and continuously scrolls the virtual interface 2800 according to the scrolling speed V₂ while the user's hand remains in its position shown in FIG. 33B.

As described above (e.g., with reference to FIGS. 31A and 31B), in some implementations, the scrolling speed V₂ can be greater than the scrolling speed V₁. In some implementations, the increase in speed from V₁ to V₂ can be proportional to the increase in distance from d₁ to d₂. In some implementations, scrolling speed can vary according to some other relationship with distance (e.g., non-linear relationship, exponential relationship, hyperbolic relationship, asymptotic relationship, etc.).

In some implementations, the reference line 3102 can extend through a center of the virtual interface 2800. In some implementations, the reference line 3102 can extend through some other portion of the virtual interface 2800 (e.g., an upper portion, lower portion, etc.).

In the example shown in FIGS. 33A and 33B, the measured distances (e.g., d₁ and d₂) represent the distance between a particular portion of a user's hand 3004 (e.g., the center of the user's palm) and a reference line 3102. However, in practice, the measured distances can represent the distance between (i) any portion of the user's hand 3004 (e.g., a tip of a finger, a joint, etc.), and (ii) any other reference line or point (e.g., a top of the virtual interface 2800, a bottom of the virtual interface 2800, a point on the user's hand 3002, etc.).

In the example gestures shown in FIGS. 32, 33A, and 33B, the user's hand 3004 has all five fingers pointing outward. However, in some implementations, the wearable multimedia device 101 can be configured to scroll the virtual interface 2800 in response to the user performing gestures in which other numbers of fingers and/or other combinations of fingers are pointed outward.

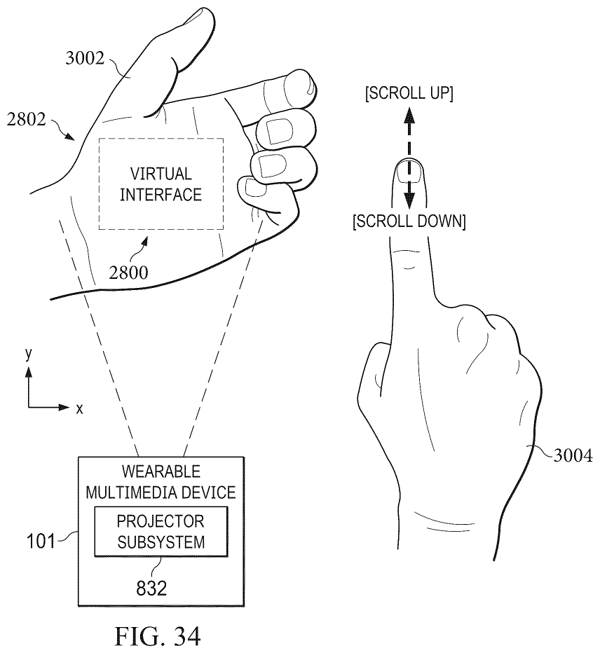

As an example, as shown in FIG. 34, the wearable multimedia device 101 can be configured to scroll the virtual interface 2800 in an upward direction in response to the user positioning her hand 3004 higher than the virtual interface 2800 (e.g., in the positive y-direction) with one finger (e.g., an index finger) pointed outward. Further, the wearable multimedia device 101 can be configured to scroll the virtual interface 2800 in a downward direction in response to the user positioning her hand 3004 lower than the virtual interface 2800 (e.g., in the negative y-direction) with one finger (e.g., an index finger) pointed outward.

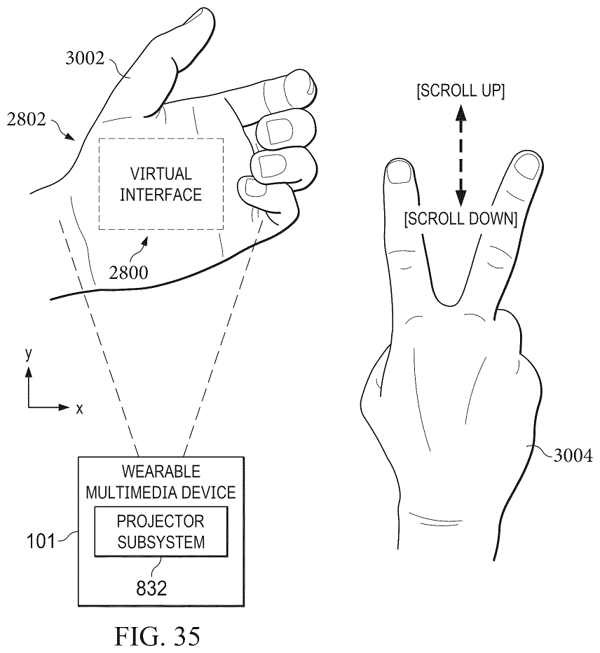

As another example, as shown in FIG. 35, the wearable multimedia device 101 can be configured to scroll the virtual interface 2800 in an upward direction in response to the user positioning her hand 3004 higher than the virtual interface 2800 (e.g., in the positive y-direction) with two fingers (e.g., an index finger and a middle finger) pointed outward. Further, the wearable multimedia device 101 can be configured to scroll the virtual interface 2800 in a downward direction in response to the user positioning her hand 3004 lower than the virtual interface 2800 (e.g., in the negative y-direction) with two fingers (e.g., the index finger and the middle finger) pointed outward.

In some implementations, the wearable multimedia device 101 can be configured to scroll the virtual interface 2800 in response to a user hovering her finger over a particular portion of the virtual interface 2800 (e.g., in the positive z-direction, where the z-direction is orthogonal to the x-y plane) and performing a gesture.

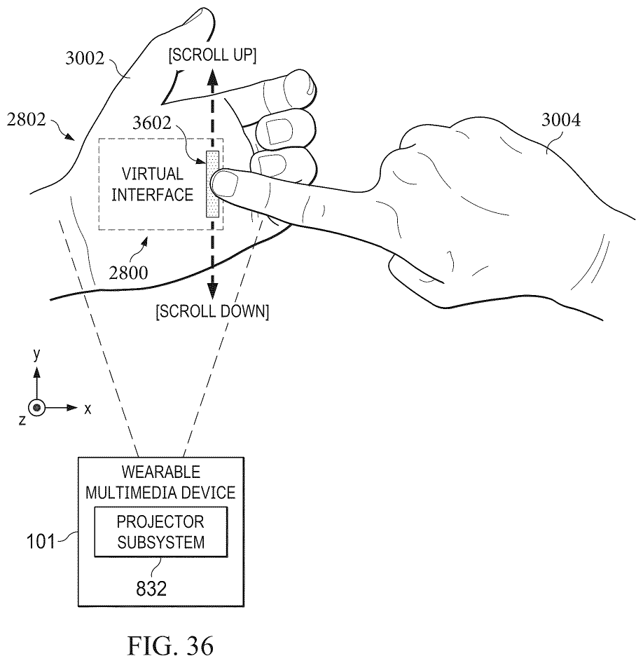

As an example, as shown in FIG. 36, a virtual interface 2800 can include a user interface element 3602 (e.g., a scroll bar). The user can position her hand 3004 such that a tip of a finger (e.g., an index finger) is hovering over the user interface element 3602 (e.g., in the positive z-direction). The finger can move her hand 3004 in an upward direction (e.g., in the positive y-direction) along the user interface element 3602) to instruct the wearable multimedia device 101 to scroll the virtual interface 2800 in an upward direction. Further, the user can move her hand 3004 in a downward direction (e.g., in the negative y-direction) along the user interface element 3602 to instruct the wearable multimedia device 101 to scroll the virtual interface 2800 in a downward direction.

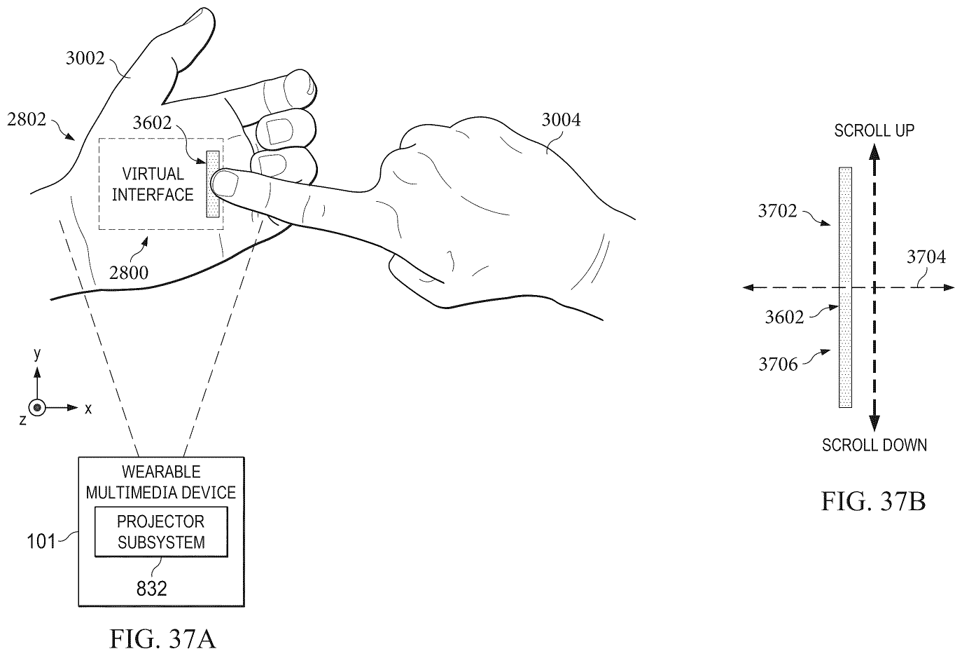

In some implementations, the wearable multimedia device 101 can continuously scroll the virtual interface upward or downward, depending on the position of the user's hand relative to the user interface element 3602. For example, referring to FIG. 37A, the user can position her hand 3004 such that a tip of a finger (e.g., an index finger) is hovering over the user interface element 3602 (e.g., in the positive z-direction). The wearable multimedia device 101 can determine a scrolling direction and a scrolling speed based on the position of the tip of the finger.

For instance, referring to FIG. 37B, if the tip of the user's finger is positioned along an upper portion 3702 of the user interface element 3602 (e.g., a portion above a reference line 3704), the wearable multimedia device 101 can continuously scroll the virtual interface upward (e.g., in a positive y-direction). Further, if the tip of the user's finger is positioned along a lower portion 3706 of the user interface element 3602 (e.g., a portion below the reference line 3704), the wearable multimedia device 101 can continuously scroll the virtual interface downward (e.g., in a negative y-direction).

Further, the wearable multimedia device 101 can determine a scrolling speed based on the position of the tip of the finger relative to the user interface element 3602. For example, the wearable multimedia device 101 can determine a distance between the tip of the user's finger and the reference line 3704 (e.g., along the y-direction), and determine a corresponding scrolling speed based on the distance. In some implementations, the scrolling speed can increase with an increase in this distance. In some implementations, the scrolling speed can be vary proportionally with this distance.

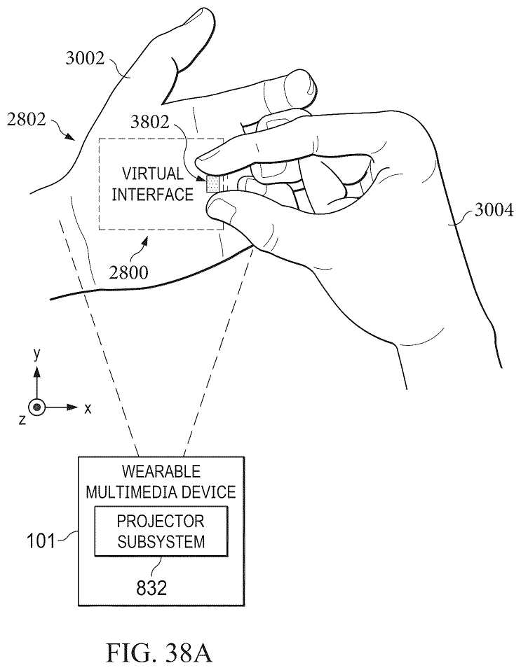

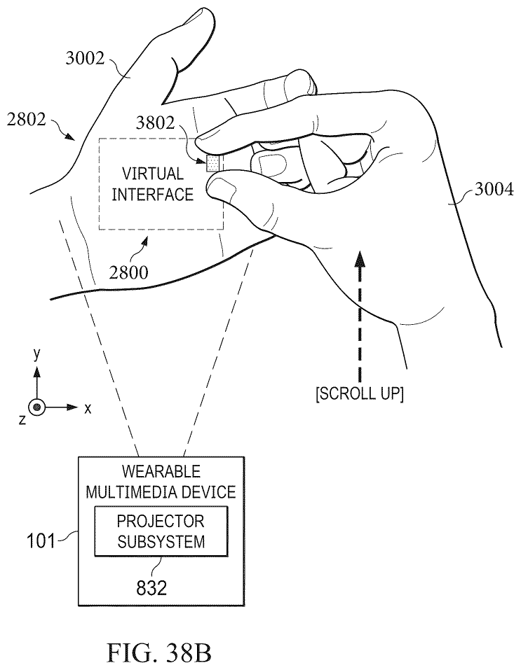

As an example, as shown in FIGS. 38A, a virtual interface 2800 can include a user interface element 3802 (e.g., a scroll bar). While hovering her hand 3004 over the virtual interface 2800 (e.g., in the positive z-direction), the user can perform a pinching gesture with her hand 3004 on the user interface element 3802 (e.g., by moving her index finger and her thumb towards each other, such that they are on opposing sides of the user interface element 3802). As shown in FIG. 38B, the user can maintain the pinching gesture and move her hand in an upward direction (e.g., in the positive y-direction) to instruct the wearable multimedia device 101 to scroll the virtual interface 2800 in an upward direction. Further, the user can maintain the pinching gesture and move her hand in a downward direction (e.g., in the negative y-direction) to instruct the wearable multimedia device 101 to scroll the virtual interface 2800 in a downward direction. The user can cease the pinching gesture (e.g., by moving her index finger and thumb away from each other) to instruct the multimedia device 101 to cease scrolling the virtual interface 2800.

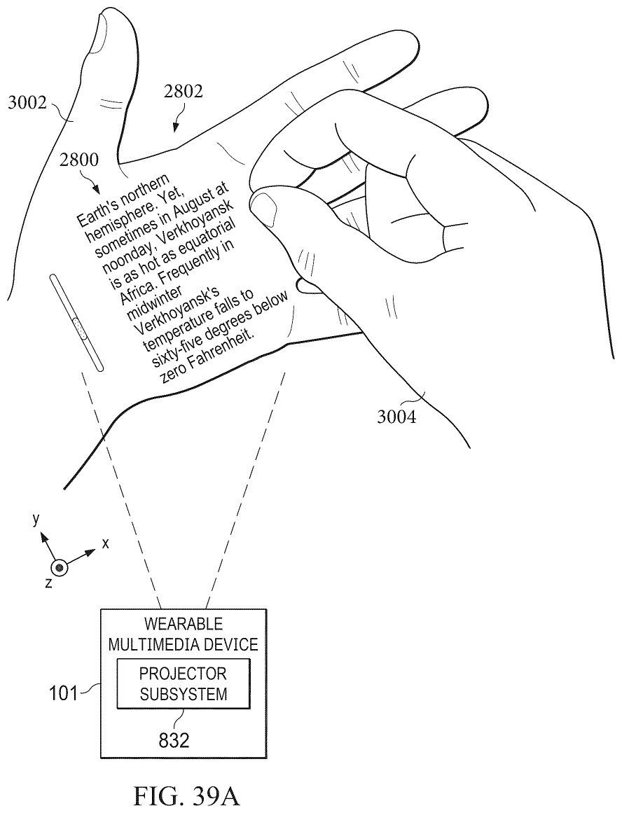

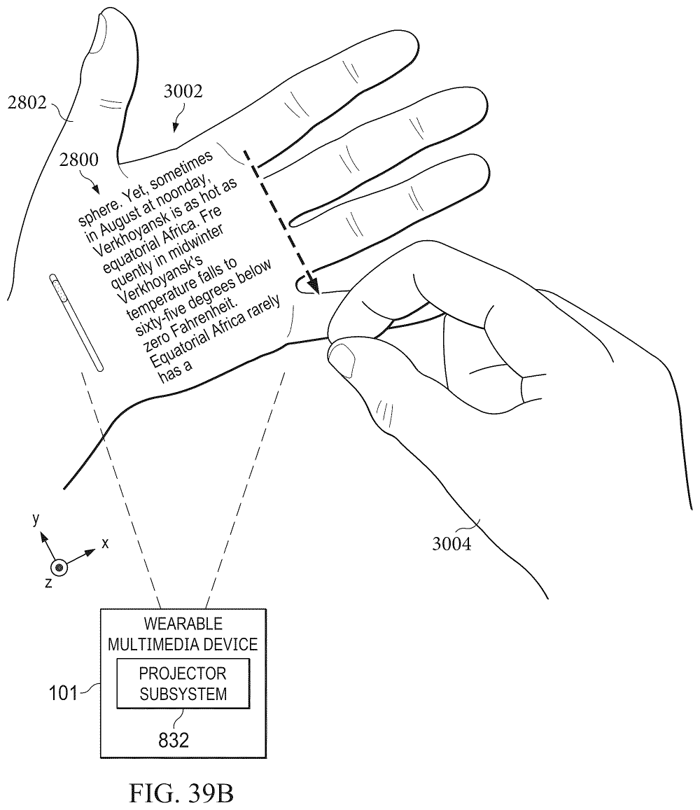

In the example gesture shown in FIGS. 38A and 38B, a user hovers her hand 3004 over the virtual interface 2800, and performs a pinching gesture with her hand 3004 on the user interface element 3802. However, in some implementations, a user can perform a pinching gesture along any portion of the virtual interface 2800. For example, referring to FIG. 39A, while hovering her hand 3004 over the virtual interface 2800 (e.g., in the positive z-direction), the user can perform a pinching gesture with her hand 3004 along any portion of the virtual interface 2800 (e.g., by moving her index finger and her thumb towards each other). As shown in FIG. 39B, the user can maintain the pinching gesture and move her hand in a downward direction (e.g., in the negative y-direction) to instruct the wearable multimedia device 101 to scroll the virtual interface 2800 in a downward direction. Further, the user can maintain the pinching gesture and move her hand in an upward direction (e.g., in the positive y-direction) to instruct the wearable multimedia device 101 to scroll the virtual interface 2800 in an upward direction. The user can cease the pinching gesture (e.g., by moving her index finger and thumb away from each other) to instruct the multimedia device 101 to cease scrolling the virtual interface 2800.

In the examples shown in FIG. 38A-39B, a user can instruct the wearable multimedia device 101 to scroll the virtual interface 101 by performing a pinching gesture while hovering her hand 3004 above the surface 2802, and moving her hand 3004 along the x-y plane. In some implementations, the user can also instruct the wearable multimedia device 101 to zoom in on the virtual interface 101 by performing a pinching gesture while hovering her hand 3004 above the surface 2802, and moving her hand 3004 towards the surface 2802 (e.g., in the negative z-direction). Further, the user can also instruct the wearable multimedia device 101 to zoom out of the virtual interface 101 by performing a pinching gesture while hovering her hand 3004 above the surface 2802, and moving her hand 3004 away from the surface 2802 (e.g., in the positive z-direction).

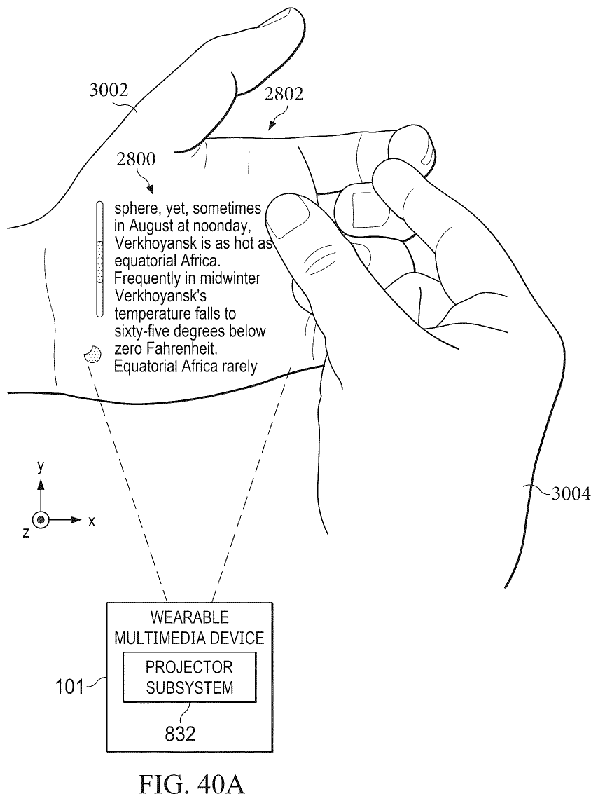

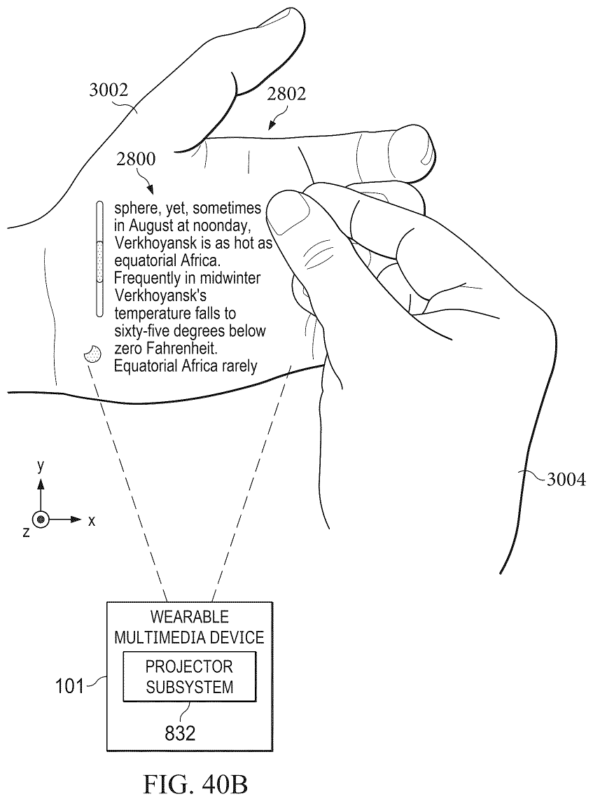

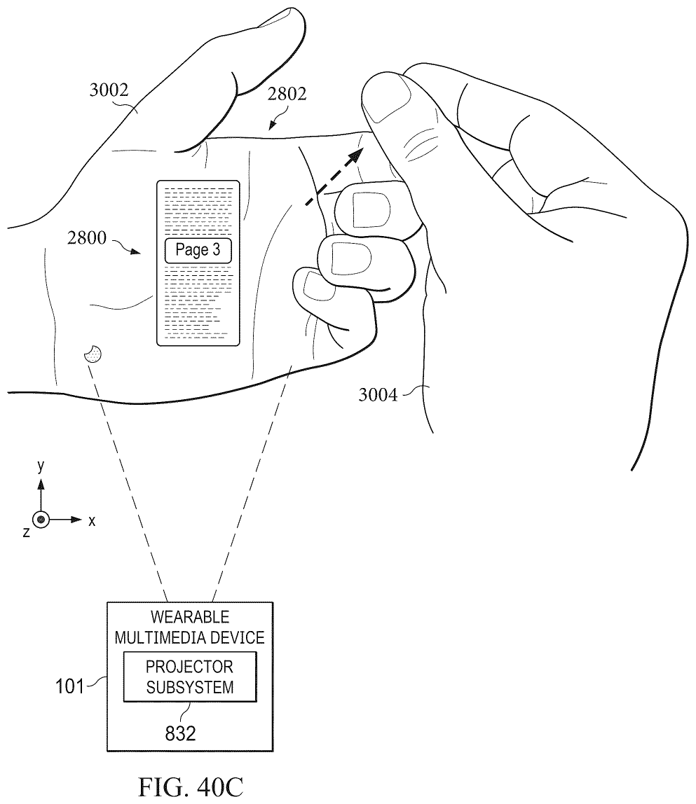

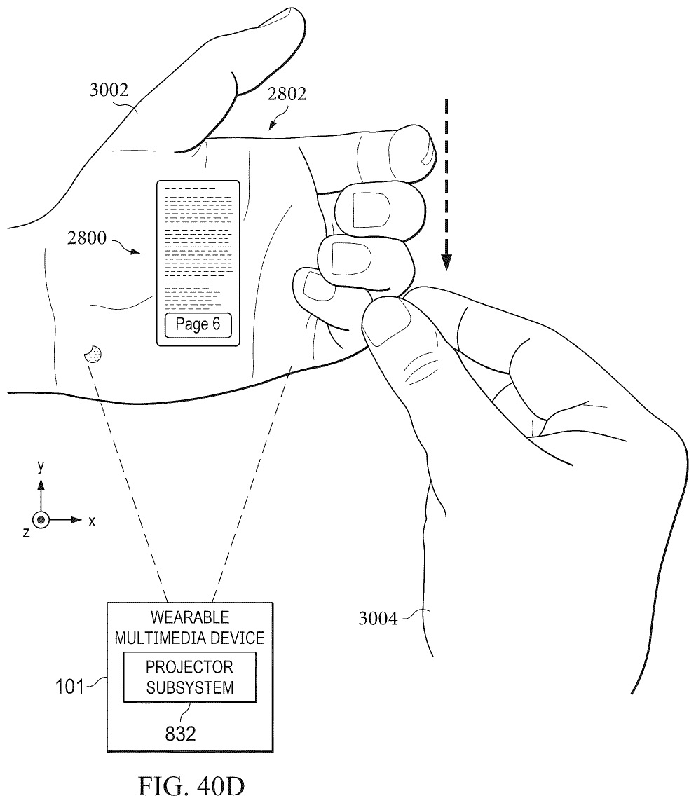

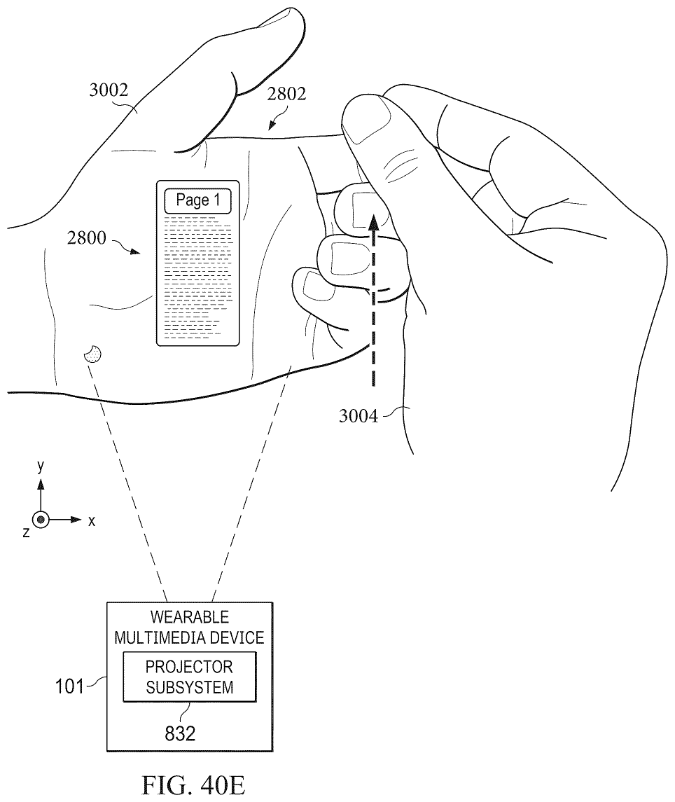

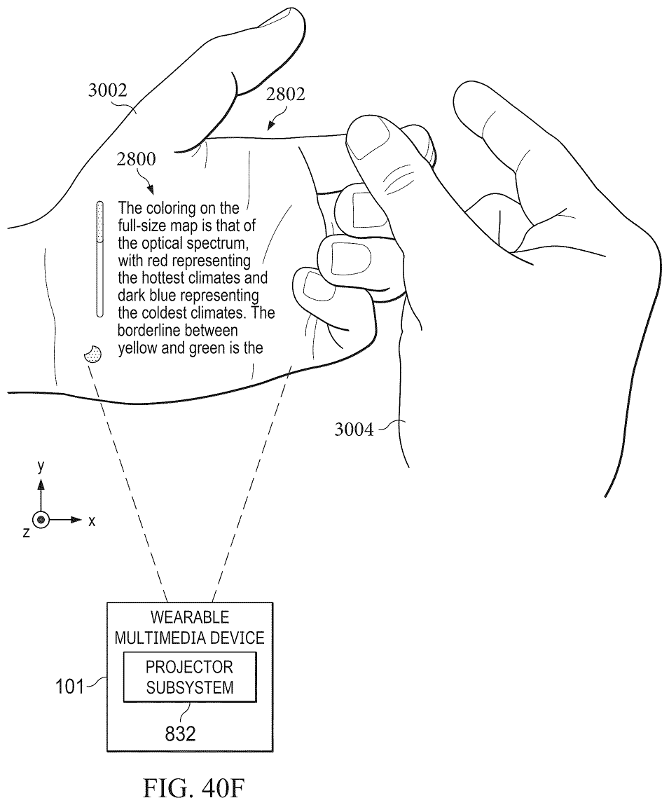

As an example, as shown in FIG. 40A, a user can position her hand 3004 such that it is hovering over the virtual interface 2800 (e.g., in the positive z-direction). Further, as shown in FIG. 40B, the user can perform a pinching gesture using her hand 3004 (e.g., by moving her index finger and her thumb towards each other).

Further, as shown in FIG. 40C, while maintaining the pinching gesture with her hand 3004, the user can move her hand 3004 away from the surface 2802 (e.g., in the positive z-direction). In response, the wearable multimedia device 101 can perform a zoom out operation with respect to the virtual interface 2800. For example, if the virtual interface 2800 shows a particular portion of a document or other layout of content, the wearable multimedia device 101 can cause the virtual interface 2800 to zoom out, such that it shows a larger portion of the document or layout.

Further, while maintaining the pinching gesture with her hand 3004, the user can move her hand 3004 towards the surface 2802 (e.g., in the negative z-direction). In response, the wearable multimedia device 101 can perform a zoom in operation with respect to the virtual interface 2800. For example, if the virtual interface 2800 shows a particular portion of a document or other layout of content, the wearable multimedia device 101 can cause the virtual interface 2800 to zoom in, such that it shows a smaller portion of the document or layout.

In some implementations, the wearable multimedia device 101 can cause the virtual interface 2800 to zoom in and/or zoom out by differing degrees, depending on the movement of the user's hand 3004 in the z-direction. For example, as the user moves her hand away from the surface 2802 (e.g., in the positive z-direction), the wearable multimedia device 101 can cause the virtual interface 2800 to zoom out to an increasingly large degree. As another example, as the user moves her hand towards the surface 2802 (e.g., in the negative z-direction), the wearable multimedia device 101 can cause the virtual interface 2800 to zoom in to an increasingly large degree.

Further, while maintaining the pinching gesture with her hand 3004, the user can move her hand 3004 in a downward direction (e.g., in the negative y-direction) to instruct the wearable multimedia device 101 to scroll the virtual interface 2800 in a downward direction (FIG. 40D). Further, the user can maintain the pinching gesture and move her hand in an upward direction (e.g., in the positive y-direction) to instruct the wearable multimedia device 101 to scroll the virtual interface 2800 in an upward direction (FIG. 40E). The user can cease the pinching gesture (e.g., by moving her index finger and thumb away from each other) to instruct the multimedia device 101 to cease scrolling the virtual interface 2800 and revert to a particular zoom level (FIG. 40F). For example, upon the user ceasing the pinching gesture, the multimedia device 101 can revert to virtual interface 2800 to a default or pre-determined zoom level that allows the user to read or otherwise the interpret the contents of the interface 2800 in detail (e.g., the zoom level of the ual interface 2800 prior to the user performing the pinching gesture).

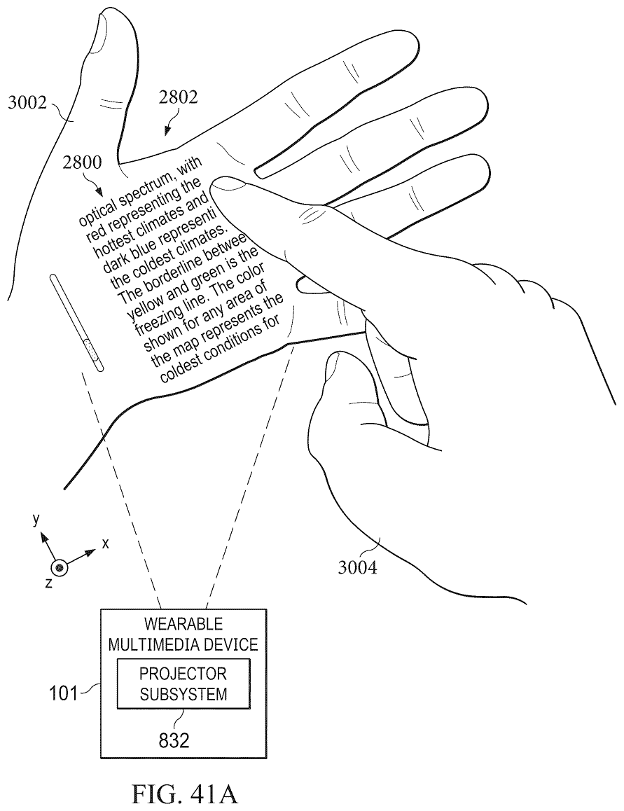

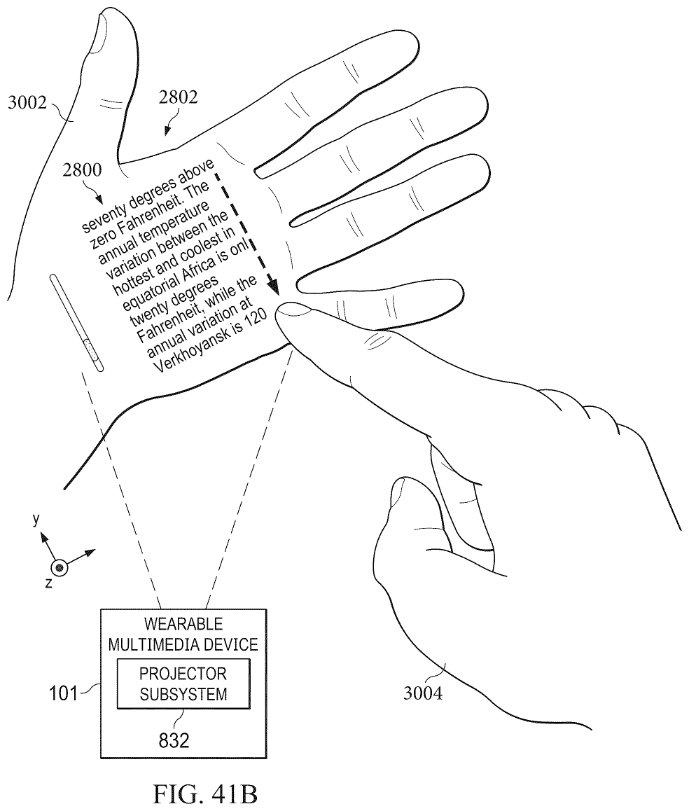

In the examples shown in FIGS. 30A-40F, a user performs various gestures with her hand 3004, where her hand 3004 is not in direct contact with the hand 3002 upon which the virtual interface element 2800 is projected. However, in some implementations, a user can perform one or more gestures in which her hand 3002 and her hand 3004 directly contact one another. For example, referring to FIG. 41A, a user can position her hand 3004 such that a finger (e.g., an index finger) contacts the surface of the hand 3002 along a portion of the virtual interface 2800. As shown in FIG. 41B, while her finger is in contact with the surface of the hand 3002, the user can move her finger downward (e.g., in the negative y-direction) to instruct the wearable multimedia device 101 to scroll the virtual interface 2800 in a downward direction. Further, while her finger is in contact with the surface of the hand 3002, the user can move her finger upward (e.g., in the positive y-direction) to instruct the wearable multimedia device 101 to scroll the virtual interface 2800 in an upward direction.

FIGS. 30A-41B show various gestures that can be performed to instruct the wearable multimedia device 101 to scroll a virtual interface 2800 in an upward or downward direction. However, in practice, similar gestures can be performed to instruct the wearable multimedia device 101 to scroll a virtual interface 2800 in other directions, such as a rightward direction, a leftward direction, or a diagonal direction.

For example, a user can perform gestures similar to those shown in FIGS. 30A-31B, but can instead position her finger on the left or right side of the virtual interface 2800 to instruct the wearable multimedia device 101 to scroll a virtual interface 2800 in a leftward or rightward direction, respectively.

As another example, a user can perform gestures similar to those shown in FIGS. 32-35, but can instead move her hand leftward or rightward to instruct the wearable multimedia device 101 to scroll a virtual interface 2800 in a leftward or rightward direction, respectively.

As another example, a user can perform gestures similar to those shown in FIGS. 36-37B, but can instead move her hand leftward or rightward along a user interface element 101 to scroll a virtual interface 2800 in a leftward or rightward direction, respectively.

As another example, a user can perform gestures similar to those shown in FIGS. 38A-40F, but can instead perform a pinching gesture and move her hand leftward or rightward to scroll a virtual interface 2800 in a leftward or rightward direction, respectively.

Although example gestures are described with reference to FIGS. 30A-41F, there are merely illustrative examples. In practice, a user can perform other gestures to instruct the wearable multimedia device 101 to scroll a virtual interface, either instead of or in addition to those described above.

Further, although FIGS. 28-41F describe example operations that can be performed using a virtual interface (e.g., a virtual interface that is projected by a projector subsystem 832), in practice, similar operations also can be performed using other types of user interfaces. As an example, some or all of these operations can be performed using a user interface that is presented using a display device such as a computer monitor or a touch sensitive display panel.

### Example Techniques for Detecting Finger Positions and Hand Gestures

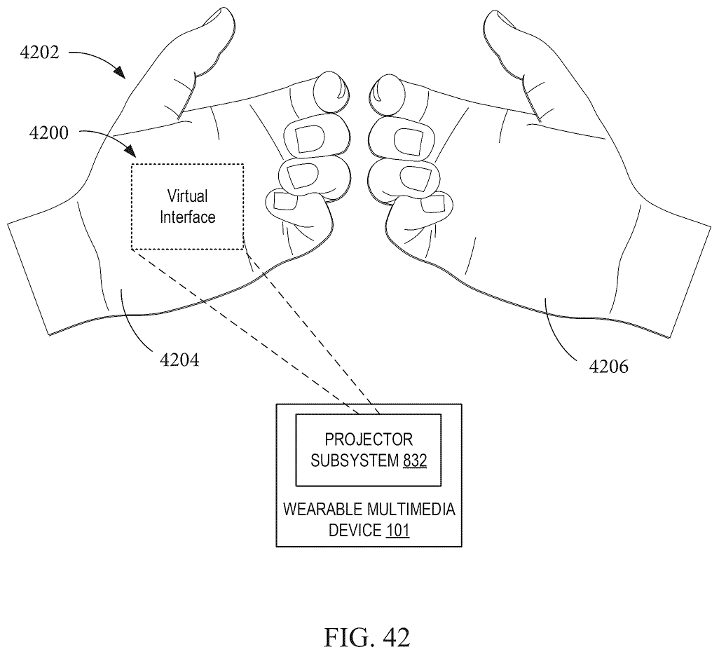

As described above, a wearable multimedia device 101 can include a projector subsystem 832 configured to present information visually to a user in the form of projected light. For example, the projector subsystem 832 can project light onto a surface (e.g., a surface of a user's hand, such as the user's palm) according to a particular spatial and/or temporal pattern, such that the user perceives text, images, videos, colors, patterns, and/or any other graphical information on the surface. As an illustrative example, FIG. 42 shows a virtual interface 4200 projected by a projector subsystem 832 onto the palm 4202 of the user's hand 4204.

In general, the user can perform gestures to interact with one or more user interface elements of the virtual interface 4200. For instance, the user can perform one or more gestures directed at one or more of the user interface elements. As examples, the user can point to a user interface element, touch or tap a user interface element using her finger (e.g., a single time, or multiple times in a sequence), perform a swiping motion along a user interface element using her finger, wave at a user interface element using her hand, hover over the user interface element, or perform any other hand or finger gesture. In some implementations, a user can perform a gesture using a single hand at a time (e.g., using the hand 4204 upon which the virtual interface 4200 is projected or her other hand 4206). In some implementations, a user can perform a gesture using two hands concurrently. The wearable multimedia device 101 can detect the performed gestures using one or more sensors (e.g., the camera/video subsystems 820, environment sensor(s) 817, depth sensor(s) 814, etc.), identify one or more commands associated with those gestures, and execute the identified commands (e.g., using the processor(s) 804).

At least some of the user interface elements and/or commands can be used to control the operation of the wearable multimedia device 101. For example, at least some of the user interface elements and/or commands can be used to execute or control the generation of video and/or audio content, the viewing of content, the editing of content, the storing and transmission data, and/or any other operation described herein. As another example, at least some of the user interface elements and/or commands can be used to facilitate communications between users (e.g., via a voice call, video call, email, chat messages, text messages, etc.).

In some implementations, there may be little surface area on which to project a detailed virtual interface. For example, a user's palm 4202 may be relatively small (e.g., compared to the display screen of a smartphone or tablet). Thus, there may be constraints regarding the size, number, and/or density of user interface elements that are presented on the virtual interface 4200, such that they can be readily discerned by the user while also not overwhelming the user with minute detail. Further, there may be constraints regarding the types of physical interactions that the user can perform with respect to the virtual interface 4200.

In some implementations, a user can perform hand gestures in which one hand does not physically contact the other hand. For example, the virtual interface 4200 can be configured to project the virtual interface on a first hand 4204 of the user (e.g., the left hand). Further, the user can position her second hand 4206 (e.g., the right hand) such that it is hovering over the first hand 4204 or positioned alongside the first hand, and perform one more gestures using the second hand 4206 (e.g., by posing and/or moving her second hand 4206 in a particular manner). This can be beneficial, for example, as it allows the user to perform hand gestures in the air, without being confined to the physical surface upon which the virtual interface 4200 is projected.

The implementations described herein can provide various technical benefits. For example, at least some of these implementations allow a user to interact with a virtual interface 4200 in a more intuitive manner. For instance, as discussed above, there may be little surface area on which to project a detailed virtual interface 4200. Further, there may be little surface area with which a user can physically interact. Therefore, a user might otherwise have difficulty interacting with the contents of the virtual interface 4200 solely through touch-based inputs. However, according to the implementations described herein, a user can interact with the virtual interface 4200 by performing hand gestures in the air (e.g., in which the hands are not necessarily in contact with one another). Accordingly, the user can interact with the virtual interface 4200 without being constrained to the surface area of her palm.

Further, these techniques can reduce the occurrence of erroneous and/or unintended selections by the user, which can reduce the resources expended by the wearable multimedia device 101 during operation. For instance, if a user selects a particular user interface element in error, the wearable multimedia device 101 may perform certain operations unnecessarily (e.g., contrary to the user's intentions). Further, the user may spend more time interacting with the wearable multimedia device 101 to correct or reverse her erroneous selection. Accordingly, the wearable multimedia device 101 may expend resources—such as computational resources (e.g., CPU cycles), memory resources, storage resources, network resources, and/or battery resources—that might otherwise not need to be expended. By reducing the likelihood of user error in interaction with the virtual interface, the wearable multimedia device 101 can reduce the expenditure of resources in correcting or reversing those errors. Thus, the wearable multimedia device 101 can operate in a more efficient manner.

Nevertheless, at least some implementations, the user can also perform gestures by physically touching one hand with the other hand (e.g., touching the first hand 4204 using one or more fingers of the second hand 4206, and/or vice versa). Further, the user can perform gestures by moving one hand along the surface of the other hand (e.g., (e.g., moving one or more fingers of the second hand 4206 along the surface of the first hand 100, and/or vice versa). In some implementations, a wearable device 101 can detect both touch-based gestures and gestures that in which the user's hands are not in contact with one another.

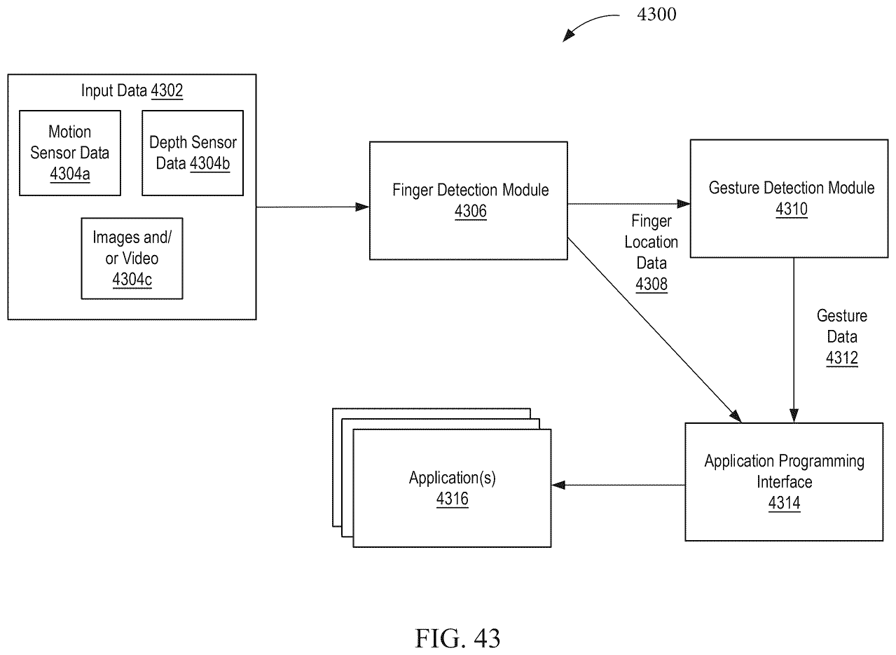

An example system 4300 for detecting the positions of a user's fingers and/or hand gestures is shown in FIG. 43. In some implementations, the system 4300 can be implemented on the wearable multimedia device 101 (e.g., one or more processors and/or other components of the wearable multimedia device 101), one or more computer systems remote from the wearable multimedia device 101 (e.g., a cloud computing platform 102), or a combination thereof.

In an example operation of the system 4300, the system 4300 obtains input data 4302 from one or more sensors of the wearable multimedia device 101. As examples, the input data 4302 can include motion sensor data 4304 (e.g., from one or more motion sensor(s) 810), depth sensor data 4304b (e.g., from one or more depth sensors 814), and images and/or video 4304c (e.g., from the camera/video subsystem 820). The input data 4302 can include information regarding one or more portions of the user's body that are in view of the sensors of the wearable multimedia device 101. As an example, the input data 4302 can include motion sensor data, depth sensor data, images, and/or videos representing one or both of the user's hands.

A finger detection module 4306 receives the input data 4302, and processes the input data 4302 to generate finger location data 4308 indicating the presence and/or location of one or more of the user's fingers in three-dimensional space.

As an example, the finger location data 4308 can identify one or more points of interest on a user's hand, such as one or more fingertips, joints, knuckles, fingers, etc. Further, the finger location data 4308 can indicate the position of each of the points of interest (e.g., according to a three-dimensional coordinate system).

In some implementations, the finger location data 4308 can indicate the position of each of the points of interest according to a coordinate system having a frame of reference relative to the surface 4202 of the hand 4204. For instance, the virtual interface 4200 can be presented according to an x-y plane (e.g., on a plane parallel to the surface 4202 of the hand 4204). The position of a point of interest along the x-y plane can be represented using x-coordinates and y-coordinates. Further, distance between the point of interest and the x-y plane (e.g., in a direction normal to the x-y plane) can be represented by a z-coordinate.

In some implementations, the finger location data 4308 can indicate the position of each of the points of interest according to a coordinate system having a frame of reference relative to the wearable multimedia device 101. As an example, an x-coordinate represent the position of a point of interest along a first axis relative to the wearable multimedia device 101 (e.g., to the left or right of the wearable multimedia device), the y-direction can indicate the position of a point of interest along a second axis relative to the wearable multimedia device 101 (e.g., to the front or back of the wearable multimedia device), and the z-direction can indicate the position of a point of interest along a third axis relative to the wearable multimedia device 101 (e.g., above or below the wearable multimedia device).

In some implementations, the finger location data 4308 can indicate the position of each of the points of interest according to a coordinate system having a frame of reference relative to the earth.

In some implementations, a wearable multimedia device 101 can use multiple coordinate systems to represent points of interest. For example, a wearable multimedia device 101 can use a coordinate system having a frame of reference relative to the surface 4202 of the user's hand 4204 in some contexts (e.g., to represent points of interest and/or movements of those points of interest when the user is touching her fingers on the surface 4202 and/or hovering her fingers over the surface 4202). As another example, the wearable multimedia device 101 can use another coordinate system having a frame of reference relative to the wearable multimedia device 101 in other contexts (e.g., to represent points of interest and/or movements of those points of interest when the user is performing hand gestures in the air). In some implementations, a wearable multimedia device 101 can use a single coordinate system to represent points of interest.

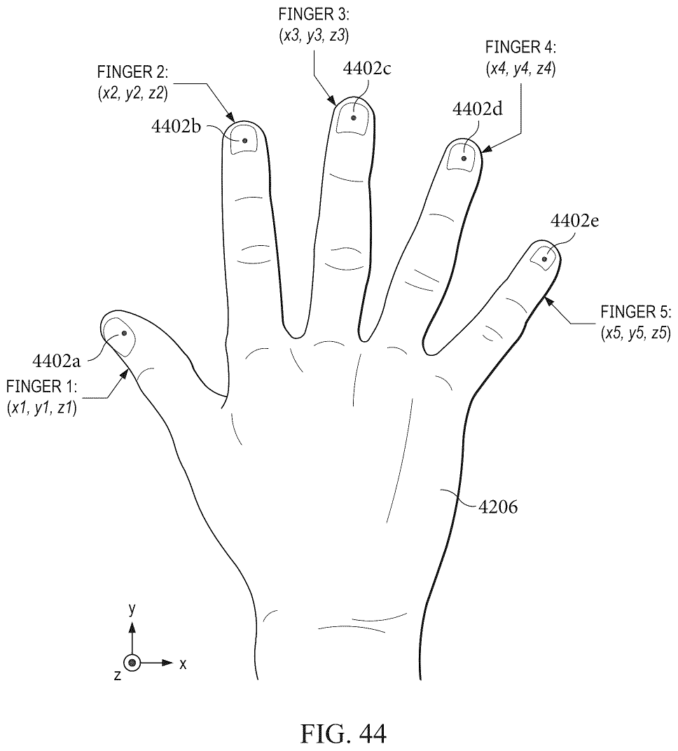

As an example, FIG. 44 shows a user's hand 4206. For each of the user's fingers, the finger location data 4308 can identify a respective point of interest 4402a-4402e corresponding to the tip of that finger. Further, the finger location data 4308 can indicate the position of each of the points of interest 4402a-4402e in in three-dimensional space.

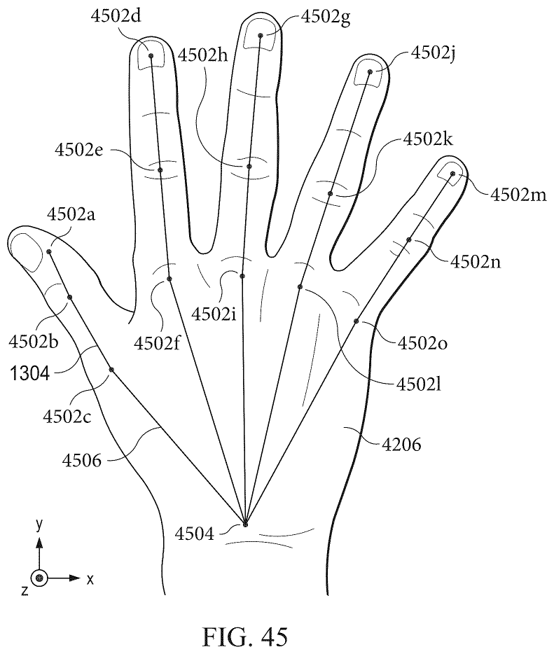

As another example, FIG. 45 shows a user's hand 4206. For each of the user's fingers, the finger location data 4308 can identify respective points of interest 4502a-45020 corresponding to the tip and joints of that finger. Further, the finger location data 4308 can indicate one or more additional points of interest (e.g., a point of interest 4504 representing the joint between the user's hand 4206 and her wrist). Further still, the finger location data 4308 can indicate line segments 4506 connecting respective pairs of the points of interest 4502a-45020 and 4504 (e.g., to approximate the user's fingers).

In some implementations, the finger detection module 4306 can generate the finger location data 4308 for a single point in time (e.g., indicating the positions of one or more points of interest at that point in time). In some implementations, the finger detection module 4306 can generate the finger location data 4308 for multiple points in time (e.g., indicating the positions of one or more points of interest at multiple points in time). For example, the finger detection module 4306 can generate the finger location data 4308 periodically or continuously over a particular time interval.

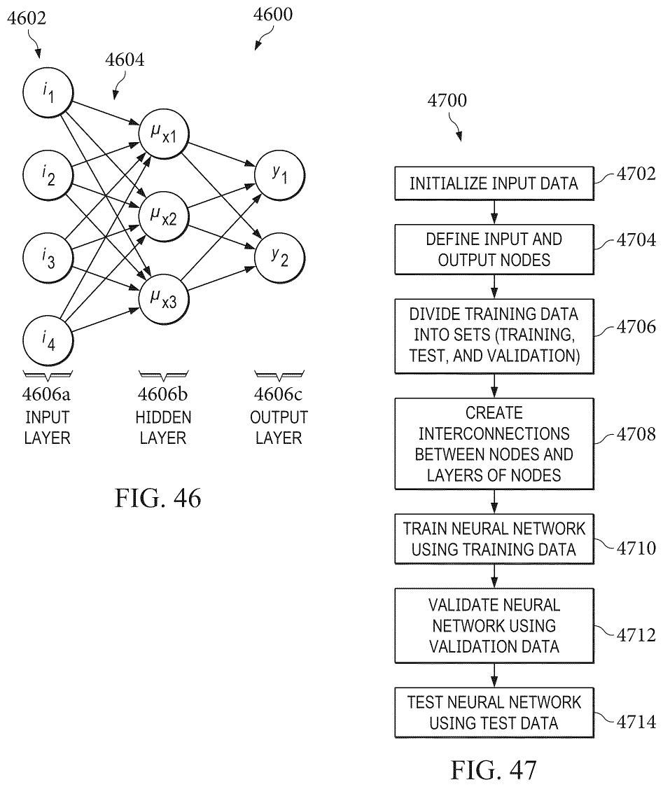

In some implementations, the finger detection module 4306 can generate the finger location data 4308 based on one or more machine learning processes. As an example, the finger detection module 4306 can include a neural network that is trained to identify the presence and locations of one or more points of interest of a user's hand based on motion sensor data, depth sensor data, images, and/or videos. Example neural networks are described in further detail with reference to FIGS. 46 and 47.

Referring back to FIG. 43, a gesture detection module 4310 receives the finger location data 4308, and processes the finger location data 4308 to generate gesture data 4312 indicating the performance of one or more hand gestures by the user. As an example, based on the finger location data 4308, the gesture detection module 4310 can determine the presence (or absence) of one or more of the user's fingers. Further, based on the finger location data 4308, the gesture detection module 4310 can determine the pose of the user's hand. Further still, based on the finger location data 4308, the gesture detection module 4310 can determine a movement of one or more portions of the user's hand over time. Based on these determinations, the gesture detection module 4310 can identify one or more corresponding hand gestures being performed by the user.

In some implementations, gesture detection module 4310 can determine a pose of a user's hand based, at least in part, on the positions of the points of interest of the user's hand relative to one another (e.g., as indicated by the finger location data 4308). In some implementations, gesture detection module 4310 can determine a pose of a user's hand based, at least in part, on the positions of the line segments interconnecting the points of interest of the user's hand relative to one another (e.g., as indicated by the finger location data 4308).

In some implementations, gesture detection module 4310 can determine that a user performed as gesture based, at least in part, on the positions of the points of interest of the user's hand and/or the positions of the line segments interconnecting them (e.g., as indicated by the finger location data 4308). In some implementations, gesture detection module 4310 can determine that a user performed as gesture based, at least in part, on movements of the points of interest of the user's hand and/or movements of the line segments interconnecting them (e.g., as indicated by the finger location data 4308).

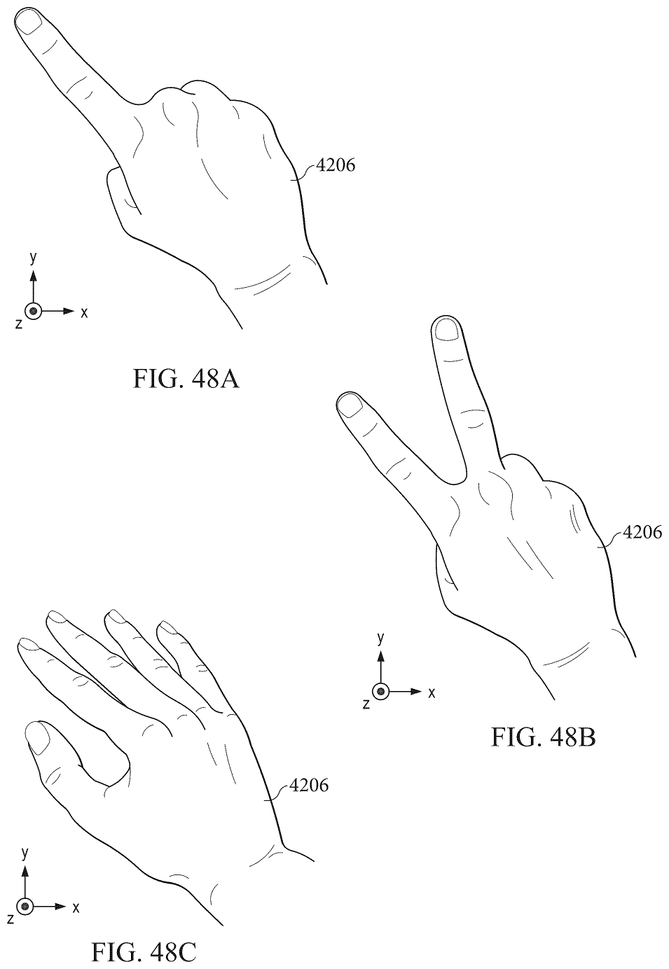

The gesture detection module 4310 can be configured to detect the performance of any number of hand gestures. Example gestures include a pinching gesture, a swiping gesture, a waving gesture, a pointing gesture, and a rotating gesture. As another example, a gesture includes a hand raising motion (e.g., raising the hand from the user's side, such as to a position in front of the user and at the level of the user's torso, chest, head, etc.). As another example, a gesture includes a hand lower motion (e.g., lower the hand from a position in front of the user and at the level of the user's torso, chest, head, etc., to a position at the user's side). As another example, a gesture includes posing a hand in a particular manner, and maintaining that pose for a particular period of time. In another example gesture, a first finger of the user's hand (e.g., a thumb) is moved along a second finger of the same hand (e.g., an index finger). In another example gesture, a moves the tip of a finger (e.g., an index finger) along a particular path to simulate writing a portion of text. In another example gesture, a poses her hand as if she were grasping a writing instrument (e.g., a pencil or pen), and moves her hand along a particular path to simulate writing a portion of text. As another example, a gestures can include touching one hand with another hand (e.g., touching one hand with one or more fingers of the other hand). As another example, a gestures can include moving one hand along the surface of the other hand (e.g., moving one or more fingers of one hand along the surface of other hand). Example gestures are described in greater detail with reference to FIGS. 48A-54.

In some implementations, the gesture detection module 4310 can generate the gesture data 4312 for a single point in time (e.g., indicating a gesture that was performed at that point in time). In some implementations, the gesture detection module 4310 can generate the gesture data 4312 for multiple points in time (e.g., indicating one or more gestures that were performed at multiple points in time). For example, the gesture detection module 4310 can generate the gesture data 4312 periodically or continuously over a particular time interval.

In some implementations, the gesture detection module 4310 can generate the gesture data 4312 based on one or more machine learning processes. As an example, the gesture detection module 4310 can include a neural network that is trained to identify the performance of hand gestures by a user based on the locations of one or more points of interest of the user's hand over time (e.g., as indicated by the finger location data 4308). Example neural networks are described in further detail with reference to FIGS. 36 and 37.

The finger location data 4308 and/or the gesture data 4312 can be provided to one or more applications 4316 for further processing. As an example, the finger location data 4308 and/or the gesture data 4312 can be provided to one or more applications 4316 via an application programming interface (API) 4314 that abstracts the underlying finger and/or gesture detection, and exposes programming objects or actions for use by the applications 4316.

In some implementations, an application 4316 can be configured to perform certain operations in response to a user positioning in her in a particular manner relative to the virtual interface 4200. As an example, open determining that a user's fingertip is hovering above a particular interactive user interface element (e.g., based on the finger location data 4308), the application 4316 can visually accentuate that user interface element. For instance, the application can change the color, pattern, shade, size, etc. of that user interface element relative to other user interface elements in the virtual interface 4200. This can be beneficial, for example, as it allows the user to visually ascertain that her finger is in proximity with the user interface element and that the user can interact with that user interface element.

Further, an application 4316 can be configured to perform certain operations in response to a user performing particular gestures. As an example, the application 4316 can be configured such that certain gestures are associated with certain operations. Upon determining that the user is performing a particular gesture (e.g., based on the gesture data 4312), the application 4316 can identify one or more operations corresponding to that gesture, and execute the operations.

As an example, an application 4316 can be configured to present an image to a user using the virtual interface 4200. Upon determining that a user is performing a first gesture in which she hovers a single finger above the image (e.g., the z-direction), the application 4316 can present a description of the image to the user using the virtual interface 4200. Further, upon determining that a user is performing a second gesture in which she hovers two fingers above the image (e.g., the z-direction), the application 4316 can present a menu with options for editing the image.

As another example, an application 4316 can be configured to present a drawing or illustration interface to a user, whereby the user can draw lines by hovering her finger upon the virtual interface (e.g., the z-direction) and swiping her finger across the interface to trace the desired line (e.g., in the x-direction and/or y-direction). The thickness of the line can depend on the distance between the user's finger and the surface 4202 of the user's hand 4204 (e.g., in the z-direction). In some implementations, the thickness of the line can be inversely related to the distance between the user's finger and the surface 4202 of the user's hand 4204. For instance, if the user moves her finger closer to the surface 4202, the application 4316 can increase the thickness of the line as she swipes her finger across the interface. Further, if the user moves her finger away from the surface 4202, the application 4316 can decrease the thickness of the line as she swipes her finger across the interface.

In some implementations, at least some of the applications 4316 can be developed and/or maintained by an entity or entities that are different from those that develop and/or maintain the finger detection module 4306 and/or the gesture detection module 4310. For example, the finger detection module 4306 the gesture detection module 4310 can be developed and/or maintained by an entity that provides the wearable multimedia device 101, and at least some of the applications can be developed and/or maintained by a different entity (e.g., a third-party software developer). Further, the finger location data 4308 and/or the gesture data 4312 can be provided to the applications 4316 via the API 4314. This can be beneficial, for example, in allowing entities to develop applications that are gesture-aware, without requiring that the developers of those applications independently develop systems for recognizing finger positions and/or gestures. Nevertheless, in some implementations, at least some of the applications 4316 can be developed and/or maintained by the same entity or entities that develop and/or maintain the finger detection module 4306 and/or the gesture detection module 4310.

As described above, a machine learning process can be performed using one or more neural networks. A simplified example of a neural network 4600 is shown in FIG. 46.

The neural network 4600 includes several nodes 4602 (often called “neurons”) interconnected with another by interconnections 4604. Further, the nodes 4602 are arranged according to multiple layers, including an input layer 4606a, a hidden layer 4606b, and an output layer 4606c. The arrangement of the nodes 4602 and the interconnections 4604 between them represent a mathematical transformation of input data (e.g., as received by the nodes of the input layer 4606a) into corresponding output data (e.g., as output by the nodes of the output layer 4606c). In some implementations, the input data can represent one or more data points obtained by the finger detection module 4306 (e.g., input data 4302), and the output data can represent corresponding finger location data 4308 generated by the finger detection module 4306 based on the input data. In some implementations, the input data can represent one or more data points obtained by the gesture detection module 4310 (e.g., input data 4302 and/or finger location data 4308), and the output data can represent corresponding gesture data 4312 generated by the gesture data 4312 based on the input data.

The nodes 4602 of the input layer 4606a receive input values and output the received input values to respective nodes of the next layer of the neural network 4600. In this example, the neural network 4600 includes several inputs i₁, i₂, i₃, and i₄, each of which receives a respective input value and outputs the received value to one or more of the nodes μₓ₁, μₓ₂, and μₓ₃ (e.g., as indicated by the interconnections 4604).

In some implementations, at least some of the input data 4302 (e.g., the motion sensor data 4304, depth sensor data 4304b, images and/or video 4304c, etc.) can be used as inputs for the nodes of the input layer 4606a. For example, at least some of the input data 4302 can be expressed numerically (e.g., using spatial coordinates), and input into the nodes of the input layer 4606a.

The nodes of the hidden layer 4606b receive input values (e.g., from the nodes of the input layer 4606a or nodes of other hidden layers), applies particular transformations to the received values, and outputs the transformed values to respective nodes of the next layer of the neural network 4600 (e.g., as indicated by the interconnections 4604). In this example, the neural network 4600 includes several nodes μₓ₁, μₓ₂, and μₓ₃, each of which receives respective input values from the nodes i₁, i₂, i₃, and i₄, applies a respective transformation to the received values, and outputs the transformed values to one or more of the nodes y₁ and y₂.

In some implementations, nodes of the hidden layer 4606b can receive one or more input values, and transform the one or more received values according to a mathematical transfer function. As an example, the values that are received by a node can be used as input values in particular transfer function, and the value that is output by the transfer function can be used as the output of the node. In some implementations, a transfer function can be a non-linear function. In some implementations, a transfer function can be a linear function.

In some implementations, a transfer function can weight certain inputs differently than others, such that certain inputs have a greater influence on the output of the node than others. For example, in some implementations, a transfer function can weight each of the inputs by multiplying each of the inputs by a respective coefficient. Further, in some implementations, a transfer function can apply a bias to its output. For example, in some implementations, a transfer function can bias its output by a particular offset value.

For instance, a transfer function of a particular node can be represented as:

$$Y = {\sum }_{i = 1}^{n} ( {weight}_{i} * {input}_{i} ) + bias ,$$

where weightᵢ is the weight that is applied to an input inputᵢ, bias is a bias or offset value is that is applied to the sum of the weighted inputs, and Y is the output of the node.

The nodes of the output layer 4606c receive input values (e.g., from the nodes of the hidden layer 4606b) and output the received values. In some implementations, nodes of the output layer 4606c can also receive one or more input values, and transform the one or more received values according to a mathematical transfer function (e.g., in a similar manner as the nodes of the hidden layer 4606b). As an example, the values that are received by a node can be used as input values in particular transfer function, and the value that is output by the transfer function can be used as the output of the node. In some implementations, a transfer function can be a non-linear function. In some implementations, a transfer function can be a linear function.

In some implementations, at least one of the nodes of the output layer 4606c can correspond to position information (e.g., spatial coordinates) regarding one or more fingers or other points of interest on the user's hand. In some implementations, at least one of the nodes of the output layer 4606c can correspond to a likelihood that a user is performing a particular gesture.

In this example, the neural network 4600 includes two output nodes y₁ and y₂, each of which receives respective input values from the nodes μₓ₁, μₓ₂, and μₓ₃, applies a respective transformation to the received values, and outputs the transformed values as outputs of the neural network 4600.

Although FIG. 46 shows example nodes and example interconnections between them, this is merely an illustrative example. In practice, a neural network can include any number of nodes that are interconnected according to any arrangement. Further, although FIG. 46 shows a neural network 4600 having a single hidden layer 4606b, in practice, a neural network can include any number of hidden layers (e.g., one, two, three, four, or more), or none at all.

In some implementations, the neural network 4600 can be trained based on training data. An example process 4700 for training the neural network 4600 is shown in FIG. 47.

According to the process 4700, the system 4300 initializes the input data that is used to train the neural network 4600 (block 4702). As an example, the system 4300 can retrieve one or more sets sensor data regarding a user's hand (e.g., motion sensor data 4304a, depth sensor data 4304b, images and/or video 4304c). Further, the system 4300 can retrieve data indicating the positions of one or more points of interest of the user's hand and/or one or more gestures that were being performed by the user during the time that the sensor data was acquired. In some implementations, the training data may be referred to as “ground truth” data (e.g., sets of sensor data and corresponding finger position and/or gesture data that are known to be accurate).

Further, the system 4300 defines the input and the output nodes of the neural network 4600 (block 4704). For example, the system 4300 can select one or more of the types of data included in the training data, and specify that they be used as respective input nodes in the neural network 4600 (e.g., as inputs for respective nodes of the input layer 4606a). As another example, the system 4300 can specify each of the outputs of the neural network 4600 (e.g., the outputs of each of the nodes of the output layer 4606c). For instance, at least one of the nodes of the output layer 4606c can correspond to position information (e.g., spatial coordinates) regarding one or more fingers or other points of interest on the user's hand. For instance, at least one of the nodes of the output layer 4606c can correspond to a likelihood that a user is performing a particular gesture.

The system 4300 divides the training data into different sets (block 4706). For example, the training data can be divided into a training set, a validation set, and a test set.

The training set can be used to train the neural network 4600. For example, the training set can be used to identify patterns, trends, or correlations between the inputs and the outputs of the neural network 4600, and to express those relationships using the nodes and interconnections between them.

The validation set can be used to tune the performance of the trained neural network 4600. For example, the validation set can be used to determine a difference between the output of the neural network 4600 given certain inputs, and an expected output. The configuration of the neural network can be modified based on the different (e.g., such that the output of the neural network 4600 better matches the expected result).

The test set can be used to evaluate the performance of the trained neural network 4600 (e.g., after it has been tuned based on the validation set). For example, the test set can be used to determine a difference between the output of the neural network 4600 given certain inputs, and an expected output. This difference can indicate the ability of the neural network 4600 to accurately predict a particular outcome (e.g., the position of a point of interest on a user's hand and/or a gesture that was performed by the user) given particular inputs (e.g., particular sensor data).

Further, the system 4300 creates interconnections between the nodes and layers of nodes in of the neural network 4600 (block 4708). In some implementations, an interconnection between two or more nodes can be in the forward direction (e.g., data can be passed between nodes in the direction of the input to the output of the neural network 4600). This may be referred to as a “feed forward” interconnection. In some implementations, an interconnection between two or more nodes can be in the backward direction (e.g., data can be passed between nodes in the direction of the output to the input of the neural network 4600). This may be referred to as a “back propagation” interconnection.

Further, the system 4300 creates layers of nodes. For example, the system 4300 can specify that the neural network include N layers of nodes, such as one input layer, one output layer, and N−2 hidden layers. Other arrangements of layers are also possible, depending on the implementation.

Further, the system 4300 trains the neural network 4600 using the training set (block 4710). In some implementations, the system 4300 can perform the training based on a supervised learning method. As an example, the training set can include example input data and output data. Based on the arrangement of the nodes and the interconnections between them, the system 4300 can identify transfer functions for each of the nodes that would result in the output of the neural network 4600 matching or otherwise being similar to the output data in the training set, given the same input data. In some implementations, the system 4300 can select particular weights or biases for each of the transfer functions. In some implementations, this can be performed iteratively (e.g., using successive sets of training data).

After training the neural network 4600, the system 4300 validates the neural network 4600 using the validation set (block 4712). As an example, the validation set can include example input data and output data. The system 4300 can input the input data into the neural network 4600, and compare the output of the neural network 4600 to the output data of the validation set. In some implementations, the system 4300 can calculate an “error” of the neural network 4600, such as the difference between the output data of the validation set and the output of the neural network 4600.

In some implementations, the system 4300 can tune the neural network 4600 based on the validation set. For example, the system 4300 can modify the arrangement of the nodes, the interconnections between them, and/or the transfer functions (e.g., the weights and biases) such that the error of the neural network 4600 is reduced.

In some implementations, this can be performed iteratively (e.g., using successive sets of validation data) until particular criteria are met. For example, in some implementations, the system 4300 can iteratively tune the neural network 4600 until the error of the neural network 4600 is less than a particular threshold value. As another example, the system 4300 can iteratively tune the neural network 4600 until the neural network 4600 exhibits a sufficiently low false positive rate (e.g., the rate in which it predicts the performance of a gesture, when in fact the gesture was not performed) and/or a sufficiently low false negative rate (e.g., the rate in which it predicts that a gesture was not performed, when in fact the gesture was performed).

After training and tuning the neural network 4600, the system 4300 tests the neural network 4600 using the test set (block 4714). As an example, the test set can include example input data and output data. The system 4300 can input the input data into the neural network 4600, and compare the output of the neural network 4600 to the output data of the test set. In some implementations, the system 4300 can calculate an “error” of the neural network 4600, such as the difference between the output data of the test set and the output of the neural network 4600. This error can represent the predictive performance of the neural network 4600. For example, a high error can indicate that the neural network 4600 is not likely to predict an outcome accurately, given certain input data. Conversely, lower error can indicate that the neural network 4600 is likely to predict an outcome accurately, given certain input data.

Although example neural networks are provided, other types of machine learning system can be used to implement some or all of the techniques described herein, either instead of our in addition to neural networks. Example machine learning systems include decision tree systems, support-vector machines, regression analysis systems, Bayesian networks, and genetic algorithms, among others.

In some implementations, the gesture detection module 4310 can determine a pose of a user's hand. In some implementations, the gesture detection module 4310 can determine a pose of a user's hand, at least in part, by determining whether each of the fingers of the user's hand is pointed outward or inward. For example, the gesture detection module 4310 can distinguish between different gestures based on the number of fingers that are pointed outward or inward. As another example, the gesture detection module 4310 can distinguish between different gestures based on the specific combinations of fingers that are pointed outward or inward.

As an example, referring to FIG. 48A, a pointing gesture can correspond to a user pointing any one finger outward from her hand 4206. As another example, a pointing gesture can correspond to a user pointing a single specific finger outward from her hand 4206 (e.g., her index finger). In some implementations, at least some of these gestures can be used to indicate a user's selection of a particular user interface element, a particular object in the user's environment, etc.

As an example, referring to FIG. 48B, another gesture can correspond to a user pointing any two fingers outward from her hand 4206. As another example, another gesture can correspond to a user pointing two specific fingers outward from her hand 4206 (e.g., her index finger and her middle finger).

As an example, referring to FIG. 48C, another gesture can correspond to a user pointing all five fingers outward from her hand 4206.

In some implementations, a gesture can correspond to both a pose of the user's hand and movement of one or more portions of the user's hand.

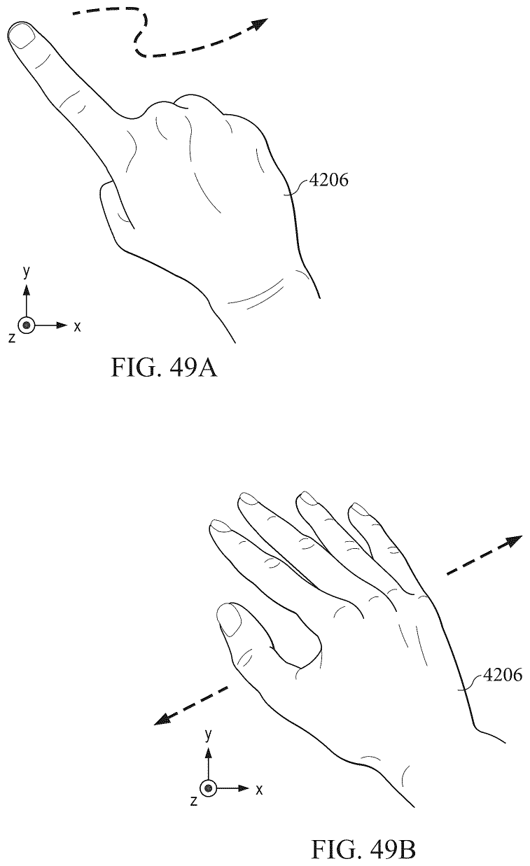

As an example, referring to FIG. 49A, a swiping gesture can correspond to a user pointing a finger outward from her hand 4206, and moving her the tip of her finger along a path (e.g., along the x-y plane). In some implementations, this gesture can be used to perform a scrolling operation using the virtual interface 4200. In some implementations, this gesture can be used to draw a line or other shape using the virtual interface 4200.

As an example, referring to FIG. 49B, a waving gesture can correspond to a user pointing five fingers outward from her hand 4206, and moving her hand 4206 back and forth (e.g., along the x-y plane). In some implementations, this gesture can be used to perform a scrolling operation using the virtual interface 4200.

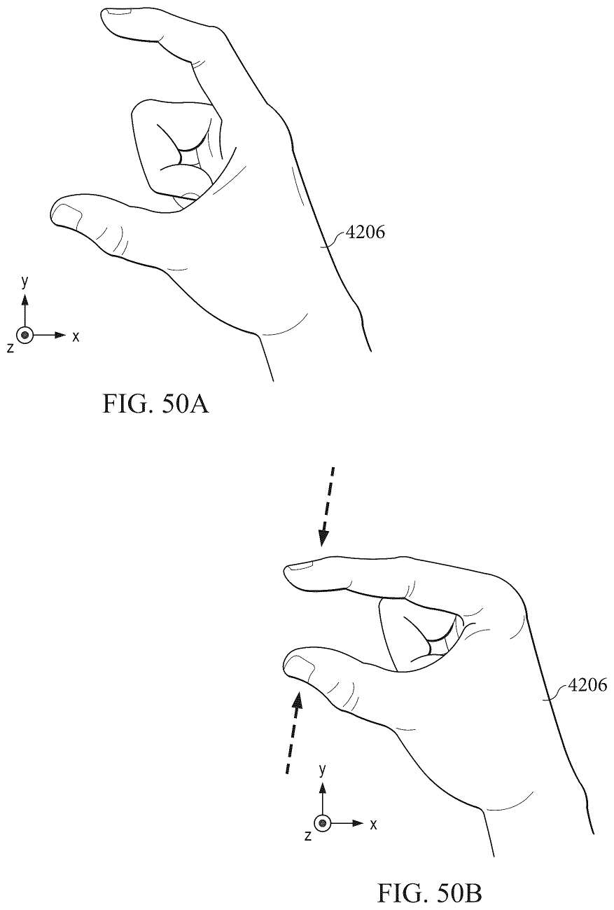

As an example, referring to FIGS. 50A and 50B, a pinching gesture can correspond to a moving two fingers (e.g., a thumb and an index finger) of her hand towards each other. In some implementations, this gesture can be used to select, move, and/or manipulate a particular user interface element. In some implementations, this gesture can be used to perform a zoom operation using the virtual interface 4200.

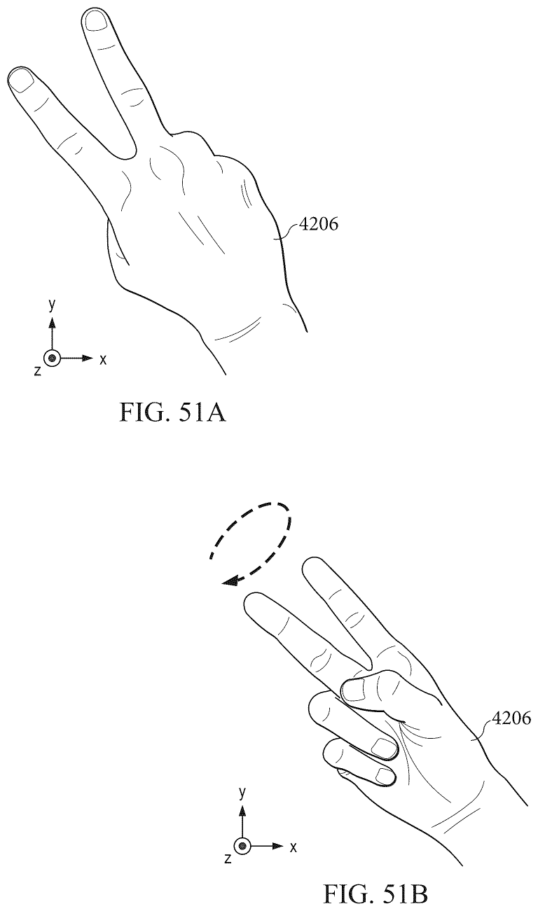

As another example, referring to FIGS. 51A and 51B, a rotating gesture can correspond to the user pointing a particular number and/or combination of fingers outward from her hand 4206 (e.g., two fingers, such as her index finger and middle finger), and rotating her hand 4206 (e.g., along an axis of her wrist). In some implementations, this gesture can be used to rotate a user interface element (e.g., a dial or knob).

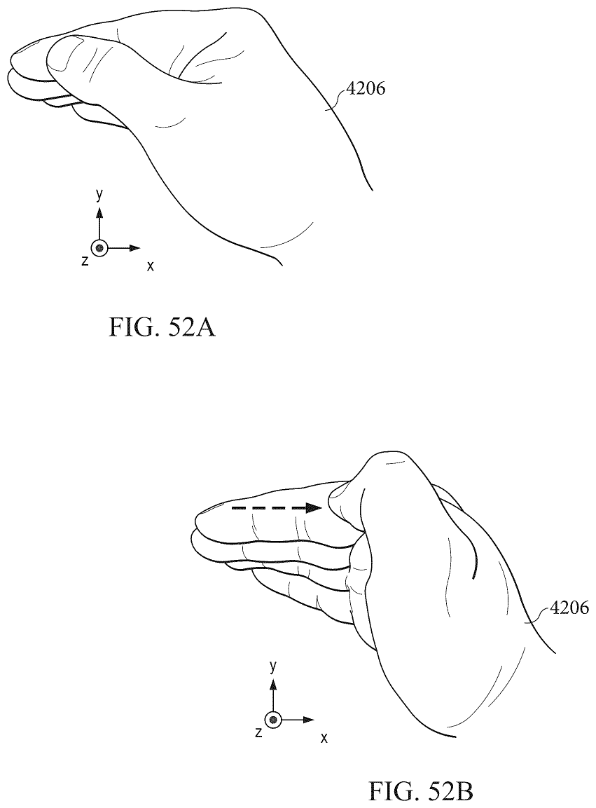

As another example, referring to FIGS. 52A and 52B, another gesture can correspond to the user placing a first finger of her hand 4206 (e.g., a thumb) against a second finger of her hand 4206 (e.g., an index finger), and moving the first finger along the surface of the second finger. In some implementations, this gesture can be used to manipulate a sliding user interface element (e.g., a slider, scroll bar, etc.).

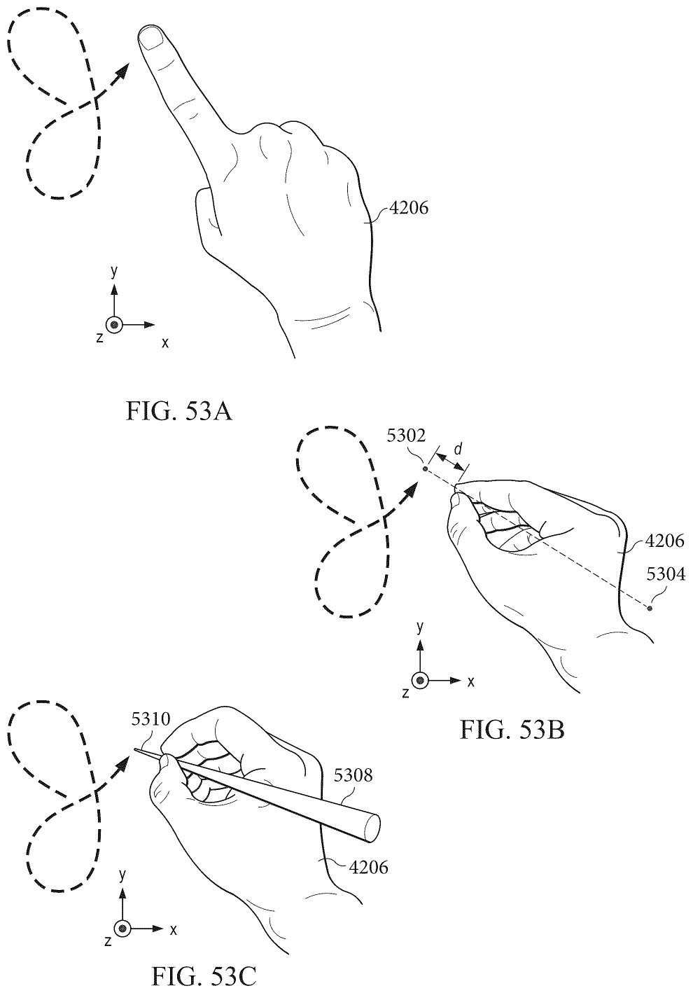

As another example, referring to FIG. 53A, a handwriting gesture can correspond to a user pointing a finger outward from her hand 4206 (e.g., an index finger), and tracing the tip of her finger along a path. In some implementations, the path can correspond to a portion of text (e.g., a word, a number, the user's name, the user's signature, etc.). In some implementations, the tip of the user's finger need not physically contact the surface upon which the virtual interface 4200 is projected (e.g., the finger can hover above the user's palm).

As another example, referring to FIG. 53B, a handwriting gesture can correspond to a user positioning the tip of a first finger of her hand 4206 (e.g., an index finger) in contact with a tip of a second finger of the user's hand 4206 (e.g., a thumb), as if she were holding an imaginary writing implement. Further, while the user's hand is posed in this manner, the user can move her hand 4206 along a path. In some implementations, the path can correspond to a portion of text (e.g., a word, a number, the user's name, the user's signature, etc.). In some implementations, the path can be defined based on a point 5302 that is beyond the user's hand 4206. For example, the point 5302 can be aligned with an axis 5304 extending between the user's two fingers (e.g., the axis 5304 with which a writing implement would be aligned if the user's hand were actually holding the writing implement), and positioned a particular distance d away from the tips of the user's two fingers. In some implementations, the user's hand 4206 not physically contact the surface upon which the virtual interface 4200 is projected (e.g., the user's hand 4206 can hover above the user's palm).

As another example, referring to FIG. 53C, a handwriting gesture can correspond to a user grasping an object 2108 with her hand 4206, such as a writing instrument (e.g., a pen, pencil, etc.) or an object having a similar size and/or shape as a writing instrument (e.g., a stick, stylus, rod, tube, straw, etc.). Further, while the user is grasping the object 5310, the use can move her hand 4206 along a path. In some implementations, the path can correspond to a portion of text (e.g., a word, a number, the user's name, the user's signature, etc.). In some implementations, the path can be defined based on a point 5310 on a tip of the object. In some implementations, the user's hand 4206 and/or the object 5308 not physically contact the surface upon which the virtual interface 4200 is projected (e.g., the hand 4206 and/or the object 5308 can hover above the user's palm).

In some implementations, the user can perform one or more of the handwriting gestures shown in FIGS. 53A-53C to provide text input to the wearable multimedia device 101. For example, the user can move her hand along a path that corresponds to one or more characters, letters, numbers, characteristics, symbols, etc. The wearable multimedia device 101 can detect the path along which the user moves her hand, and determine a portion of text corresponding to the path. In some implementations, the wearable multimedia device 101 can incorporate the portion of text into a document, image, video, or other content. In some implementations, the wearable multimedia device 101 can provide the portion of text to one or more of the applications 4316 (e.g., via the API 4314).

In some implementations, the user can perform one or more of the handwriting gestures shown in FIGS. 53A-53C to authenticate her identity to the wearable multimedia device 101. For example, the user can move her hand along a path that corresponds to a signature or other pattern that is unique to the user, personal to the user, or otherwise identifies the user from among other users. The wearable multimedia device 101 can detect the path along which the user moves her hand, and determine whether the path corresponds to a known signature or other pattern that is associated with an authorized user. If the path matches (or is sufficiently similar to) the known signature or other pattern, the wearable multimedia device 101 can authenticate the user (e.g., grant the user certain access permissions). However, if the path does not match (or is sufficiently dissimilar to) the known signature or other pattern, the wearable multimedia device 101 can refrain from authenticating the user.

In some implementations, the wearable multimedia device 101 can also incorporate the signature or pattern into a document, image, video, or other content. In some implementations, the wearable multimedia device 101 can provide the signature or pattern to one or more of the applications 4316 (e.g., via the API 4314).

In some implementations, the wearable multimedia device 101 can facilitate communications between users. For example, the wearable multimedia device 101 can transmit and/or receive data over a communications network (e.g., a cellular network, local area network, Internet, etc.) to facilitate a voice call and/or a video call between the user and one or more other users. As another example, the wearable multimedia device 101 can transmit and/or receive data over a communications network to enable a first user to exchange emails, chat messages, text messages, and/or any other messages with one or more other users.

In some implementations, the wearable multimedia device 101 can notify the user of an incoming communication. Further, the user can perform one or more gestures to instruct the wearable multimedia device 101 to perform particular operations with respect to that incoming communication.

For instance, the wearable multimedia device 101 can notify the user of an incoming call, such as an incoming voice call and/or video call. As an example, the wearable multimedia device 101 can generate an audio alert (e.g., using a speaker), a haptic alert (e.g., using a haptic motor, vibration mechanism, etc.), and/or a visual alert (e.g., using an LED indicator light, display, projector, etc.).

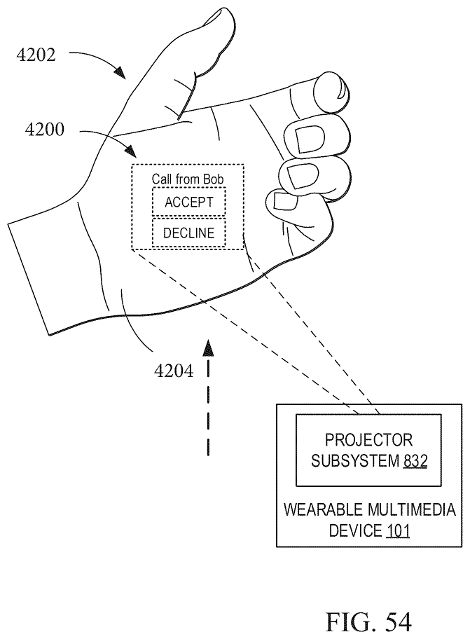

The user can perform a hand raising gesture to obtain additional information regarding the incoming call (e.g., to determine whether to accept or decline the call). For example, referring to FIG. 54, the user can raise her hand 4204 from her side, such that her hand 4204 is positioned at the level of her torso, chest, head, etc. and her palm 4202 is exposed. The wearable multimedia device 101 can detect this gesture, and can present a virtual interface 4200 on the user's hand 4204 (e.g., by projecting the virtual interface 4200 onto the palm 4202 of the user's hand 4204 using the projector subsystem 832).

In some implementations, the virtual interface 4200 can include one or more user interface elements that identify the caller (e.g., using text, images, etc.). In some implementations, the wearable multimedia device 101 can also generate audio identifying the call (e.g., using synthesized speech, audio recordings, etc.). In some implementations, the virtual interface 4200 can include one or more interactive user interface elements (e.g., buttons) that enable the user to accept and/or decline the call.

In some implementations, the user can instruct the wearable multimedia device 101 to accept and/or decline the call by performing one or more gestures using her hand 4204 and/or other hand 4206. As an example, the user can manually instruct the wearable multimedia device 101 to accept and/or decline the call by touching the corresponding interactive user interface element that is projected onto the user's hand 4204 using a finger from other hand 4206. In response to detecting this gesture, the wearable multimedia device 101 can accept the call and/or decline the call, in accordance with the user's instructions.

As another example, the user can instruct the wearable multimedia device 101 to accept the call by keeping her hand 4204 in the raised position for at least a threshold period of time. Upon detecting that the user hand 4204 has been maintained in the raised position for the threshold period of time, the wearable multimedia device 101 can infer that the user wishes to accept the call, and can automatically accept the call on behalf of the user. For example, the wearable multimedia device 101 can establish a voice and/or video session between the user and the caller, and exchange data with a communications network to facilitate the call. Further, the wearable multimedia device 101 can update the virtual interface 4200 to include details regarding the call (e.g., the running time of the call) and/or user interface elements for controlling the call (e.g., user interface elements to end the call, transfer the call, control the volume of the call, etc.).

As another example, the user can instruct the wearable multimedia device 101 to decline the call by lowering her hand 4204 (e.g., to her side) within the threshold period of time. Upon detecting that the user hand 4204 has been lowered within the threshold period of time, the wearable multimedia device 101 can infer that the user wishes to decline the call, and can automatically decline the call on behalf of the user. For example, the wearable multimedia device 101 can refrain from establishing a voice and/or video session between the user and the caller, notify the caller and/or the communications network that the call has been declined, and/or direct the call to a voicemail inbox. Further, the wearable multimedia device 101 can discontinue presenting alerts or notifications to the user regarding the incoming call (e.g., discontinue generating audio, haptic, and/or visual alerts regarding the incoming call). Further, the wearable multimedia device 101 can discontinue presenting the virtual interface 4200 on the user's hand 4204.

As another example, the user can instruct the wearable multimedia device 101 to “silence” the call by lowering her hand 4204 (e.g., to her side) within the threshold period of time. Upon detecting that the user hand 4204 has been lowered within the threshold period of time, the wearable multimedia device 101 can infer that the user wishes to silence the call, and can automatically discontinue presenting alerts or notifications to the user regarding the incoming call (e.g., discontinue generating audio, haptic, and/or visual alerts regarding the incoming call). Further, the wearable multimedia device 101 can discontinue presenting the virtual interface 4200 on the user's hand 4204. However, in this example, the wearable multimedia device 101 does not expressly notify the caller and/or the communications network that the call has been declined (e.g., the call will continue to “ring” until a particular time-out period expires). Prior to the expiration of the time-out period, the user can subsequently re-raise her hand 4204 to see information regarding the call again (e.g., as described above). Further, prior to the expiration of the time-out period, the user can perform one or more gestures to accept or decline that call (e.g., as described above). If the user does not accept the call before the expiration of the time-out period, the wearable multimedia device 101 can refrain from establishing a voice and/or video session between the user and the caller, notify the caller and/or the communications network that the call has been declined, and/or direct the call to a voicemail inbox.

In some implementation, the threshold period of time can be a tunable value (e.g., a value that is selected by the user, an administrator or developer of the wearable multimedia device 101, etc.).

In some implementations, the user can instruct the wearable multimedia device 101 to accept and/or decline the call by interacting with one or more physical controls of the wearable multimedia device 101, either instead of or in addition to performing the gestures described above. For example, the user can instruct the wearable multimedia device 101 to accept and/or decline the call by manipulating a physical button or switch of the wearable multimedia device 101. As another example, the user can instruct the wearable multimedia device 101 to accept and/or decline the call by interacting with a touch sensitive surface or touch sensitive display of the wearable multimedia device 101.

Although example gestures are described with reference to FIGS. 38A-54, there are merely illustrative examples. In practice, a user can perform other gestures to interact with the wearable multimedia device 101, either instead of or in addition to those described above.

As an example, in some implementations, the wearable multimedia device 101 can project a virtual interface 1000 onto a user's hand 1004 (e.g., as shown in FIG. 10). Further, the virtual interface 1000 can include a moveable cursor or pointer. The user can move the cursor or pointer by tilting her hand in different directions relative to the wearable multimedia device 101. For example, the user can tilt her hand downward, upward, leftward, and rightward to move the cursor or pointer downward, upward, leftward, and/or rightward, respectively. Further, the visual appearance of the user interface elements of the virtual 1000 can be modified based on their proximity to the cursor or pointer (e.g., in a manner similar to that described with respect to FIGS. 18A-20C and 23A-25C, or any other aspect described herein, where the modification is performance based on the proximity of a user interface element to a cursor or finger, rather than to a user's finger).

As another example, the user can close her hand 1004 (e.g., by making a first) to navigate the virtual interface 1000. For example, the user can closer her hand 1004 to navigate backwards (e.g., go to the previous view or menu shown in the virtual interface 1000) or to go “home” (e.g., the default view or menu, or the highest hierarchical view or menu).

Further, although FIGS. 42-54 describe example operations that can be performed using a virtual interface (e.g., a virtual interface that is projected by a projector subsystem 832), in practice, similar operations also can be performed using other types of user interfaces. As an example, some or all of these operations can be performed using a user interface that is presented using a display device such as a computer monitor or a touch sensitive display panel.

### Example Techniques for Unlocking a Device Using Touch-Based Gestures

In some implementation, a wearable multimedia device 101 can be selectively “locked” and “unlocked” in order to provide power savings and/or enhance the security of the wearable multimedia device 101 during operation. Further, a user can selectively lock and/or unlock the wearable multimedia device 101 by performing gestures respect to the wearable multimedia device 101.

For instance, when the wearable multimedia device 101 is in an “unlocked” state, the wearable multimedia device 101 can operate in a high-power mode (e.g., “awake” mode) and allow the user to access a full set of functionality of the wearable multimedia device 101. For example, the wearable multimedia device 101 can enable the user to perform some or all of the functionality described herein.

Further, the wearable multimedia device 101 can transition to a “locked” state, in which the wearable multimedia device 101 operates in a lower-power mode (e.g., a “sleep” mode) and/or restricts access by a user to some or all of the functionality provided in the unlocked state. For example, which in a locked state, the wearable multimedia device 101 can restrict the user from accessing content stored on the wearable multimedia device 101, creating new content using the wearable multimedia device 101, transmitting data to and/or receiving data from a network (e.g., the Internet) using the wearable multimedia device 101, running some or all of the applications on the wearable multimedia device 101, and/or performing some or all of the other operations described herein.

In some implementations, a user can selectively lock and/or unlock the wearable multimedia device 101 by performing gestures respect to the wearable multimedia device 101. For example, when the wearable multimedia device 101 is in a locked state, the user can perform a particular gesture to unlock the wearable multimedia device 101. As another example, when the wearable multimedia device 101 is in an unlocked state, the user can perform another gesture to lock the wearable multimedia device 101.

In some implementation, the wearable multimedia device 101 can automatically transition from a locked state to an unlocked state, or vice versa, based on certain criteria. For example, if the wearable multimedia device 101 is in an unlocked state, it can automatically transition to the locked state (e.g., without explicit instructions from the user) if the user has not interacted with the wearable multimedia device 101 for a particular period of time. As another example, the wearable multimedia device 101 can default to the locked state upon initially being powered on.

In some implementations, the user can unlock the wearable multimedia device 101 by inputting touch-based gestures, such as using the touch surface 846 and the touch controller 842 shown in FIG. 8.

For example, while the wearable multimedia device 101 is locked, a user can perform one or more pre-determined gestures on the touch surface 846 (e.g., touching, tapping, and/or swiping one or more fingers on the touch surface 846 according to a particular pattern). Upon detecting that the user performed one of the pre-determined gestures (e.g., using the touch controller 842), the wearable multimedia device 101 can transition to the unlocked state.

As another example, while the wearable multimedia device 101 is unlocked, a user can perform one or more pre-determined gestures on the touch surface 846 (e.g., touching, tapping, and/or swiping one or more fingers on the touch surface 846 according to a particular pattern). Upon detecting that the user performed one of the pre-determined gestures (e.g., using the touch controller 842), the wearable multimedia device 101 can transition to the locked state.

In some implementations, a user can unlock the wearable multimedia device 101 by performing multiple gestures in a sequence. For instance, the user can perform a first gesture to instruct the wearable multimedia device 101 to enter into a gesture unlock input mode, followed by a second gesture (e.g., a security gesture) that demonstrates that she is authorized the unlock the wearable multimedia device 101.

As an example, the user can instruct the wearable multimedia device 101 to enter into a gesture unlock input mode by touching, tapping, and/or swiping one or more fingers on the touch surface 846 according to a first pattern. In some implementations, the first pattern can include touching and swiping a finger in a circular or ring pattern. In some implementations, the first pattern can be touch and swiping a finger in a square pattern, rectangular, or a triangle pattern. In some implementations, the first pattern can include touching and swiping any number of fingers along a curved, straight, and/or angled path (e.g., zig zag pattern, straight line, curved line, or any combination thereof).

In some implementations, the first gesture can be a pre-determined gesture (e.g., a gesture selected by a developer or administrator of the wearable multimedia device 101, by the user, etc.). In some implementations, the first pattern can be a default gesture selected by a developer or administrator of the wearable multimedia device 101 and used across multiple instances of the wearable multimedia device 101.

In some implementations, the first pattern can be selected based on feedback from multiple test subjects. For example, a developer can instruct multiple test subjects to perform a particular gesture (e.g., a circular or ring gesture) and determine the gestures actually performed by the test gestures in response to the instruction. Further, the developer can instruct the test subjects to perform other gestures (e.g., gesture other can circular or ring gestures). The developer can select criteria for detecting the first gesture based on the feedback (e.g., by selecting criteria that would distinguish the gestures performed by the test subjects from the other gestures).

After performing the first gesture, the user can subsequently demonstrate that she is authorized the unlock wearable multimedia device 101 by touching, tapping, and/or swiping one or more fingers on the touch surface 846 according to a second pattern. The second pattern can be a pre-determined pattern that is specific to the user (e.g., a personal security pattern selected by the user as a way of confirming her identity of the wearable multimedia device 101). Upon detecting the second gesture, the wearable multimedia device 101 transitions to the unlocked state. In some implementations, the second pattern can include touching and swiping any number of fingers along a curved, straight, and/or angled path (e.g., zig zag pattern, straight lines, curved lines, or any combination thereof).

In some implementations, the wearable multimedia device 101 can allow a user to unlock the device by entering a password or passcode specific to the user (e.g., via a laser projected virtual interface and/or the touch surface 846). Further, the wearable multimedia device 101 can link or map the user's password or passcode to a corresponding second gesture (e.g., the user's personal security pattern), such that the user can enter either the selected second gesture or the password/passcode to unlock the wearable multimedia device 101. This can be beneficial, for example, in providing the user with multiple ways to unlock the wearable multimedia device 101, some of which may be more convenient to perform than others depending on the situation at hand.

For instance, a user's passcode can be a sequence of numerical digits, where each numerical digit is an integer from zero to 9. Further, each numerical digit can be mapped to a corresponding swiping or tapping pattern. The user can unlock the wearable multimedia device 101 can inputting the passcode itself, or by performing the swiping and/or tapping patterns corresponding that passcode.

For example, a set of ten patterns can include a user:
1. Swiping one finger from right to left,
2. Swiping one finger from left to right,
3. Swiping one finger from top to bottom,
4. Swiping one finger from bottom to top
5. Swiping two fingers from right to left,
6. Swiping two fingers from left to right,
7. Swiping two fingers from top to bottom,
8. Swiping two fingers from bottom to top,
9. Tapping one finger, and
10. Tapping two fingers

Each of these patterns can be mapped to a corresponding numerical digit (e.g., zero to nine, respectively). The user can unlock the wearable multimedia device 101 can inputting the passcode itself, or by swiping and/or tapping her finger(s) in a particular sequence corresponding that passcode.

In some implementations, if the user performs the first gesture incorrectly (or does not attempt to perform the first gesture at all), the wearable multimedia device 101 interprets the user's subsequent gestures as commands to perform functions other than unlocking the wearable multimedia device 101. This can be beneficial, for example, as it allows the user to perform touch-based gestures to interact with the wearable multimedia device 101 in other ways (e.g., other than merely unlocking the wearable multimedia device 101), while the wearable multimedia device 101 is in a locked state. Further, this allows the same gesture to be used for at least two difference purposes (e.g., unlocking the device and performing some other function), depending on the context.

As an example, while the wearable multimedia device 101 is in a locked state, the wearable multimedia device 101 can pay music and allow the user to perform touch-based gestures to control the playback of the music. For instance, the user can touch and swiping one or more fingers on the touch surface 846 according to particular patterns to change the volume, skip to a next track, repeat a track, etc. If the user does not initially perform the first gesture, the wearable multimedia device 101 would interpret each of patterns as instructions to control the playback of the music in a particular way. However, if the user initially performs the first gesture, the wearable multimedia device 101 enters into the gesture unlock input mode, interprets each of patterns as an attempt to provide the user's personal security pattern for unlocking the device.

In some implementations, the wearable multimedia device 101 can maintain a particular playback volume during the unlocking process. This can be beneficial, for example, in reducing disruptions to the user. For instance, while attempting to unlock the wearable multimedia device 101, the user may inadvertently perform gestures that change the volume in which music is played back by the wearable multimedia device 101. Upon detecting performance of the first gesture, the wearable multimedia device 101 can restore the original volume (e.g., the volume of the music, prior to the performance of the first gesture).

In some implementations, the wearable multimedia device 101 can provide feedback to the user regarding successful performance of the first gesture and/or the second gesture. For example, upon detecting the first gesture and/or the second gesture, the wearable multimedia device 101 can generate first audio feedback and/or first haptic feedback (e.g., by generating a first sound or first vibration pattern). As another example, upon determining that the user entered the first gesture and/or the second gesture incorrectly, the wearable multimedia device 101 can generate second audio feedback and/or second haptic feedback (e.g., by generating a second sound or second haptic pattern).

In some implementations, the wearable multimedia device 101 can provide guidance to the user regarding selecting and performing the first and second gestures. For example, during a deployment process (e.g., an initial “set up” process), the wearable multimedia device 101 can instruct the user to perform the first gesture (e.g., swiping a finger in a circular or ring pattern on the touch surface 846). Upon detecting the first gesture, the wearable multimedia device 101 can instruct the user to perform a customized gesture that will be used as the second gesture (e.g., the user's security gesture having a touch pattern that is specific to the user). In some implementations, the wearable multimedia device 101 can instruct the user to perform the customized gesture multiple times (e.g., two or more times) to confirm that the user can perform the same gesture in a consistent and repeatable manner. In some implementation, the wearable multimedia device 101 can provide the user with guidance via audio feedback (e.g., by presenting the user with instructions using audio speakers) and/or via visual feedback (e.g., by presenting the user with instructions using a laser projector or display).

In some implementations, if the user successfully performs the first gesture, but subsequently performs the second gesture incorrectly, the wearable multimedia device 101 can require that the user successfully enter the first gesture again before attempting to perform the second gesture to unlock the wearable multimedia device 101.

In some implementations, if the user successfully performs the first gesture, the wearable multimedia device 101 can require that the user successfully enter the second gesture within a particular period of time before transitioning to the unlocked state. If the user does not perform the second gesture within the period of time, the wearable multimedia device 101 can require that the user successfully enter the first gesture again before attempting to perform the second gesture to unlock the wearable multimedia device 101.

In some implementations, when the wearable multimedia device 101 is in an unlocked state, the user can perform the first gesture to instruct the wearable multimedia device 101 to transition to the lock state.

In the examples described above, the wearable multimedia device 101 can be configured to lock or unlock upon detecting touch-based gestures (e.g., gesture performed along the touch surface 846). However, in some implementations, the wearable multimedia device 101 can be configured to lock or unlock upon detecting gestures performed by the user in the air (e.g., by moving one or more of her hands in a particular pattern or sequence of patterns) and/or upon detecting gesture performed by the user on the surface of her hand (e.g., by touching one or more fingers of one hand to another hand, and by tapping and/or moving the fingers in a particular pattern or sequence of patterns). These gestures can be detected using a camera/video subsystem 820 (e.g., as described above).

### Additional Example Processes

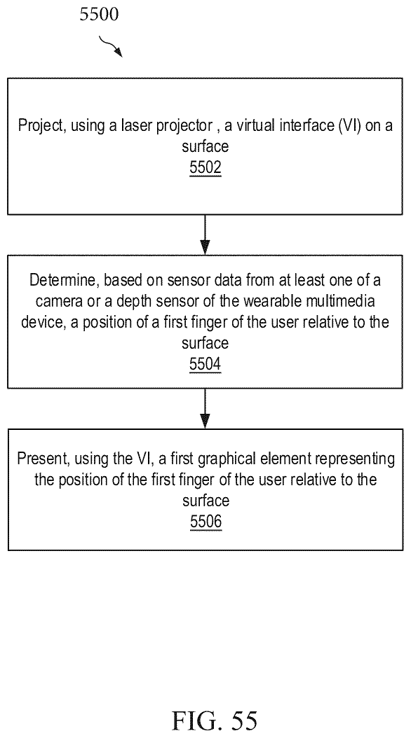

FIG. 55 is flow diagram of an example process 5500 for presenting a virtual interface to a user, according to an embodiment. Process 5500 can be implemented using wearable multimedia devices 101 described in reference to FIGS. 1-54.

According to the process 5500, a wearable multimedia device projects, using a laser projector of a wearable multimedia device, a virtual interface (VI) on a surface (block 5502). In some implementations, the surface can be a surface of a hand of the user. In some implementations, the surface can be a surface of a palm of the user.

Further, the wearable multimedia device determines, based on sensor data from at least one of a camera or a depth sensor of the wearable multimedia device, a position of a first finger of the user relative to the surface (block 5504).

Further, the wearable multimedia device presents, using the VI, a first graphical element representing the position of the first finger of the user relative to the surface (block 5506). In some implementations, the first graphical element can further represents a shape of at least a portion of the first finger, a size of at least a portion of the first finger, and/or an orientation of the first finger.

In some implementations, determining the position of the first finger of the user relative to the surface can include determining a distance between the first finger and the surface. Further, one or more characteristics the first graphical element can be selected based on the distance between the first finger and the surface.

For example, an opacity of the first graphical element can be selected based on the distance between the first finger and the surface. In some implementations, the opacity of the first graphical element can increase with a decrease in the distance between the first finger and the surface.

As another example, a color of the first graphical element can be selected based on the distance between the first finger and the surface.

As another example, a size of the first graphical element can be selected based on the distance between the first finger and the surface.

As another example, a sharpness of the first graphical element can be selected based on the distance between the first finger and the surface.

As another example, a distance between the first graphical element and the first finger can be selected based on the distance between the first finger and the surface. In some implementations, the distance between the first graphical element and the first finger can decrease with a decrease in the distance between the first finger and the surface.

In some implementations, the wearable multimedia device can also determine, based on sensor data, a movement of the first finger relative to the surface, and modify the one or more characteristics the first graphical element based on the movement.

In some implementations, the wearable multimedia device can also determine, based on sensor, that the first finger is in proximity to a first portion of the VI, and in response, present the first graphical element using the VI. Further, the wearable multimedia device can determine, based on sensor, that the first finger is in proximity to a second portion of the VI, in response, refrain from presenting the first graphical element using the VI. The first portion of the VI can include one or more interactive user interface element. Further, the second portion of the VI can have an absence of interactive user interface elements.

In some implementations, the wearable multimedia device can also determine, based on the sensor data, a second position of a second finger of the user relative to the surface, and present, using the VI, a second graphical element representing the position of the second finger of the user relative to the surface.

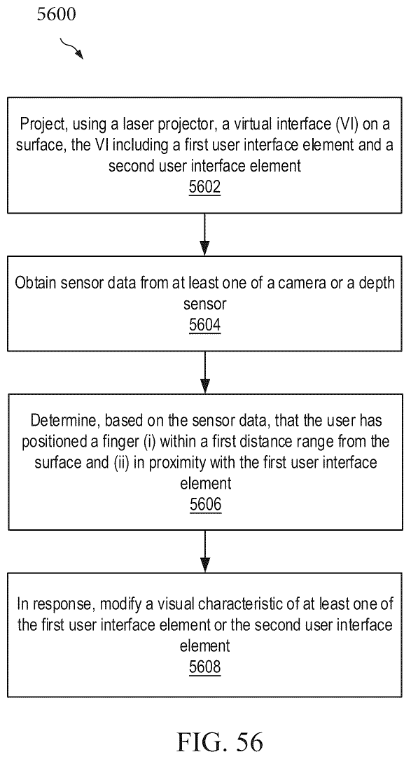

FIG. 56 is flow diagram of an example process 5600 for presenting a virtual interface to a user, according to an embodiment. Process 5600 can be implemented using wearable multimedia devices 101 described in reference to FIGS. 1-54.

According to the process 5600, a wearable multimedia device projects a virtual interface (VI) on a surface using a laser projector (block 5602). The VI includes a first user interface element and a second user interface element.

The wearable multimedia device obtains sensor data from at least one of a camera or a depth sensor (block 5604).

The wearable multimedia device determines, based on the sensor data, that the user has positioned a finger (i) within a first distance range from the surface and (ii) in proximity with the first user interface element (block 5606).

In response, the wearable multimedia device modifies a visual characteristic of at least one of the first user interface element or the second user interface element (block 5608). In some implementations, modifying a visual characteristic of the first user interface element or the second user interface element can include changing a size of the first user interface element, changing a size of the second user interface element, moving the first user interface element relative to the second user interface element, or moving the second user interface element relative to the first user interface element. Other example modifications are described above (e.g., with reference to FIGS. 19A-26C).

In some implementations, the wearable multimedia device can also determine, based on the sensor data, that the user has touched the finger on a portion of the surface coinciding with the first user interface element (e.g., to select the first user interface element). In response, the wearable multimedia device can performing one or more first operations associated with the first user interface element.

In some implementations, the wearable multimedia device can perform additional operations subsequent to determining that the user has positioned a finger (i) within the first distance range from the surface and (ii) in proximity with the first user interface element. For example, the wearable multimedia device can determine the user has repositioned the finger within a second distance range from the surface, where the second distance range less than the first distance range. In response to this determination, the wearable multimedia device can refrain from modifying the visual characteristic of the first user interface element and the second user interface element based on the repositioning of the finger (e.g., such that the user's selection is “locked” to a particular one of the user interface elements).

In some implementations, the second distance range can be greater than zero and less than or equal to a first threshold distance. Further, the first distance range can be greater than the first threshold distance and less than or equal to a second threshold distance.

In some implementations, subsequent to determining that the user has repositioned the finger within the second distance range from the surface, the wearable multimedia device can determine that the user has touched the finger on the surface (e.g., indicating a selection of the first user interface element). In response to this determination, the wearable multimedia device can perform one or more first operations associated with the first user interface element.

In some implementations, the wearable multimedia device can determine that the user has touched the finger on the surface, at least in part by determining that the user has touched the finger on a portion of the surface coinciding with the first user interface element.

In some implementations, the wearable multimedia device can determine that the user has touched the finger on the surface, at least in part by determining that the user has touched the finger on a portion of the surface that does not coincide with the first user interface element.

In some implementations, the wearable multimedia device can also determine that the user is moving the finger within a second distance range from the surface according to a first velocity, where the second distance range less than the first distance range. Further, the wearable multimedia device can determine that the first velocity is less than a threshold velocity. In response to determining that the first velocity is less than the threshold velocity, the wearable multimedia device can modify the visual characteristic of at least one of the first user interface element or the second user interface element based on the movement of the finger. In some implementations, the first velocity can be measured with respect to a plane parallel of the surface.

In some implementations, the wearable multimedia device can also determine that the user is moving the finger within the second distance range from the surface according to a second velocity, and determine that the second velocity is greater than the threshold velocity. In response to determining that the second velocity is greater than the threshold velocity, the wearable multimedia device can refrain from modifying the visual characteristic of the first user interface element and the second user interface element based on the movement of the finger. In some implementations, the second velocity can be measured with respect to a plane parallel of the surface.

In some implementations, the wearable multimedia device can perform further operations subsequent to determining that the user has positioned a finger (i) within the first distance range from the surface and (ii) in proximity with the first user interface element. For example, the wearable multimedia device can determine that the user has moved the finger in a first direction, and in response, move the first user interface element in the first direction (e.g., as shown in FIGS. 23A-23C).

In some implementations, the VI can include a plurality of user interface elements including the first user interface element and the second user interface element. Further, the plurality of user interface elements can be arranged in a grid (e.g., as shown in FIGS. 24A-25C).

In some implementations, the wearable multimedia device can determine, based on the sensor data, that the user has moved the finger towards the surface, and in response, perform a zoom in operation with respect to the VI (e.g., as shown in FIGS. 15A-15B and 18A-18B). Further, the wearable multimedia device can determine, based on the sensor data, that the user has moved the finger in a first direction along the VI, and in response, performing a scroll operation on the VI in the first direction (e.g., as shown in FIGS. 25C and 26C).

In some implementations, the wearable multimedia device can also determine, based on the sensor data, that the user has moved the finger away from the surface, and in response, performing a zoom out operation with respect to the VI.

In some implementations, the wearable multimedia device can determine, based on the sensor data, that the user is moving the finger, and determine a first velocity of the finger along a plane parallel to the surface. Further, the wearable multimedia device can apply a weight to the first velocity, and determine an input of the user based on the weighted first velocity (e.g., as described with reference to FIGS. 27A-27C). In some implementations, the weight can be determine based on a second velocity of the finger along a direction orthogonal to the plane. In some implementations, the weight can be inversely related to the second velocity.

In some implementations, modifying the visual characteristic of at least one of the first user interface element or the second user interface element can include visually indicating that the finger is in proximity with the first user interface element. Further, the wearable multimedia device can perform further additional operations subsequent to determining that the user has positioned a finger (i) within the first distance range from the surface and (ii) in proximity with the first user interface element. For example, the wearable multimedia device can determine that the user has moved the finger to a first position, and determine that the first position is within a boundary region enclosing the first user interface element. In response to determining that the first position is within the boundary region, the wearable multimedia device can continue to indicate that the finger is in proximity with the first user interface element (e.g., as shown in FIGS. 21A-21F).

Further, the wearable multimedia device can determine that the user has moved the finger to a second position, and determine that the first position beyond the boundary region and is in proximity with the second user interface element. In response to determining that the first position is beyond the boundary region and in proximity with the second user interface element, the wearable multimedia device can indicate that the finger is in proximity with the second user interface element (e.g., as shown in FIGS. 21H-21J).

In some implementations, the boundary region can be larger than the first user interface element. In some implementations, a size of the boundary region can vary depending on a distance between the finger and the surface. For example, the size of the boundary region can be inversely proportional to the distance between the finger and the surface. In some implementations, the wearable multimedia device can refrain from visually presenting the boundary region to the user in the VI (e.g., such that the user cannot see the boundary region in the VI).

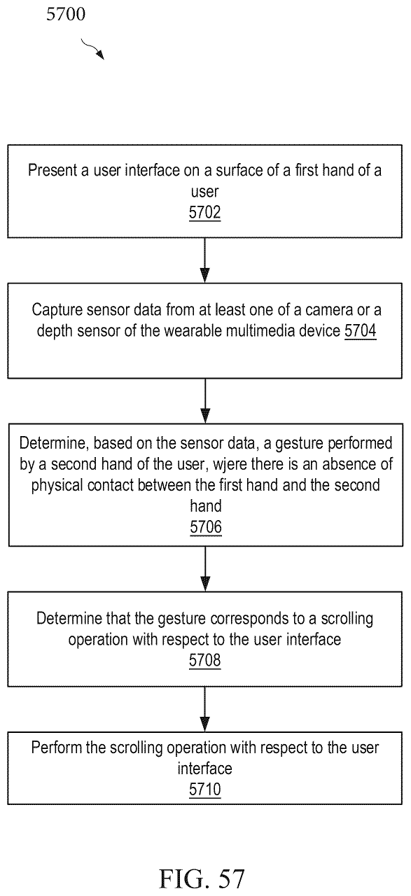

FIG. 57 is flow diagram of an example process 5700 for presenting a virtual interface to a user, according to an embodiment. Process 5700 can be implemented using wearable multimedia devices 101 described in reference to FIGS. 1-54.

According to the process 5700, a wearable multimedia device presents a user interface on a surface of a first hand of a user (block 5702). In some implementations, presenting the user interface can include projecting the user interface onto the surface of the first hand of the user using a laser projector of the wearable multimedia device,

Further, the wearable multimedia device captures sensor data from at least one of a camera or a depth sensor of the wearable multimedia device (block 5704).

Further, the wearable multimedia device determines, based on the sensor data, a gesture performed by a second hand of the user (block 5706). There is an absence of physical contact between the first hand and the second hand.

Further, the wearable multimedia device determines that the gesture corresponds to a scrolling operation with respect to the user interface (block 5708).

Further, the wearable multimedia device performs the scrolling operation with respect to the user interface (block 5710). In some implementations, a speed of the scrolling operation can depend on a distance between the one or more fingers from a reference line.

In some implementations, the gesture can be performed by the second hand beyond a periphery of the user interface.

In some implementations, the gesture can include positioning one or more fingers of the second hand a first direction from the first hand. Further, the scrolling operation can include scrolling the user interface in the first direction.

In some implementations, the gesture can include positioning one or more fingers of the second hand an upward direction from the first hand. Further, the scrolling operation can include scrolling the user interface upward.

In some implementations, the gesture can include positioning one or more fingers of the second hand a downward direction from the first hand. Further, the scrolling operation can include scrolling the user interface downward.

In some implementations, the gesture can include positioning one or more fingers of the second hand a leftward direction from the first hand. Further, the scrolling operation can include scrolling the user interface leftward.

In some implementations, the gesture can include positioning one or more fingers of the second hand a rightward direction from the first hand. Further, the scrolling operation can include scrolling the user interface rightward.

In some implementations, the gesture can include moving the second hand in a first direction. Further, the scrolling operation can include scrolling the user interface in the first direction.

In some implementations, the gesture can include moving the second hand in an upward direction. Further, the scrolling operation can include scrolling the user interface upward.

In some implementations, the gesture can include moving the second hand in a downward direction. Further, the scrolling operation can include scrolling the user interface downward.

In some implementations, the gesture can include moving the second hand in a leftward direction. Further, the scrolling operation can include scrolling the user interface leftward.

In some implementations, the gesture can include moving the second hand in a rightward direction. Further, the scrolling operation can include scrolling the user interface rightward.

In some implementations, the gesture can include, concurrently, (i) pointing a particular number of fingers outward from the second hand, and (ii) moving the second hand in a first direction. Further, the scrolling operation can include scrolling the user interface in the first direction. In some implementations, the number of fingers can be five. In some implementations, the number of fingers can be less than five.

In some implementations, the gesture can include, concurrently, (i) performing a pinching gesture using the second hand, and (ii) moving the second hand in a first direction. Further, the scrolling operation can include scrolling the user interface in the first direction.

In some implementations, the wearable multimedia device can also determine, based on the sensor data, a second gesture performed by the second hand of the user. The second gesture can include, concurrently, (i) performing the pinching gesture using the second hand, and (ii) moving the second hand away from the surface. Further, the wearable multimedia device can determine that the second gesture corresponds to a zoom out operation with respect to the user interface, and perform the zoom out operation with respect to the user interface.

In some implementations, the wearable multimedia device can, subsequent to performing the zoom out operation, determine a third gesture performed by the second hand of the user based on the sensor data. The second gesture can include stopping the performance of the pinching gesture. Further, the wearable multimedia device can determine that the third gesture corresponds to a zoom in operation with respect to the user interface, and perform the zoom in operation with respect to the user interface.

In some implementations, the user interface can include a scroll control element having a plurality of portions. Each of the portions can correspond to respective scrolling direction and a respective scrolling speed. Further, the wearable multimedia device can determine, based on the sensor data, a second gesture performed by the second hand of the user. The gesture can include touching one of the portions of the scroll control element. Further, the wearable multimedia device can scroll the user interface according to the corresponding scrolling direction and scrolling speed.

In some implementations, the first hand can be a right hand of the user, and the second hand can be a left hand of the user.

In some implementations, the first hand can be a left hand of the user, and the second hand can be a right hand of the user.

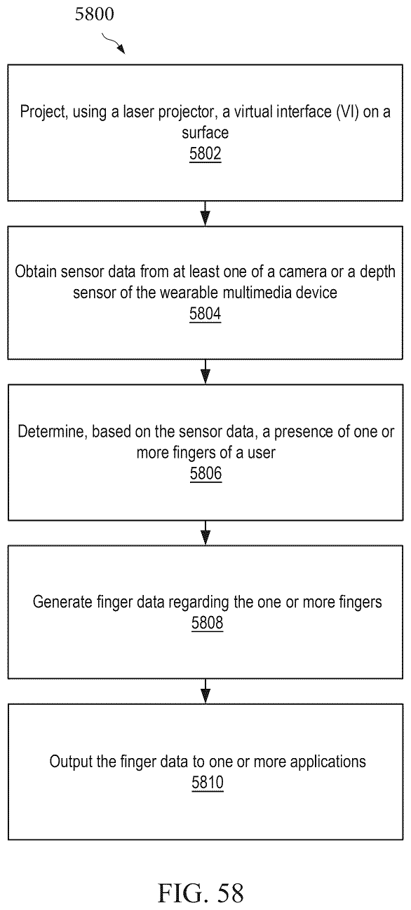

FIG. 58 is flow diagram of an example process 5800 for detecting a user's interactions with a virtual interface to a user, according to an embodiment. Process 5800 can be implemented using wearable multimedia devices 101 described in reference to FIGS. 1-54.

According to the process 5800, a wearable multimedia device projects a virtual interface (VI) on a surface using a laser projector (block 5802). In some implementations, the surface can be a surface of a hand of the user. In some implementations, the surface can be a surface of a palm of the user.

Further, the wearable multimedia device obtains sensor data from at least one of a camera or a depth sensor of the wearable multimedia device (block 5804).

Further, the wearable multimedia device determines a presence of one or more fingers of a user based on the sensor data (block 5806). In some implementations, at least some of the one or more fingers may not be in contact with the surface (e.g., the fingers may be hovering above the surface). In some implementations, each of the one or more fingers may not be in contact with the surface.

Further, the wearable multimedia device generates finger data regarding the one or more fingers (block 5808). The finger data includes, for each of the one or more fingers: (i) a first coordinate representing a location of a tip of that finger relative to the surface with respect to a first dimension, (ii) a second coordinate representing the location of the tip of that finger relative to the surface with respect to a second dimension, and (iii) a third coordinate representing the location of the tip of that finger relative to the surface with respect to a third dimension.

In some implementations, the first dimension can extend in a first direction along the surface. Further, the second dimension can extend in a second direction along the surface, where the first direction is orthogonal to the second direction. Further, the third dimension can extend in a third direction from the surface, where the third direction is orthogonal to the first direction and to the second direction.

In some implementations, the wearable multimedia device can also determine whether each of the one or more fingers is pointed outward from a palm of the user. Further, the finger data can include an indication of each of the one or more fingers that are pointed outward from the palm of the user.

In some implementations, the wearable multimedia device can also determine whether each of the one or more fingers is curled towards a palm of the user. Further, the finger data can include an indication of each of the one or more fingers that are curled towards the palm of the user.

Further, the wearable multimedia device outputs the finger data to one or more applications (block 5810).

In some implementations, a first application of the one or more applications can be configured to receive the finger data, and perform one or more operations based on at least one of the finger data.

In some implementations, the one or more operations can include, for each of the one or more fingers, determining the location of the tip of that finger based on the finger data, and causing the VI to visually indicate the location of the tip of that finger based on the finger data.

In some implementations, the one or more operations can include, for each of the one or more fingers, (i) determining the location of the tip of that finger based on the finger data, (ii) determining that the tip of that finger is proximal to one or more user interface elements of the VI, and (iii) responsive to determining that the tip of that finger is proximal to one or more user interface elements of the VI, causing the VI to modify a visual characteristics of the one or more user interface elements.

In some implementations, the one or more operations can include determining, for one of the one or more fingers, a distance between the tip of that finger and the surface based on the finger data; and performing the one or more operations based on the distance.

In some implementations, performing the one or more operations based on the distance can include performing a first operation response to determining that the distance is within a first distance range, and performing a second operation response to determining that the distance is within a second distance range. As an example, the one or more applications can include a graphics editor. Performing the first operation can include generating a first image element having a first thickness, and performing the second operation can include generating a second image element having a second thickness.

In some implementations, the wearable multimedia device can also determine gesture data based on the finger data. The gesture data can indicate one or more gestures performed by the user. Further, the wearable multimedia device can output the gesture data to the one or more applications.

In some implementations, the gesture data can be determined, at least in part, by determining a movement of each of the one or more fingers, and determining the one or more gestures based on the finger data and the movement of each of the one or more fingers.

In some implementations, the one or more gestures can include a pinching gesture, a swiping gesture, a waving gesture, a pointing gesture, a rotating gesture, a hand raising gesture, and/or a hand lowering gesture.

In some implementations, the one or more gestures can include a movement of a first finger of the one or more fingers along a second finger of the one or more fingers (e.g., as show in FIGS. 52A and 52B).

In some implementations, the one or more gestures can include a handwriting gesture. For example, the handwriting gesture can include a movement of a first finger of the one or more fingers along a path, where the path represents a portion of text (e.g., as shown in FIG. 53A). As another example, the handwriting gesture can include concurrently (i) positioning the tip of a first finger of the one or more fingers in contact with the tip of a second finger of the one or more fingers, and (ii) moving the first finger and the second finger along a path, where the path represents a portion of text (e.g., as shown in FIG. 53B).

In some implementations, the one or more gesture can include maintaining a pose of the hand for a period of time.

In some implementations, a first application of the one or more applications can be configured to receive the gesture data, determine that the one or more gestures corresponds to one or more operations, and perform the one or more operations.

In some implementations, the finger data and/or the gesture data can be outputted to the one or more applications using an application programming interface (API).

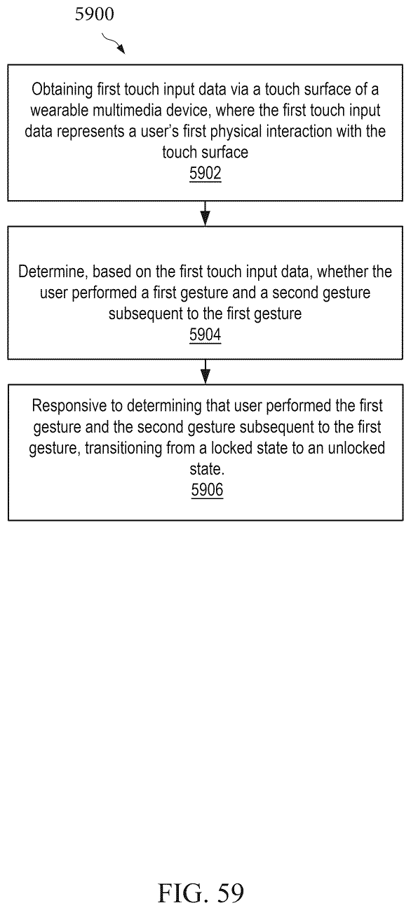

FIG. 59 is flow diagram of an example process 5900 for unlocking and locking a wearable multimedia device using touch-based gestures. Process 5900 can be implemented using wearable multimedia devices 101 described in reference to FIGS. 1-54.

According to the process 5900, a wearable multimedia device obtains first touch input data via a touch surface of the wearable multimedia device (block 5902). The first touch input data represents a user's first physical interaction with the touch surface.

In some implementations, the first gesture can include one or more fingers of the user moving along at least one of a circular path or a ring path on the touch surface.

In some implementations, the second gesture can include one or more fingers of the user moving along a pre-determined path on the touch surface and/or touching the touch surface according to a pre-determined pattern.

The wearable multimedia device determines, based on the first touch input data, whether the user performed a first gesture and a second gesture subsequent to the first gesture (block 5904).

Responsive to determining that user performed the first gesture and the second gesture subsequent to the first gesture, the wearable multimedia device transitions from a locked state to an unlocked state (block 5906).

In some implementations, the method 5900 can also include (i) subsequent to transitioning from the locked state to the unlocked state, obtaining second touch input data via the touch surface of the wearable multimedia device, where the second touch input data represents a user's second physical interaction with the touch surface, (ii) determining, based on the second touch input data, that the user performed the first gesture, and (iii) responsive to determining that user performed the first gesture, transitioning from the unlocked state to the unlocked state.

In some implementations, in the unlocked state, the wearable multimedia device can provide the user with access to a set of functionality of the wearable multimedia device. Further, in the locked state, the wearable multimedia device can restrict the user from accessing the set of functionality of the wearable multimedia device.

In some implementations, the set of functionality can include accessing content stored on the wearable multimedia device, creating content using the wearable multimedia device, transmitting data to a network using the wearable multimedia device receiving data from the network using the wearable multimedia device, and/or running an application on the wearable multimedia device.

In some implementations, the second gesture can be specified by the user.

In some implementations, determining whether the user performed the first gesture and the second gesture subsequent to the first gesture can include determining whether the user performed the second gesture within a pre-determined time of time after the first gesture.

In some implementations, the second gesture can correspond to a numerical passcode associated with the user.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor. Method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random-access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits). To provide for interaction with a user the features may be implemented on a computer having a display device such as a CRT (cathode ray tube), LED (light emitting diode) or LCD (liquid crystal display) display or monitor for displaying information to the author, a keyboard and a pointing device, such as a mouse or a trackball by which the author may provide input to the computer.

One or more features or steps of the disclosed embodiments may be implemented using an Application Programming Interface (API). An API may define one or more parameters that are passed between a calling application and other software code (e.g., an operating system, library routine, function) that provides a service, that provides data, or that performs an operation or a computation. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API. In some implementations, an API call may report to an application the capabilities of a device running the application, such as input capability, output capability, processing capability, power capability, communications capability, etc.

A number of implementations have been described. Nevertheless, it will be understood that various modifications may be made. Elements of one or more implementations may be combined, deleted, modified, or supplemented to form further implementations. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
presenting, by an electronic device, a user interface (UI) on a surface, the UI comprising a first user interface element and a second user interface element;
obtaining sensor data from at least one of a camera or a depth sensor of the electronic device;
determining, based on the sensor data, that the user has positioned a finger (i) within a first distance range from the surface and (ii) in proximity with the first user interface element;
responsive to determining that the user has positioned the finger (i) within the first distance range from the surface and (ii) in proximity with the first user interface element, modifying a visual characteristic of at least one of the first user interface element or the second user interface element.

2. The method of claim 1, wherein modifying a visual characteristic of at least one of the first user interface element or the second user interface element comprises:
changing a size of the first user interface element.

3. The method of claim 1, wherein modifying a visual characteristic of at least one of the first user interface element or the second user interface element comprises:
changing a size of the second user interface element.

4. The method of claim 1, wherein modifying a visual characteristic of at least one of the first user interface element or the second user interface element comprises:
moving the first user interface element relative to the second user interface element.

5. The method of claim 1, wherein modifying a visual characteristic of at least one of the first user interface element or the second user interface element comprises:
moving the second user interface element relative to the first user interface element.

6. The method of claim 1, further comprising:
subsequent to determining that the user has positioned the finger (i) within the first distance range from the surface and (ii) in proximity with the first user interface element, determining that the user has repositioned the finger within a second distance range from the surface, wherein the second distance range less than the first distance range; and
responsive to determining that the user has repositioned the finger within the second distance range from the surface, refraining from modifying the visual characteristic of the at least one of the first user interface element or the second user interface element based on the repositioning of the finger.

7. The method of claim 6, further comprising:
subsequent to determining that the user has repositioned the finger within the second distance range from the surface, determining that the user has touched the finger on the surface; and
responsive to determining that the user has touched the finger on the surface, performing one or more first operations associated with the first user interface element.

8. The method of claim 1, further comprising:
subsequent to determining that the user has positioned the finger (i) within the first distance range from the surface and (ii) in proximity with the first user interface element, determining that the user has moved the finger in a first direction; and
responsive to determining that the user has moved the finger in the first direction, moving the first user interface element in the first direction.

9. The method of claim 1, further comprising:
determining, based on the sensor data, that the user has moved the finger towards the surface; and
responsive to determining that the user has moved the finger towards the surface, performing a zoom in operation with respect to the VI.

10. The method of claim 9, further comprising:
determining, based on the sensor data, that the user has moved the finger in a first direction along the VI; and
responsive to determining that the user has moved the finger in the first direction along the VI, performing a scroll operation on the VI in the first direction.

11. The method of claim 9, further comprising:
determining, based on the sensor data, that the user has moved the finger away from the surface; and
responsive to determining that the user has moved the finger away from the surface, performing a zoom out operation with respect to the VI.

12. The method of claim 1, further comprising:
subsequent to determining that the user has positioned the finger (i) within the first distance range from the surface and (ii) in proximity with the first user interface element, determining that the user has moved the finger to a first position;
determining that the first position is within a boundary region enclosing the first user interface element; and
responsive to determining that the first position is within the boundary region, continuing to indicate that the finger is in proximity with the first user interface element.

13. The method of claim 12, further comprising:
determining that the user has moved the finger to a second position;
determining that the first position is beyond the boundary region and is in proximity with the second user interface element; and
responsive to determining that the first position is beyond the boundary region and in proximity with the second user interface element, indicating that the finger is in proximity with the second user interface element.

14. The method of claim 13, wherein the boundary region is larger than the first user interface element.

15. The method of claim 13, wherein a size of the boundary region varies depending on a distance between the finger and the surface.

16. The method of claim 15, wherein the size of the boundary region is inversely proportional to the distance between the finger and the surface.

17. An electronic device, comprising:
a display device;
at least one of a camera or a depth sensor;
at least one processor; and
memory storing instructions that, when executed by the at least one processor, cause the at least one processor to perform operations comprising:
displaying, using the display device, a user interface (UI) on a surface, the UI comprising a first user interface element and a second user interface element;
obtaining sensor data from at least one of the camera or the depth sensor;
determining, based on the sensor data, that the user has positioned a finger (i) within a first distance range from the surface and (ii) in proximity with the first user interface element; and
responsive to determining that the user has positioned the finger (i) within the first distance range from the surface and (ii) in proximity with the first user interface element, modifying a visual characteristic of at least one of the first user interface element or the second user interface element.

18. The electronic device of claim 17, the operations further comprising:
subsequent to determining that the user has positioned the finger (i) within the first distance range from the surface and (ii) in proximity with the first user interface element, determining that the user has repositioned the finger within a second distance range from the surface, wherein the second distance range less than the first distance range; and
responsive to determining that the user has repositioned the finger within the second distance range from the surface, refraining from modifying the visual characteristic of the at least one of the first user interface element or the second user interface element based on the repositioning of the finger.

19. The electronic device of claim 18, the operations further comprising:
subsequent to determining that the user has positioned the finger within the second distance range from the surface, determining that the user has repositioned the finger outside the second distance range from the surface; and
responsive to determining that the user has repositioned the finger outside the second distance range from the surface, ceasing to refrain from modifying the visual characteristic of the at least one of the first user interface element or the second user interface element.

20. The electronic device of claim 17, wherein:
the display device is a laser projector;
the displaying is projecting using the laser projector; and
the UI is a virtual interface (VI).
